(19) United States
(12) Patent Application Publication
(10) Pub. No.: US 2010/0161374 A1
(43) Pub. Date: Jun. 24, 2010

(54) Real-Time Quality Data and Feedback for Field Inspection Systems and Methods

(76) Inventors: Jim Horta, Denham Springs, LA (US); Damon M. Buckhalter, Denham Springs, LA (US)

Correspondence Address: Merchant & Gould - Cox, PO Box 2903, Minneapolis, MN, 55402, US

(21) Appl. No.: 12/626,295

(22) Filed: Nov. 25, 2009

Related U.S. Application Data
(60) Provisional application No. 61/118,179, filed on Nov. 26, 2008.

(51) Int. Cl. G06Q 10/00; G01C 21/00; G06F 3/048; G06F 17/30

(52) U.S. Cl. 705/9; 705/7; 701/200; 715/771; 715/764; 707/802; 707/E17.044

(57) ABSTRACT

A system, method and computer-readable medium for providing real-time quality data to a system that may be continuously updated and reviewed to maintain and control quality performance of the business. Quality information is imported into a database. The quality information imported to the database is analyzed and correlated to generate quality performance analytics. System information is provided to the database. Real-time root cause analysis is performed using the generated quality performance analytics and system information to identify root causes of system performance issues. The quality performance analytics is presented to users.

### RELATED APPLICATION

Under provisions of 35 U.S.C. §119(e), Applicant claims the benefit of U.S. provisional application No. 61/118,179 entitled “Real-Time Quality Data and Feedback for Field Inspection Systems and Methods,” filed Nov. 26, 2008, which is incorporated herein by reference.

### FIELD OF THE INVENTION

The present invention relates to systems, methods, and computer-readable media for maintaining and controlling quality performance. More particularly, the present invention relates to systems, methods and computer-readable media for providing real-time quality data to maintain and control quality performance

### BACKGROUND OF THE INVENTION

Real-time quality data is as critical to quality performance. Because of the intense competition in business today, maintaining quality data is vital. However, to provide effective quality performance, business data must reflect the current status of the business. Typically, some type of quality performance report is printed at the end of the month to find out how well the business is performing. With the pace of today's business environment, relying on monthly quality performance reports is not sufficient to maintain appropriate quality performance.

For example, in a telecommunications system, there are many technicians and field personnel that take measurements, make changes, and gather information throughout the month. In a typical scenario, there can be 200-300 field employees that inspect different areas and components of the system. There may also be contracting firms that have tens of technicians that gather data. If each field employee and technician is involved in 5-10 inspections per month, the total number of inspections in a single month can reach well into the thousands and in the tens of thousands per year. If the inspections involve 10-20 inspections points each, the number of inspection points and corresponding data will reach past 500,000 annually.

Accordingly, it can be seen that businesses need a way to provide real-time quality data to a system that may be continuously updated and reviewed to maintain and control quality performance of the business.

### SUMMARY OF THE INVENTION

Embodiments of the present invention address these issues by providing methods, computer-readable media, and systems providing real-time quality data to maintain and control quality performance.

According to one embodiment of the present invention, quality data is routinely imported to a database. Customer data is also maintained. A real-time quality data system processes the data to maintain and control quality performance of the business. The data is analyzed and correlated to generate quality performance analytics. System information is provided to the database. Real-time root cause analysis is performed using the generated quality performance analytics and system information to identify root causes of system performance issues. The quality performance analytics is presented to users.

These and other features and advantages, which characterize the present invention, will be apparent from a reading of the following detailed description and a review of the associated drawings. It is to be understood that both foregoing general description and the following detailed description are exemplary and explanatory only and are not restrictive of the invention, as claimed.

### BRIEF DESCRIPTION OF THE DRAWINGS

FIG. 1 shows a Real-Time Quality Data System main entry screen according to one embodiment;

FIG. 2 shows the Real-Time Quality Data System main screen according to one embodiment;

FIG. 3 shows a drop-down menu on the Real-Time Quality Data System main screen for adding an inspection according to one embodiment;

FIG. 4 shows the Real-Time Quality Data System Inspector Queue screen according to one embodiment;

FIG. 5 shows the Inspector Queue screen when two work orders are awaiting inspection according to one embodiment;

FIG. 6 shows Real-Time Quality Data System Inspection Add screen according to one embodiment;

FIG. 7 shows the Inspection View screen according to one embodiment;

FIG. 8 shows the Inspection View screen with a list of the inspections matching the criteria being displayed according to one embodiment;

FIG. 9 shows the Real-Time Quality Data System Inspection Detail screen accessed by Supervisor, Supervisor Limited, Contract Supervisor, Manager, and Employee user types according to one embodiment;

FIG. 10 shows the Real-Time Quality Data System Inspection Detail screen when multiple security roles have access to different information and functions on the Real-Time Quality Data System Inspection Detail screen according to one embodiment;

FIG. 11 shows the Image Upload screen according to one embodiment;

FIG. 12 shows the Image View screen with a list of images, the item they are attached to, reason for not passing, and the comments of that detail item according to one embodiment;

FIG. 13 shows the Inspection Edit screen according to one embodiment;

FIG. 14 shows the Image Refile/Delete screen where the user can refile an image in order to move it from one detail item to another within the inspection according to one embodiment;

FIG. 15 shows the Image Refile/Delete screen according to one embodiment;

FIG. 16 shows the Inspection Edit screen accessible only to administrators of an Inspection Type according to one embodiment;

FIG. 17 shows the Inspection Rejection screen according to one embodiment;

FIG. 18 shows the Inspection Work Order Queue used to assign work to inspectors according to one embodiment;

FIG. 19 shows the Inspection Work Queue screen where list of eight work orders are displayed according to one embodiment;

FIG. 20 shows the Inspection Work Order Queue screen in which the user can add a work order to the queue according to one embodiment;

FIG. 21 shows a list of all techs with less than the minimum number of inspections needed for that inspection type for the current month according to one embodiment;

FIG. 22 shows the Primary Locator List according to one embodiment;

FIG. 23 shows the Node List according to one embodiment;

FIG. 24 shows the WO Assigned Import screen that allows the importing of inspector routes that were pre assigned the previous day if needed as a back up according to one embodiment;

FIG. 25 shows the Work Order Detail screen that displays the details of a particular work order number selected in the Work Order Queue screen according to one embodiment;

FIG. 26 shows the Inspector Queue screen in which two work orders are awaiting inspection according to one embodiment;

FIG. 27 shows the WO Cancel Inspection screen according to one embodiment;

FIG. 28 shows the Dispute View which is accessible by selecting the Inspection Dispute Queue from the drop-down menu under Inspections according to an embodiment;

FIG. 29 shows the Dispute View screen with five disputes matching the criteria being displayed according to one embodiment;

FIG. 30 shows an inspection to be disputed according to one embodiment;

FIG. 31 shows the Dispute Detail screen according to one embodiment;

FIG. 32 shows the Mass Status Change Inspections screen according to one embodiment;

FIG. 33 shows the Mass Status Change Inspections screen refreshed with a grid of five inspections based on the criteria provided in FIG. 32 according to one embodiment;

FIG. 34 shows the Custom Site Reports screen according to one embodiment;

FIG. 35 shows the Custom Site Reports screen in which Data Reports has been selected for the Report Category according to one embodiment;

FIG. 36 shows a list of techs for the Supervisor Tech ‘70157’ according to one embodiment;

FIG. 37 shows the screen to add a tech to a supervisor list according to one embodiment;

FIG. 38 shows the Supervisor/Tech Maintenance screen where the tech already exists on another supervisors list when the user tried to add the tech according to one embodiment;

FIG. 39 shows the Supervisor/Tech Maintenance screen in which a tech has been selected to be edited according to one embodiment;

FIG. 40 shows the Inspection Counts screen which is used to calculate inspector counts for a specific day according to one embodiment;

FIG. 41 shows the updated Inspection Counts screen with the grid of the inspection counts retrieved according to one embodiment;

FIG. 42 shows the Flash Add screen which allows the user to add flashes to the main menu screens to inform users of a particular inspection type according to an embodiment;

FIG. 43 shows the Flash Edit screen in which the user can edit a particular flash ID from the list displayed on the Flash Administration screen according to one embodiment;

FIG. 44 shows the Flash Administration screen accessed from the Real-Time Quality Data System main screen under the Administration menu option according to one embodiment;

FIG. 45 shows the User Administration screen that displays a list of the users who have access to the particular inspection and user type according to one embodiment;

FIG. 47 shows the refreshed add screen that has the CORP\domain added to the front of the now disabled User ID field according to an embodiment;

FIG. 48 shows the Update User screen according to one embodiment;

FIG. 49 shows the Add Alternate User Type screen in which users can add new user roles to grant access for the role according to one embodiment;

FIG. 50 shows the User Mass Roll Assignment screen used to grant role access to a large group of users that are already in the system according to one embodiment;

FIG. 51 shows the Job Type Add screen according to one embodiment;

FIG. 52 shows the Job Type Edit screen according to one embodiment;

FIG. 53 shows the Job Type Administration screen according to one embodiment;

FIG. 54 shows the List Item Administration screen according to one embodiment;

FIG. 55 shows the List Items Add screen according to one embodiment;

FIG. 56 shows the List Item Edit screen which allows the user to edit a particular list item from the list displayed on the List Item Administration screen according to one embodiment;

FIG. 57 shows the List Item Reason Add screen according to one embodiment;

FIG. 58 shows the List Item Reason Edit screen according to one embodiment;

FIG. 59 shows the Truck Roll Costs Add screen according to one embodiment;

FIG. 60 shows the Truck Roll Cost Edit screen according to one embodiment;

FIG. 61 shows the Truck Roll Cost Administration screen according to one embodiment;

FIG. 62 shows the Custom Site Report Add screen according to one embodiment;

FIG. 63 shows the Custom Site Report Edit screen according to one embodiment;

FIG. 64 shows the Add Custom Site Report User Type screen according to one embodiment;

FIG. 65 shows the Custom Site Reports Administration screen according to one embodiment;

FIG. 67 shows the Inspection Type Edit screen according to one embodiment;

FIG. 68 shows the Inspection Type Administration screen according to one embodiment;

FIG. 69 shows the site administration screen that is only accessible by the Site Administration according to one embodiment;

FIG. 70 shows the first step is to Assign the Work along with a description according to one embodiment;

FIG. 71 shows the second step of Real-Time Quality Data System is to Inspect & Collect Data according to one embodiment;

FIG. 72 shows the third step of Real-Time Quality Data System is Goes to Work according to one embodiment;

FIG. 73 shows the forth step of Real-Time Quality Data System is Real-time Results according to one embodiment;

FIG. 74 shows the fifth step of Real-Time Quality Data System is being able to make Business Decisions Fast according to one embodiment;

FIG. 75 shows the on-line scoring and information about how scores are used according to one embodiment;

FIG. 76 shows an example of On Line-Real-time Reporting by displaying a Results Chart By Supervisor/Date Range report according to one embodiment;

FIG. 77 shows an example of how to Drill Down to Root Cause according to one embodiment;

FIG. 78 shows another example of how to Drill Down to Root Cause according to one embodiment;

FIG. 79 shows an example of a Non Passing Reasons Chart by Date Range report according to one embodiment;

FIG. 80 shows a Non Passing Reasons Monthly Trending Chart By Date Range report for the particular list item Drop Grounded Properly according to one embodiment;

FIG. 81 shows YTD Trending with a Passing Percentage Trending graph for the months January through July according to one embodiment;

FIG. 82 shows Non Passing Reasons Detail for the three top issues in July 2008 according to one embodiment;

FIG. 83 shows a Return on Quality report for the month of July 2008 according to one embodiment;

FIG. 84 shows a Contractor Trending YTD by Performance report according to one embodiment;

FIG. 85 shows a Result Chart By Supervisor For Install report for the month of July 2008 according to one embodiment;

FIG. 86 shows a Result Chart By Supervisor For Trouble Call report for the month of July 2008 according to one embodiment;

FIG. 87 shows a Result Chart By Supervisor For Update report for the month of July 2008 according to one embodiment;

FIG. 88 shows an example of a Results Chart By Supervisor/Date Range report according to one embodiment;

FIG. 89 shows a performance evaluation for Team 1 according to one embodiment;

FIG. 90 shows a performance evaluation for Team 2 according to one embodiment; and

FIG. 91 shows a performance evaluation for Team 3 according to one embodiment.

### DETAILED DESCRIPTION OF THE PREFERRED EMBODIMENT

Embodiments of the present invention are directed to providing real-time quality data to a system that may be continuously updated and reviewed to maintain and control quality performance of the business.

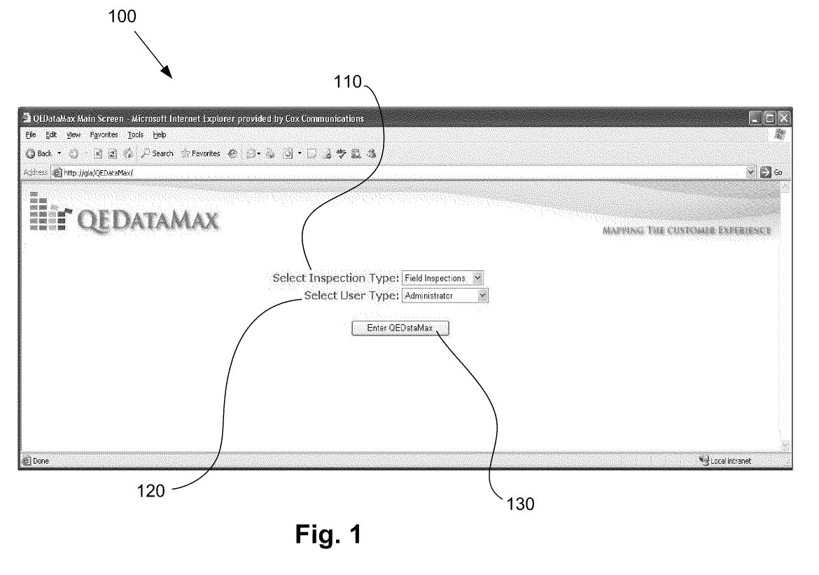

FIG. 1 shows a real-time quality data system main entry screen 100 according to one embodiment. In FIG. 1, the real-time quality data system main screen 100 includes selection options for users who have been assigned multiple roles or to multiple inspection types. A user may select a specific inspection type 110 and user type 120 to be used. After users make their selection, the user may then select the Enter Real-Time Quality Data System button 130.

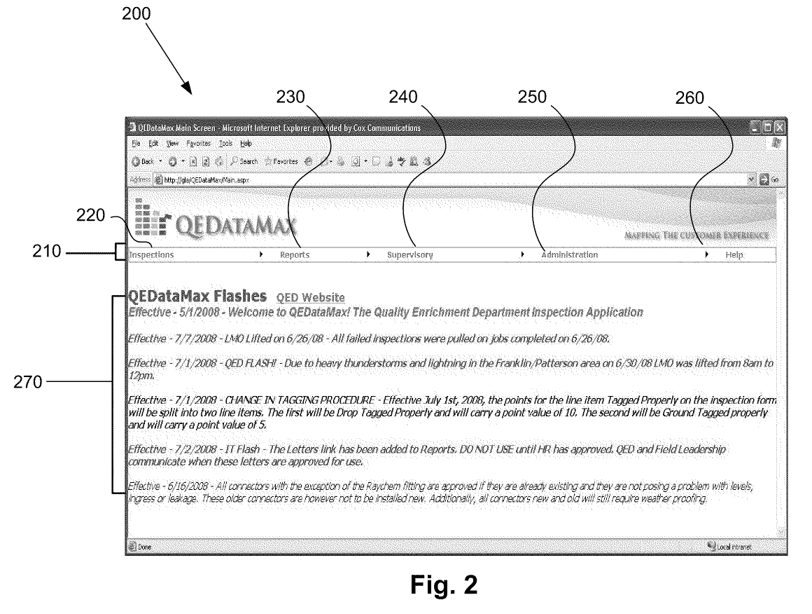

FIG. 2 shows the real-time quality data system main screen 200 according to one embodiment. The Menu options 210 available will change depending upon which user type a particular user chose when the user logged in. The Menu options include Inspections 220, Reports 230, Supervisory 240, Administration 250, and Help 260 menus. Additionally, the real-time quality data system main screen features Flashes 270. Flashes 270 are used to inform users of a particular inspection type. Administrators can add, edit, and remove flashes 270. Flashes 270 display on the main screen and the inspector main screen.

Table 1 shows the multiple user types within the real-time quality data system, along with each user's access levels within the Real-Time Quality Data System Main screen.

TABLE 1

| User Type | Access Levels |
|---|---|
| Administrator | Full Access Inspection Menu, Full Access Reports, Full Access |
| | Supervisory, Full Access Administration |
| Manager | View Inspection Full, Dispute Inspection Full, Supervisory Level Reports, |
| | Supervisor Tech Maintenance Full Access |
| Contract Supervisor | View Inspection Full, Dispute Inspection Full, Supervisory Level Reports, |
| | Supervisor Tech Maintenance Full Access |
| Supervisor | View Inspection Full, Dispute Inspection Limited, Supervisory Level |
| | Reports, Supervisor Tech Maintenance Limited Access |
| Supervisor Limited | View Inspection Limited, Dispute Inspection Limited, Supervisory Level |
| | Reports Limited |
| Inspector | Full Access Inspection Menu, Full Access Reports, Full Access |
| Supervisor | Supervisory, Limited Access Administration |
| Inspector Lead | Work Queue Full, Add Inspections, View Inspection Full, Inspector |
| | Reports (Transfers to Inspector Queue Screen) |
| Inspector | Add Inspections, View Inspections Limited, Inspector Reports (Transfers |
| | to Inspector Queue Screen) |
| Employee | View Inspections, Employee Reports |

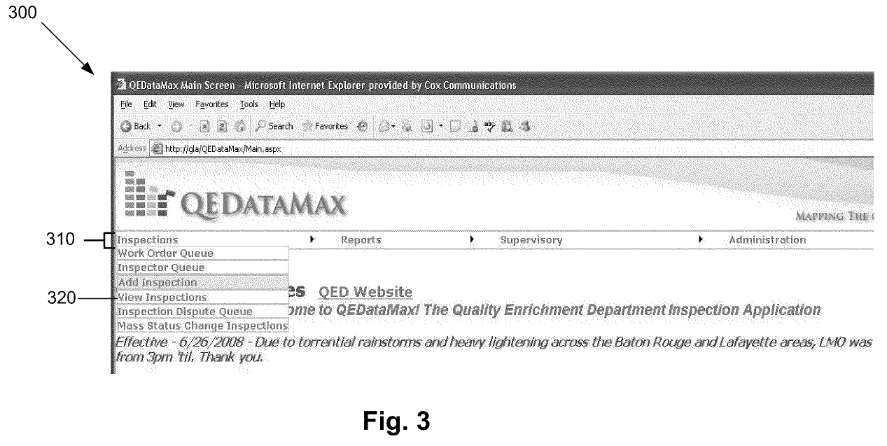

FIGS. 3-5 show three ways in which inspections may be added through the real-time quality data system. FIG. 3 shows a drop-down menu on the Real-Time Quality Data System main screen 300 for adding an inspection according to one embodiment. In FIG. 3, the inspections menu 310 is selected. From the inspections menu 310, the add inspection 320 is chosen.

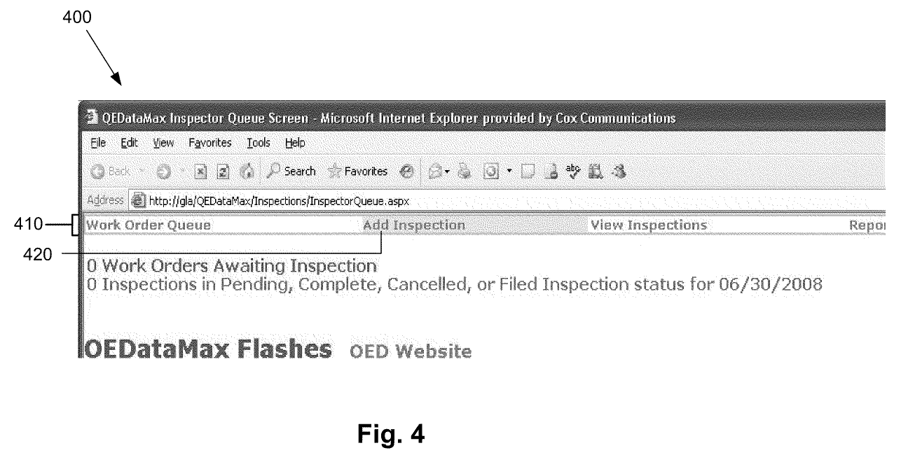

FIG. 4 shows the Real-Time Quality Data System Inspector Queue screen 400 according to one embodiment. Users may add an inspection from the Inspector Queue menu 410 by selecting Add Inspection 420.

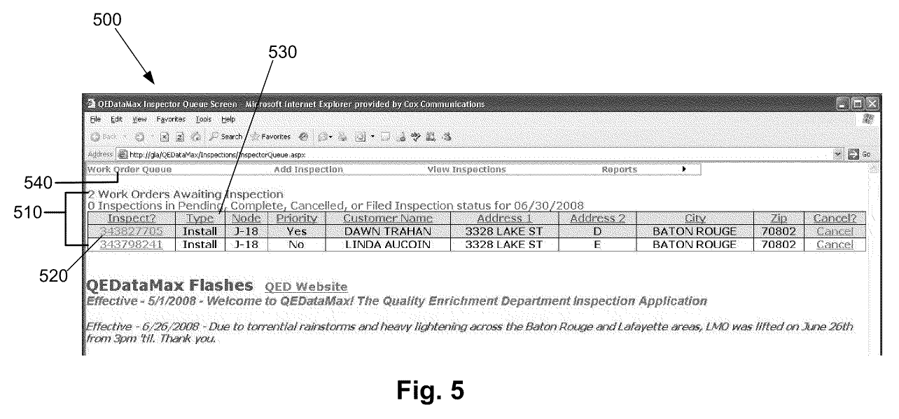

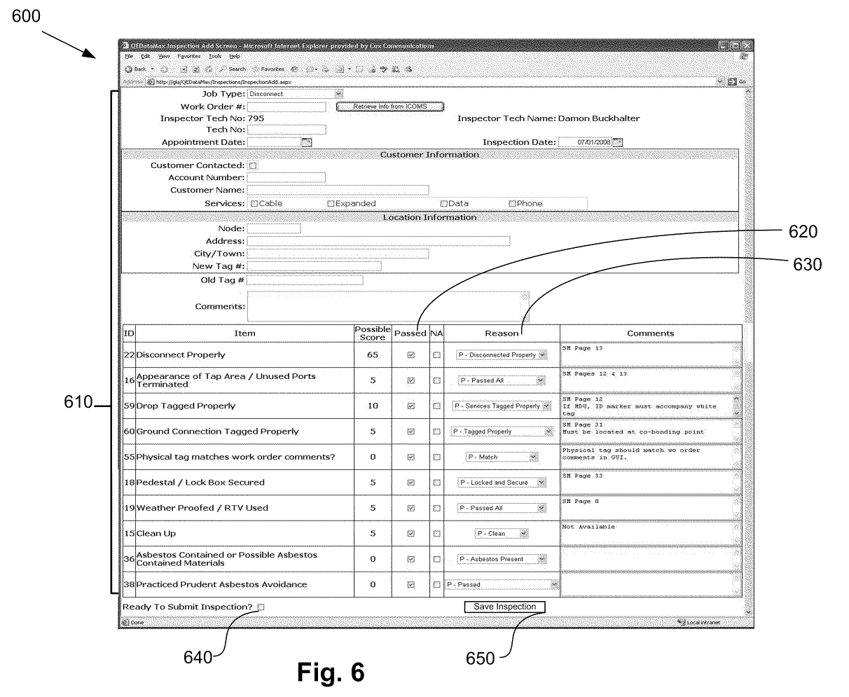

FIG. 5 shows the Inspector Queue screen 500 according to one embodiment when two work orders are awaiting inspection 510. In order to add an inspection, users may select a specific inspection's Work Order Number 520 in the inspect column that applies. An inspection add screen (see FIG. 6) will automatically open the listed Job Type 530 based on the work order number selected. Users will not be able to edit any field pulled from the work order queue 540.

FIG. 6 shows Real-Time Quality Data System Inspection Add screen 600 according to one embodiment. In FIG. 6, users enter all appropriate information in the fields 610. Inspection line items that pass 620 must have a passed reason 630 and inspection line items that fail 620 must have a failed reason 630. After filling out the fields, users may then check the Ready To Submit Inspection checkbox 640, which allows users to then select the Save Inspection button 650.

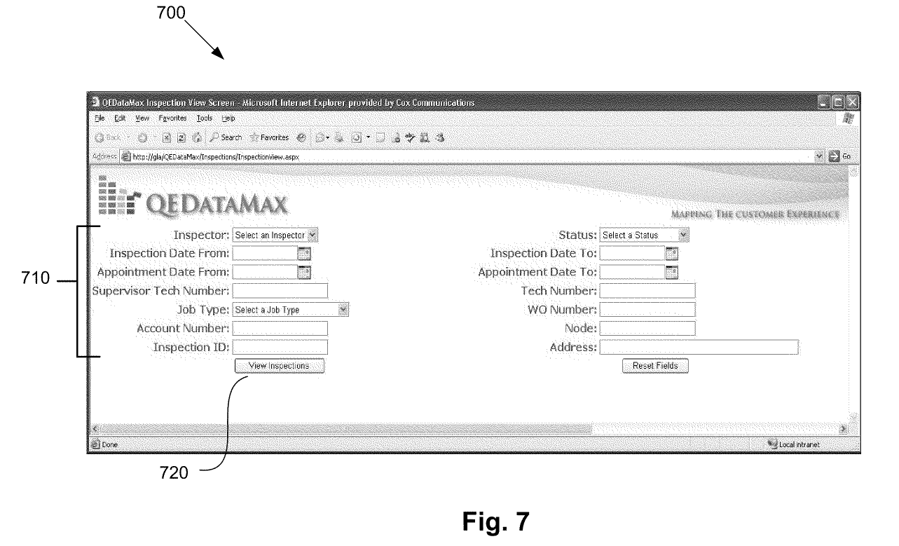

FIG. 7 shows the Inspection View screen 700 according to one embodiment. In FIG. 7, users may find inspections in the real-time quality data system. Users may use a number of fields 710 as criteria in their search. After entering the appropriate data into the fields, users select the View Inspections button 720 in order to bring up a list of inspections matching the criteria.

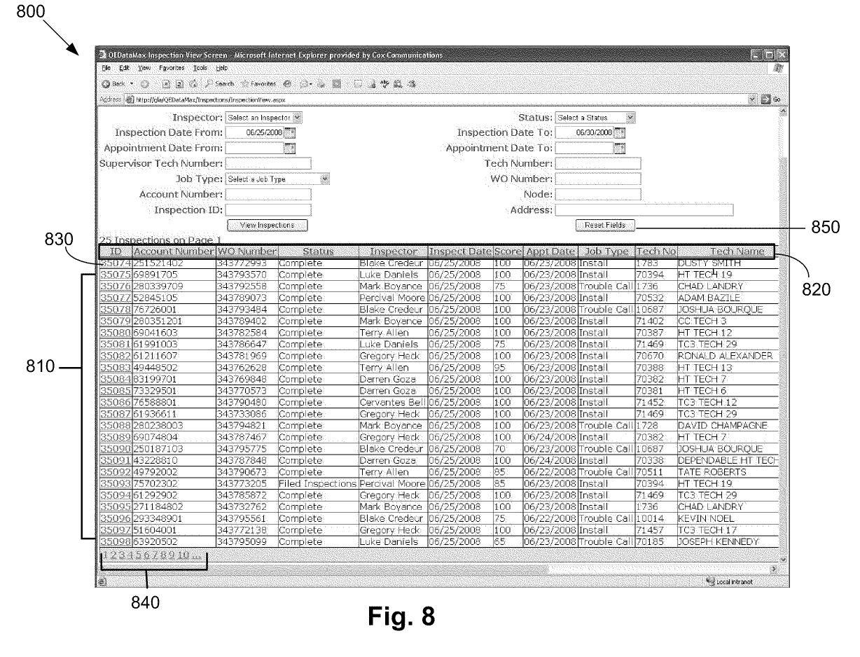

FIG. 8 shows the Inspection View screen 800 according to one embodiment with a list of the inspections matching the criteria being displayed 810. All columns can be sorted by clicking the column header links 820. Users may see the details of an inspection by selection the Inspection ID 830. Users select the number of the page 840 at the bottom of the grid in order to move through the list of inspections that meet their criteria. To start a new search, users select the Reset Fields button 850.

Table 2 shows the different statuses for an inspection, along with a description of each status.

TABLE 2

| Status | Description |
|---|---|
| Pending | Inspection is pending administrator or inspector supervisor approval. |
| In Process | Inspection is in process and awaiting administrator or inspector |
| | supervisor action. |
| Complete | Inspection is in completed and counts towards inspection reports. |
| Rejected | Inspection was rejected by the Administrator or inspector supervisor. |
| Cancelled | Inspection was cancelled by the Administrator or inspector supervisor. |
| | Cancelled inspections still count towards the Inspector's totals |
| Discarded | Inspection was discarded by the Administrator or inspector supervisor. |
| | Discarded inspections DO NOT count towards the Inspector's totals. |
| Filed Inspections | Inspection was filed for informational purposes only. Does not count |
| | towards reporting. |
| Practice | Inspection was a practice for the Inspector. |
| Inspections | |

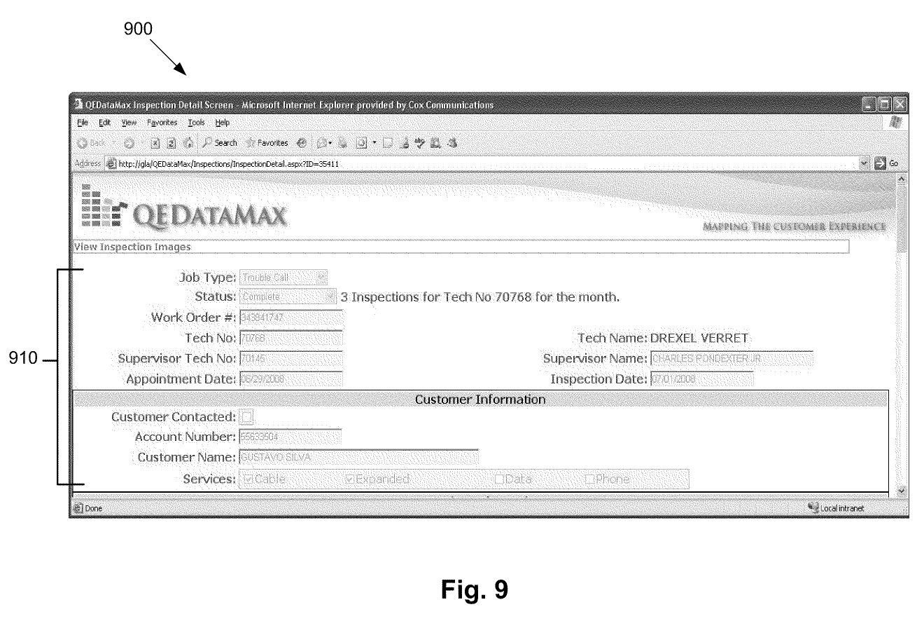

FIG. 9 shows the Real-Time Quality Data System Inspection Detail screen 900 according to one embodiment accessed by Supervisor, Supervisor Limited, Contract Supervisor, Manager, and Employee user types. In FIG. 9, the inspection information 910 is read only. The user may select the View Inspection Images option 920 to open the Image View Screen (see FIG. 12).

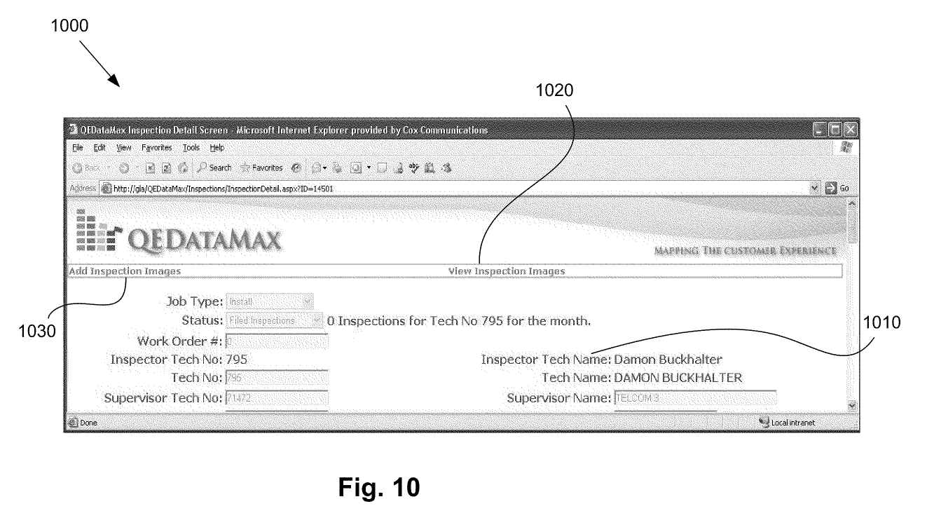

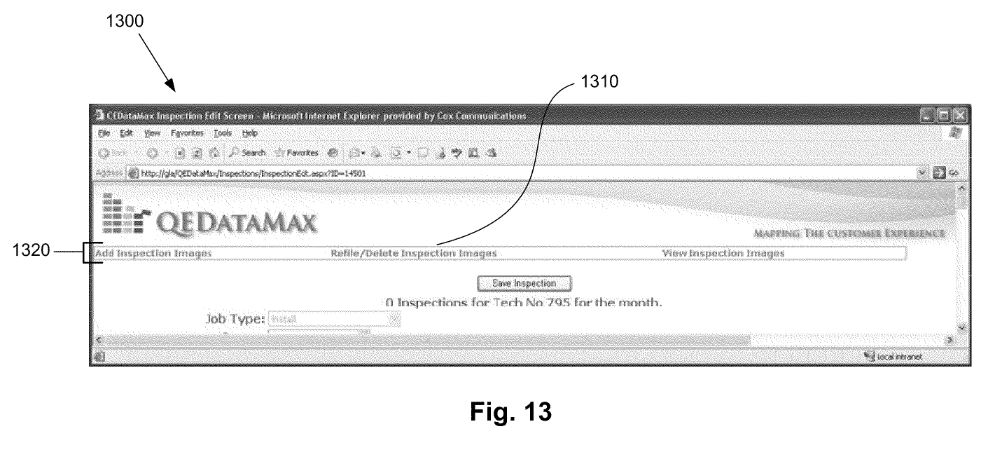

FIG. 10 shows the Real-Time Quality Data System Inspection Detail screen 1000 according to one embodiment when multiple security roles have access to different information and functions on the Real-Time Quality Data System Inspection Detail screen 1000. Supervisor, Supervisor Limited, Contract Supervisor, and Manager user types can see all data except the inspector 1010. This role can also add disputes on inspections and view inspection images 1020. The Employee user type can see all data except the inspector 1010. This role can view inspection images 1020. Administrator, Inspector, and Inspector Leads user types can see all data, add inspection images 1030, and view inspection images 1030. From the Inspection Detail 1000 or Inspection Edit screen (see FIG. 13) users may select the Add Inspection Image option 1030 in order to open the Add Inspection Image screen 600 as shown, for example, in FIG. 6.

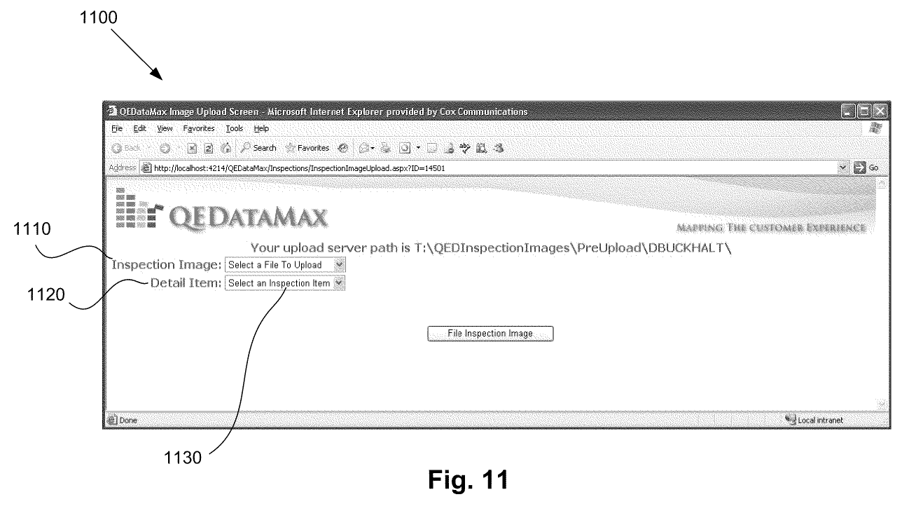

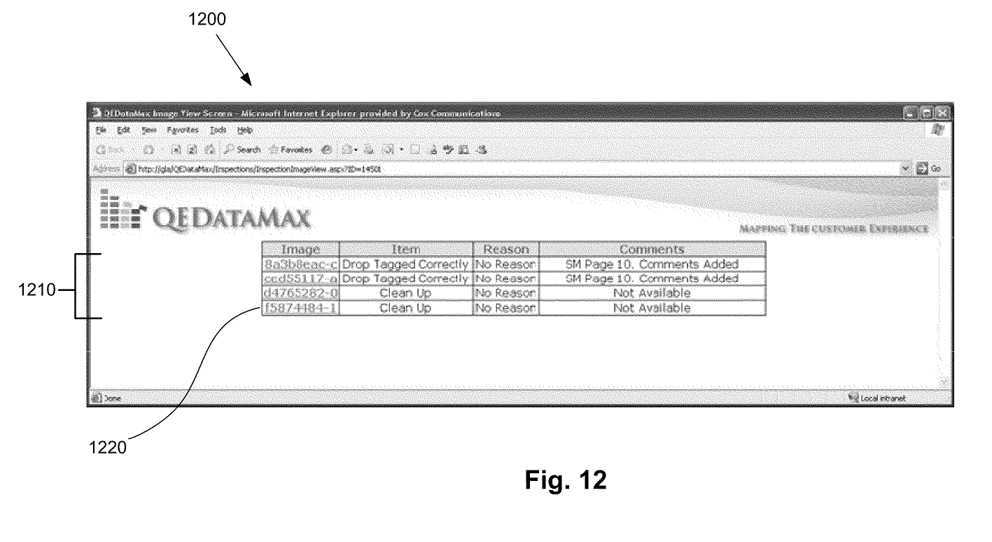

FIG. 11 shows the Image Upload screen 1100 according to one embodiment. In FIG. 11, users may select an Inspection Image 1110 and a Detail Item 1120 to attach the image to within the Add Inspection Image screen. The Detail Item list 1130 will only show those items that failed. When an image is selected, the screen will refresh and show the image on the screen so the user can confirm that the image selected is the correct image for the detail item.

FIG. 12 shows the Image View screen 1200 according to one embodiment with a list of images, the item they are attached to, reason for not passing, and the comments of that detail item 1210. The user may select a specific image name 1220 in the Image column in order to view a particular image.

FIG. 13 shows the Inspection Edit screen 1300 according to one embodiment. The user may select the Refile/Delete Inspection Images 1310 from the menu options 1320.

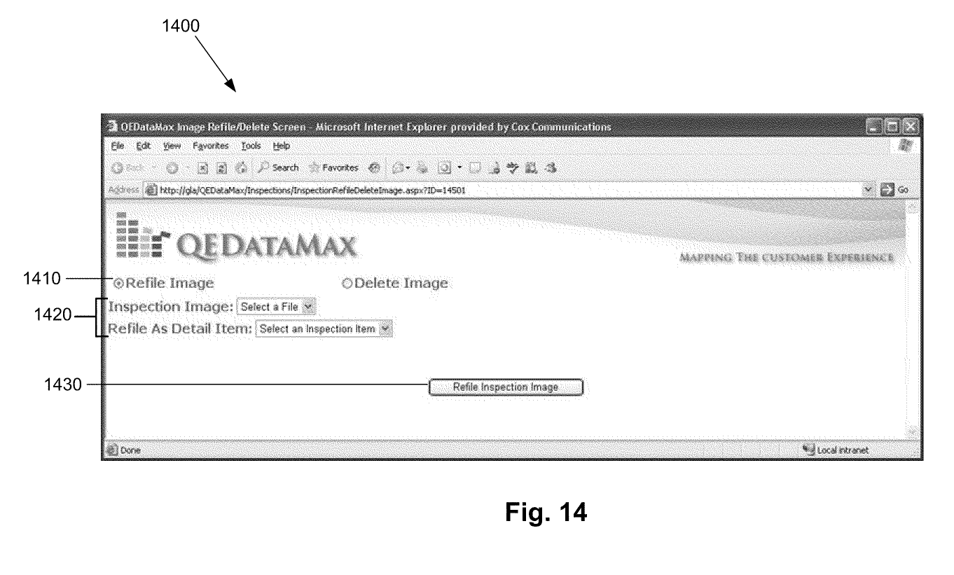

FIG. 14 shows the Image Refile/Delete screen 1400 according to one embodiment where the user can refile an image in order to move it from one detail item to another within the inspection. The user may select the Refile Image option 1410. After entering the appropriate data into fields 1420, the user will select the Refile Inspection Image button 1430 to refile the image.

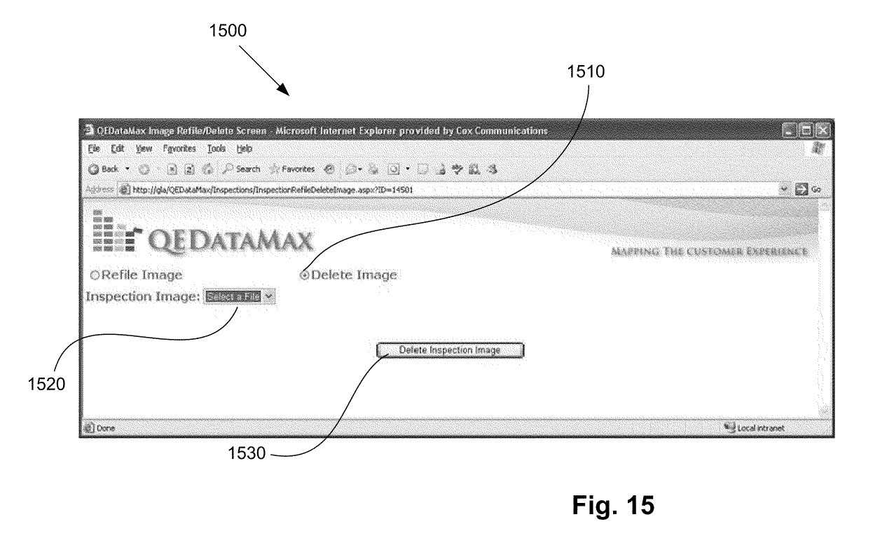

FIG. 15 shows the Image Refile/Delete screen 1500 according to one embodiment. The user may select the Delete Image option 1510, and then enter the Inspection Image 1520. After entering the Inspection Image 1520, select the Delete Inspection Image button 1530 to delete the image from the inspection.

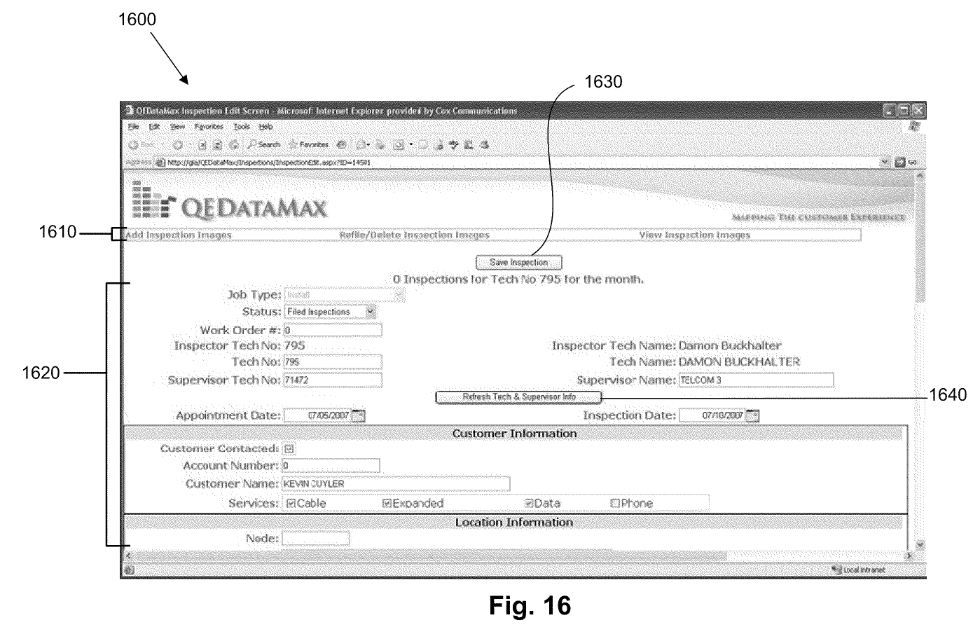

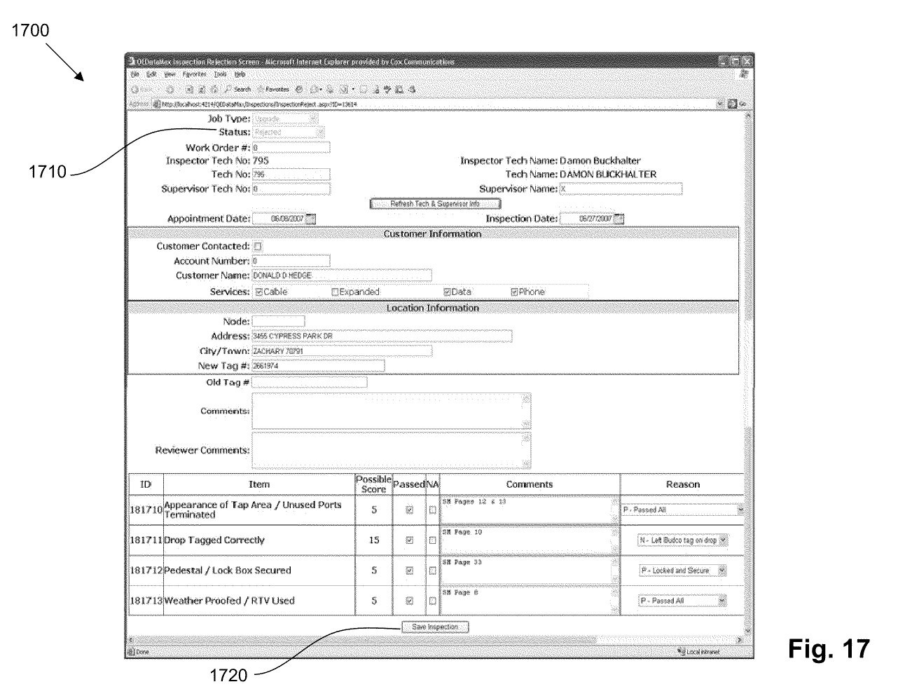

FIG. 16 shows the Inspection Edit screen 1600 according to one embodiment accessible only to administrators of an Inspection Type. Administrators will enter the appropriate information into the editable fields 1620, and then save the changes by selecting the Save Inspection button 1630. If the users need to refresh the screen with the current information listed for the tech number on the inspection form, the user may select the Refresh Tech & Supervisor Info button 1640. Additionally, administrators can choose one of the screen menu options 1610 to perform other functions.

FIG. 17 shows the Inspection Rejection screen 1700 according to one embodiment. FIG. 17 is displayed when the Status field 1710 is set to Rejected. Inspector may correct the issues, and then select the Save Inspection button 1720.

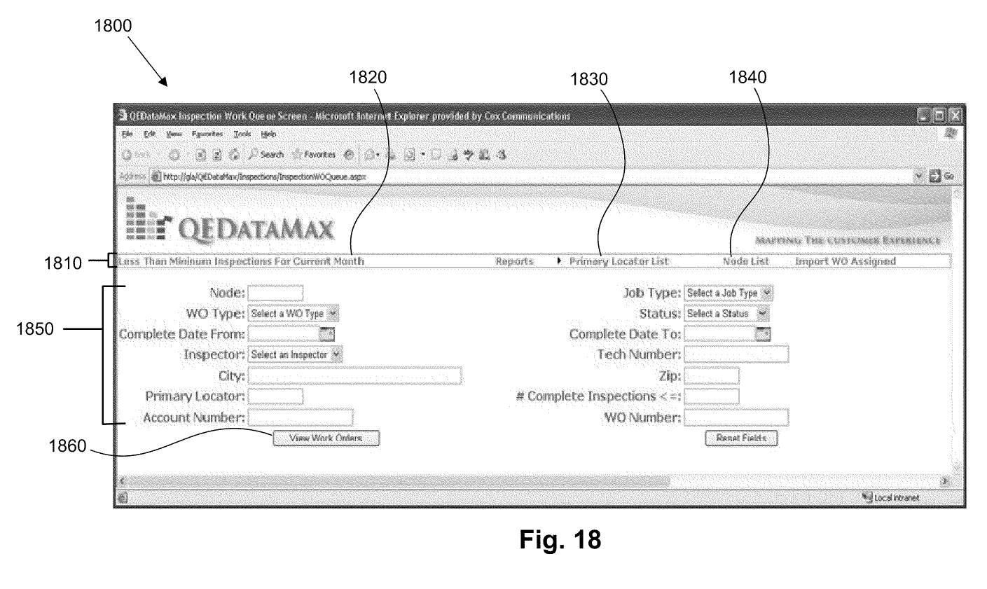

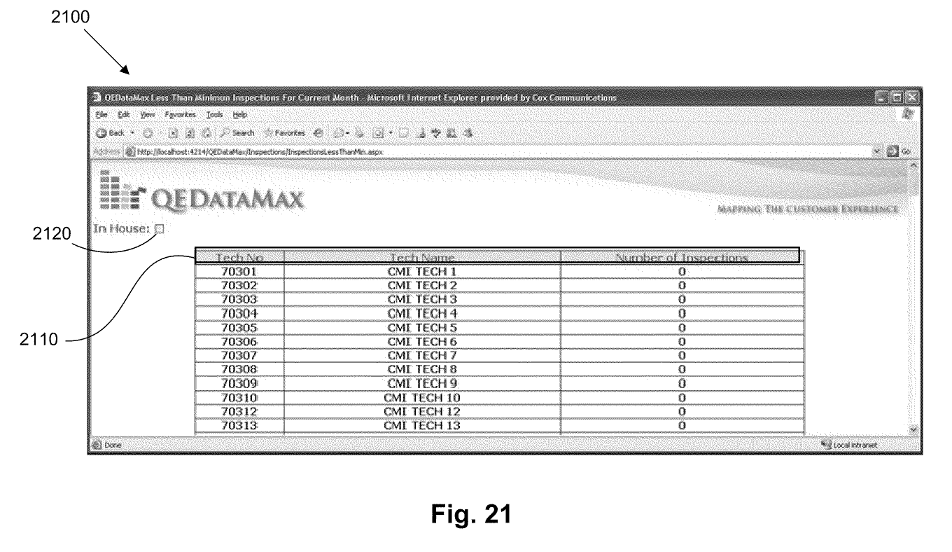

FIG. 18 shows the Inspection Work Order Queue 1800 used to assign work to inspectors according to one embodiment. Users may use a number of fields 1850 as criteria in their search. After entering the appropriate data into the fields, users select the View Work Orders button 1860 in order to bring up a list of work orders that match the criteria. Users may also select to view techs with Less Than Minimum Inspections For Current Month 1820, view the Primary Locator List 1830, or view the Node List 1840 from the menu options 1810 (see FIGS. 21-23).

Table 3 shows the different ICOMS Type Codes assigned to a work order, along with a description of each type. Table 3 also shows the Real-Time Quality Data System Job Type that each Icoms type code is mapped to for Field Service Inspections.

TABLE 3

| ICOMS TYPE | | Real-Time Quality Data |
|---|---|---|
| CODE | ICOMS DESCRIPTION | System Job Type |
| SR | Special Request Order (SRO) | |
| DW | Downgrade | |
| IN | Install | Install |
| RS | Reschedule | Install |
| UP | Upgrade | Upgrade |
| DI | Disconnect | Disconnect |
| NP | Non Pay | Disconnect |
| TC | Trouble Call | Trouble Call |

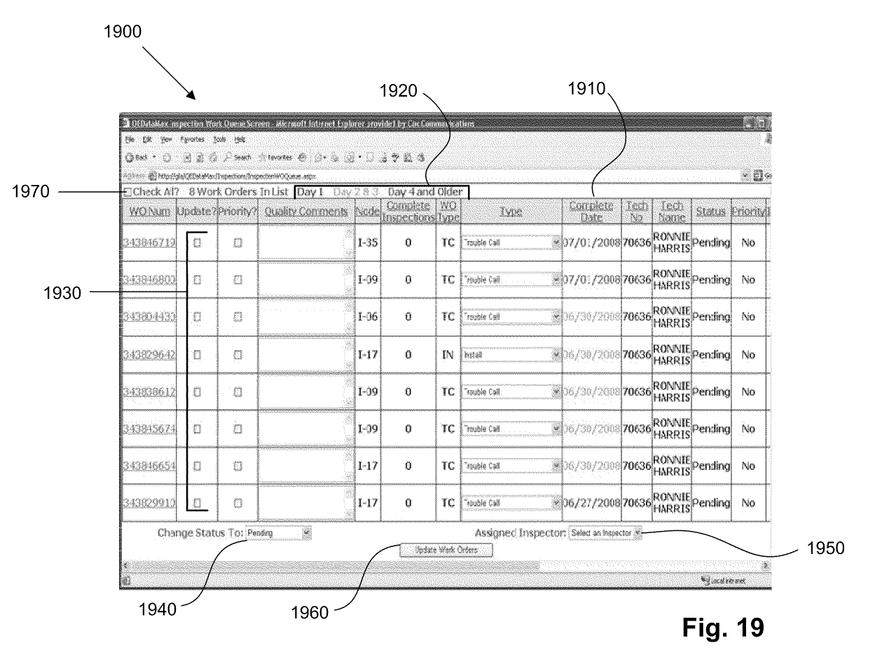

FIG. 19 shows the Inspection Work Queue screen 1900 according to one embodiment where list of eight work orders are displayed. In FIG. 19, the Complete Date column 1950 is color coded according to the number of days back 1920. Specific work orders can be assigned to an inspector by checking the Update? checkbox 1930, setting the Change Status To field 1960 to Assigned, and then selecting an appropriate inspector in the Assigned Inspector option 1970. After editing the fields, select the Update Work Orders button 1980. The user may check the Check All? box 1910 to automatically check all the Update? checkboxes 1930.

Table 4 shows the different statuses for a Work order, along with its description.

TABLE 4

| Status | Description |
|---|---|
| Pending | Work order is pending assignment. |
| Assigned | Work order has been assigned to an inspector for inspection. |
| Cancelled | Work order has been cancelled and will not be inspected. |
| Completed | Inspection has been completed on the work order. |
| Pre | Work order has been pre assigned to an inspector for |
| Assigned | the next days work |
| Admin | Administrator cancelled the work order. |
| Cancelled | |

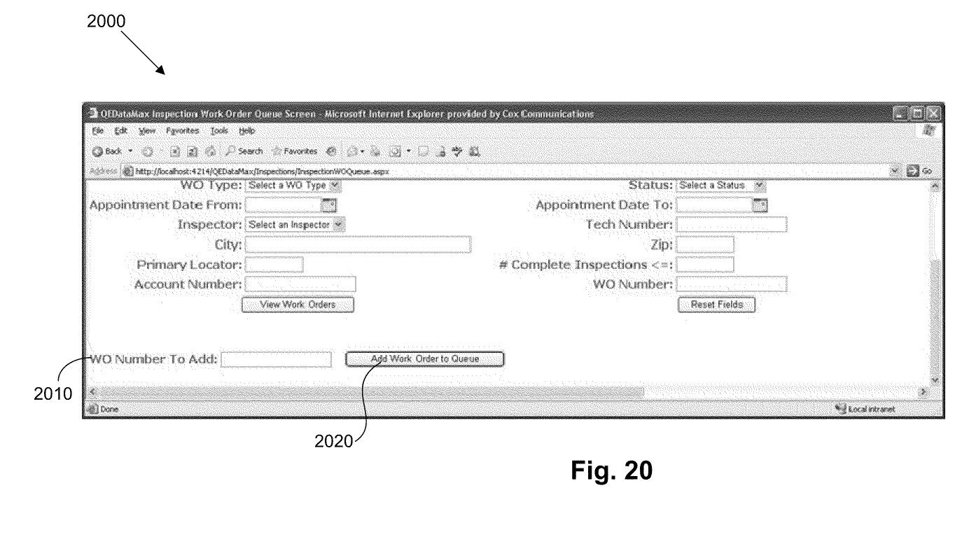

FIG. 20 shows the Inspection Work Order Queue screen 2000 according to one embodiment in which the user can add a work order to the queue. The user will enter the work order number in the WO Number To Add field 2010, and then select the Add Work Order to Queue button 2020 to add the work order.

FIG. 21 shows a list of all techs with less than the minimum number of inspections needed for that inspection type for the current month 2100 according to one embodiment. All columns can be sorted by clicking the column header links 2110. The user may check the In House checkbox 2120 to switch between In House technicians and contractors.

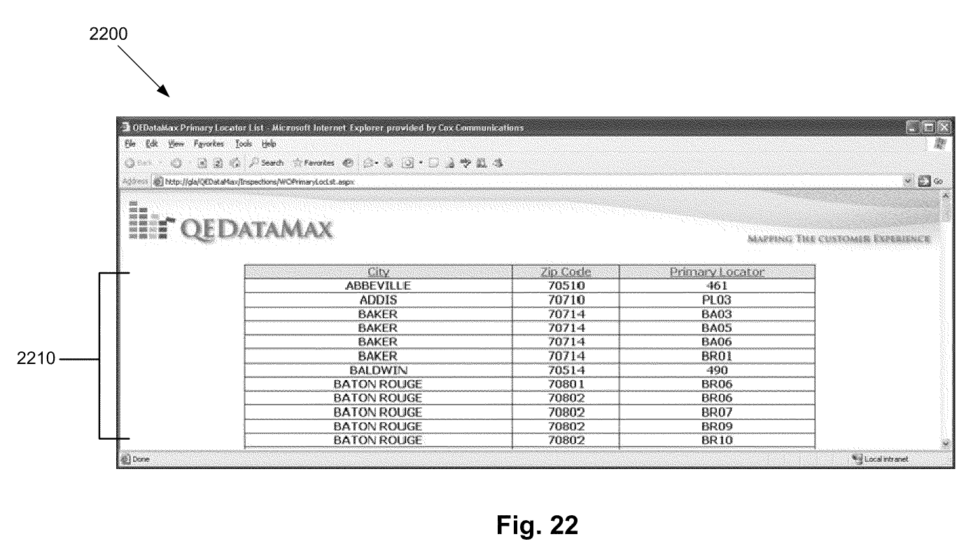

FIG. 22 shows the Primary Locator List 2200 according to one embodiment. A list of cities, zip codes, and the primary locator associated with a work order is displayed 2210 for a particular day.

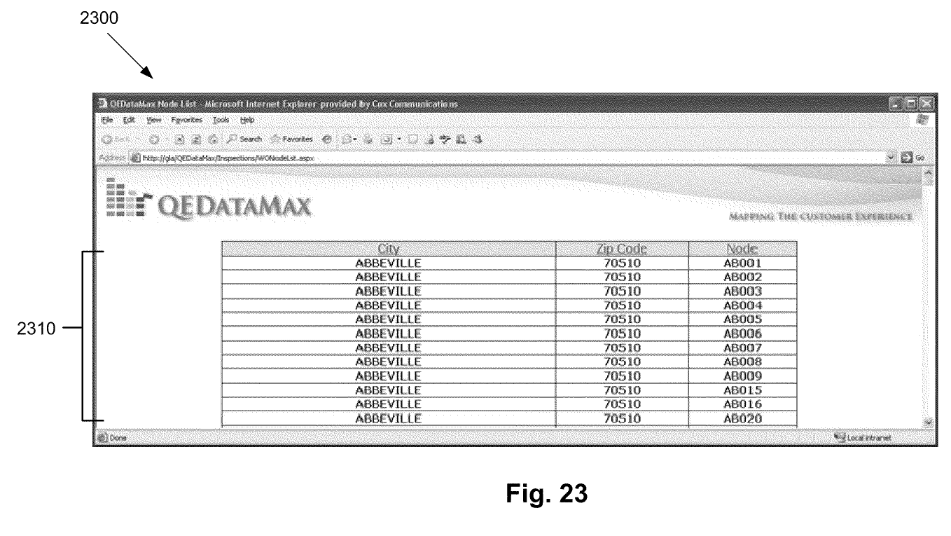

FIG. 23 shows the Node List 2300 according to one embodiment. A list of cities, zip codes and the node associated with the work order is displayed 2310 for a particular day.

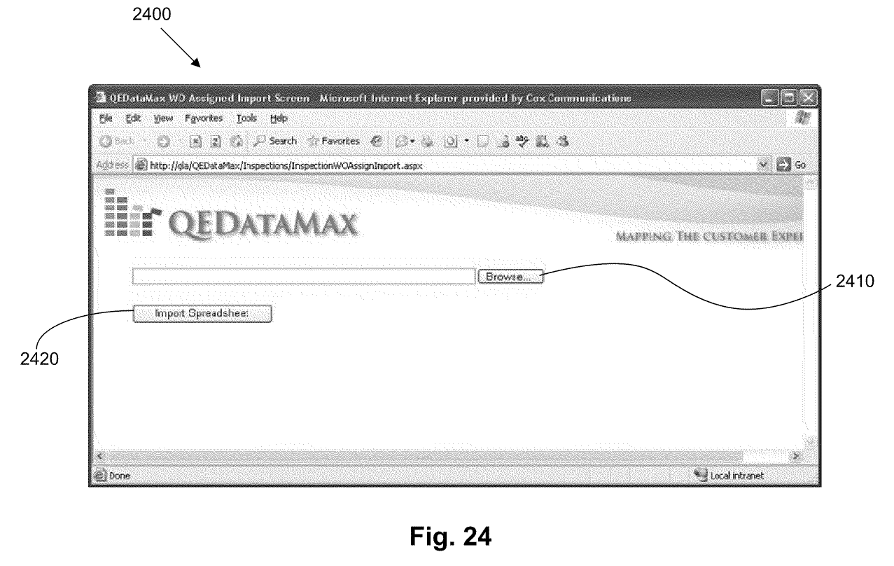

FIG. 24 shows the WO Assigned Import screen 2400 according to one embodiment that allows the importing of inspector routes that were pre assigned the previous day if needed as a back up. The user may select the browse button 2410 to choose the file to be imported, and then select the Import Spreadsheet button 2420.

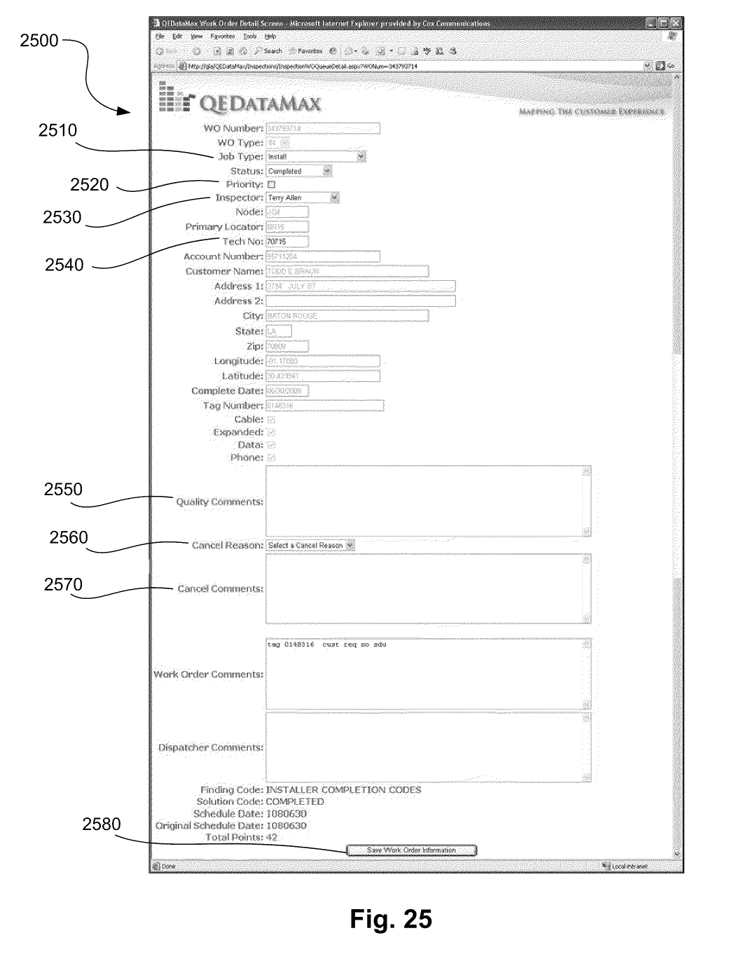

FIG. 25 shows the Work Order Detail screen 2500 according to one embodiment that displays the details of a particular work order number 2510 selected in the Work Order Queue screen (see FIG. 19). The user may edit the Job Type 2520, Priority 2520, Inspector 2530, Tech No 2540, Quality Comments 2550, Cancel Reasons 2560, and Cancel Comments 2570. The user must then select the Save Work Order Information button 2580 to save the changes.

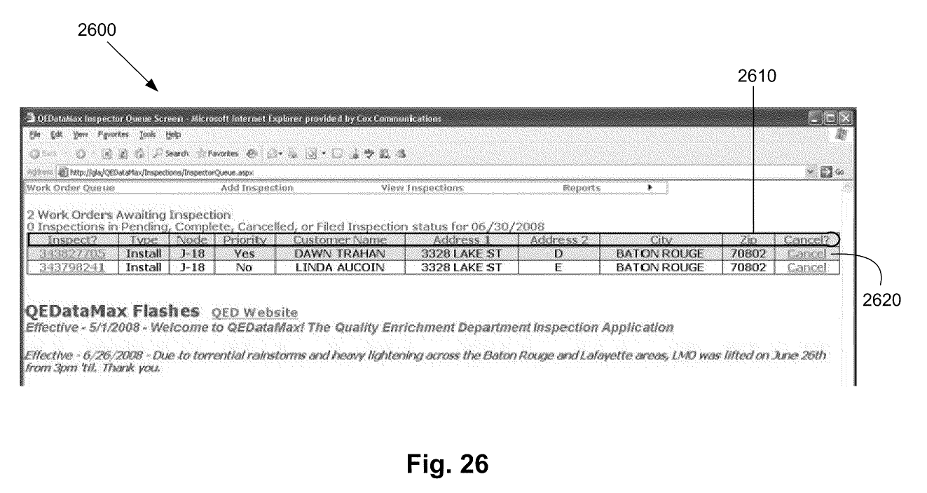

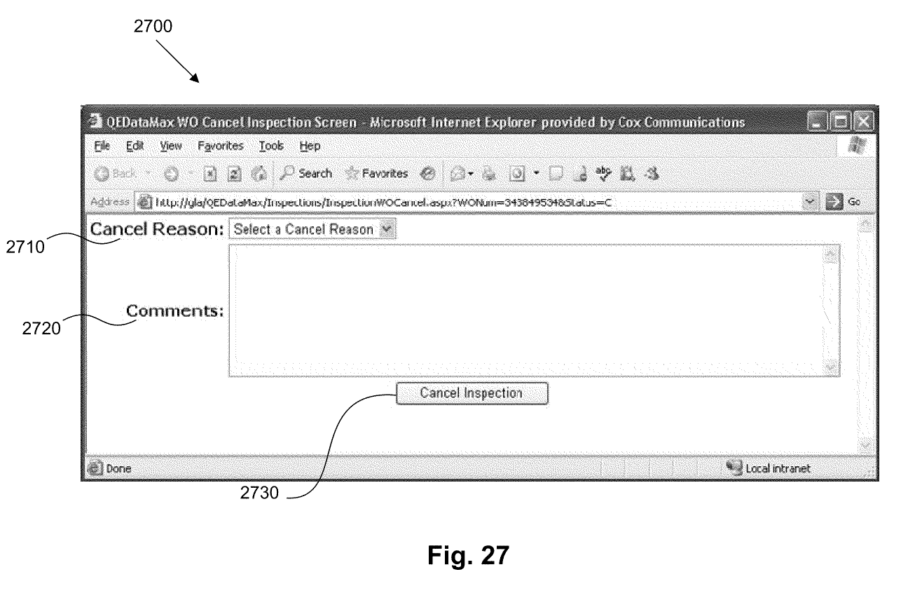

FIG. 26 shows the Inspector Queue screen 2600 according to one embodiment in which two work orders are awaiting inspection. FIG. 26 is the main screen for Inspectors and Inspector Lead user types. This screen is automatically opened to Administrators who select this screen link from the drop-down menu under Inspections on the main real-time quality data system menu (see FIG. 3). An inspector may select the cancel option 2620 corresponding to a specific work order if for some reason the inspector can not get to the site listed in the work order. This automatically brings up the Cancel Inspection screen (see FIG. 27).

FIG. 27 shows the WO Cancel Inspection screen 2700 according to one embodiment. The user may select a cancel reason 2710, and then enter cancel comments 2720. After entering the appropriate data, the user may cancel the inspection by selecting the Cancel Inspection button 2730.

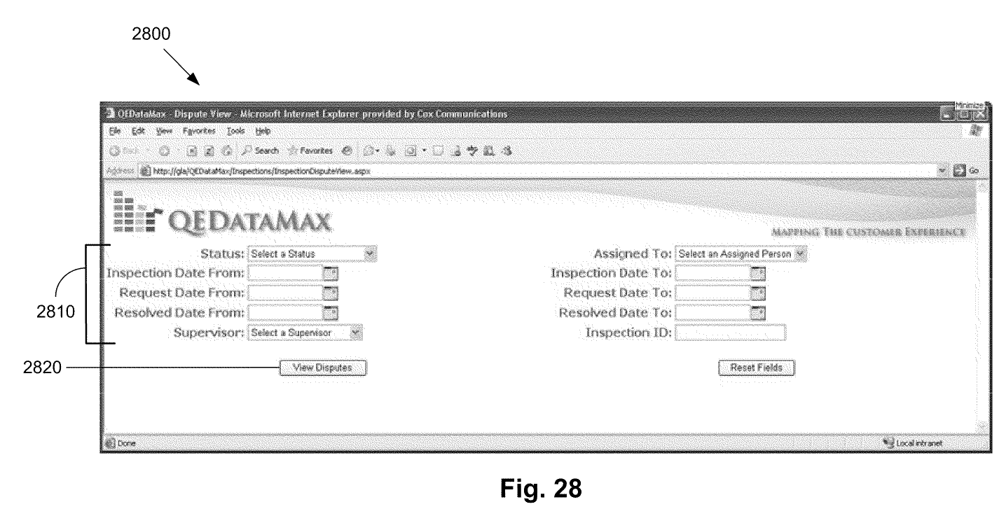

FIG. 28 shows the Dispute View 2800 according to one embodiment which is accessible by selecting the Inspection Dispute Queue from the drop-down menu under Inspections (see FIG. 3). The user may enter the appropriate criteria 2810, and then select the View Disputes button 2820 to refresh the screen with a grid of disputes matching the criteria.

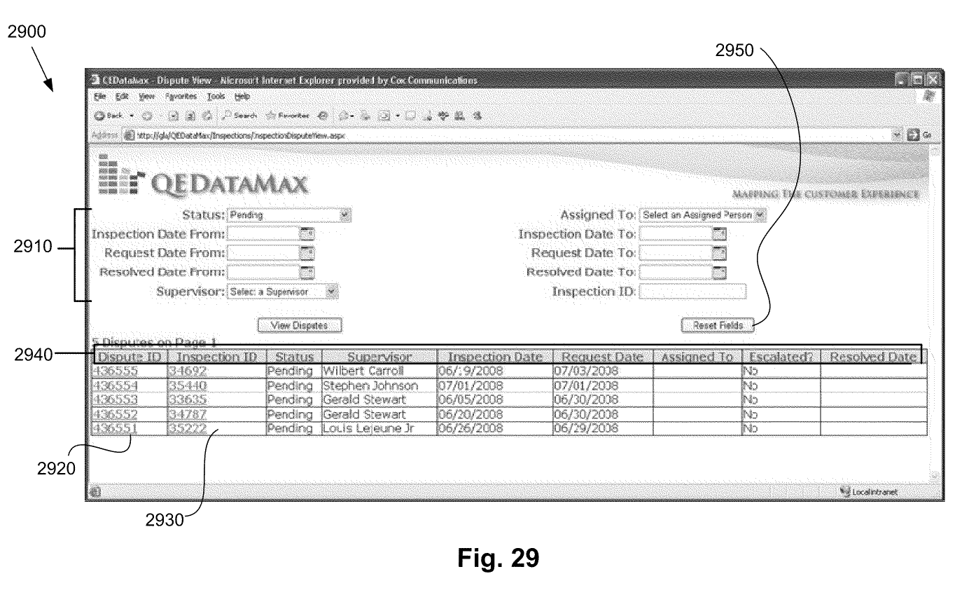

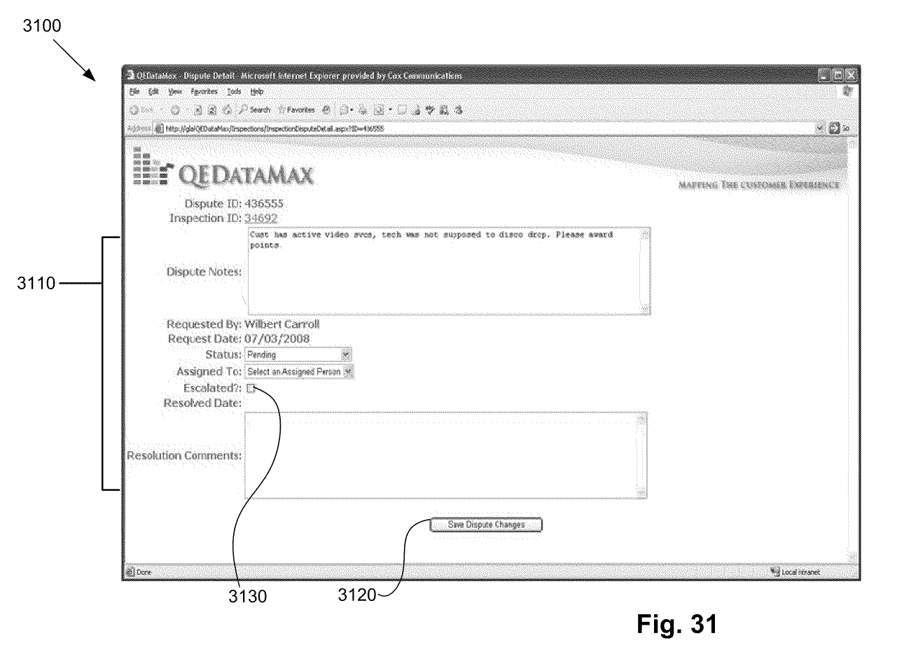

FIG. 29 shows the Dispute View screen 2900 according to one embodiment with five disputes matching the criteria being displayed 2910. In order to view and edit a dispute, users may select a specific dispute number under the Dispute ID column 2920 to open the dispute detail screen (see FIG. 31). In order to view and edit an inspection, users may select a specific inspection in the Inspection ID column 2930 to open the inspection detail screen. All columns can be sorted by clicking the column header links 2940. To start a new search, the user may select the Reset Fields button 2950.

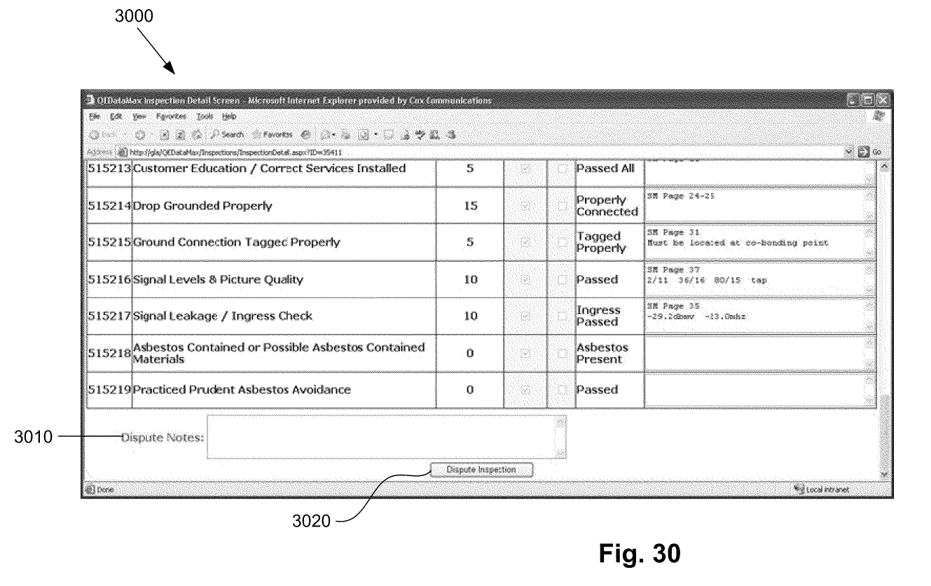

FIG. 30 shows an inspection to be disputed 3000 according to one embodiment. Manager, Supervisor, Contract Supervisor, and Supervisor Limited user types may add a dispute by entering the dispute comments for the inspection in the Dispute Notes area 3010. The user may then select the Dispute Inspection button 3020.

FIG. 31 shows the Dispute Detail screen 3100 according to one embodiment. Administrator user type may edit the dispute fields 3010, and then select the Save Dispute Changes button 3120. The Escalated? box 3130 is checked if the dispute was escalated to the manager for review.

Table 5 shows the different statuses of a dispute, along with a description.

TABLE 5

| Status | Description |
|---|---|
| Pending | The dispute has been submitted and is |
| | awaiting administrator action. |
| In Process | The dispute is being processed. |
| Escalated To | The dispute needs the quality manager to |
| Manager | review and make a decision. |
| Inspection | The inspection was cancelled. |
| Cancelled | |
| Inspection Points | Points were awarded on the inspection. |
| Awarded | |
| Inspection Stands | The inspection stands and no changes were |
| | made. |
| Dispute Cancelled | The dispute was cancelled. |

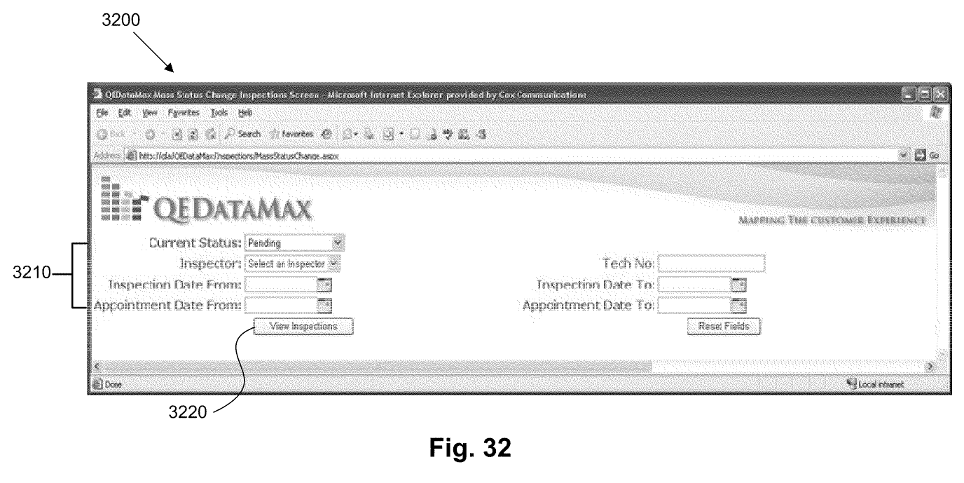

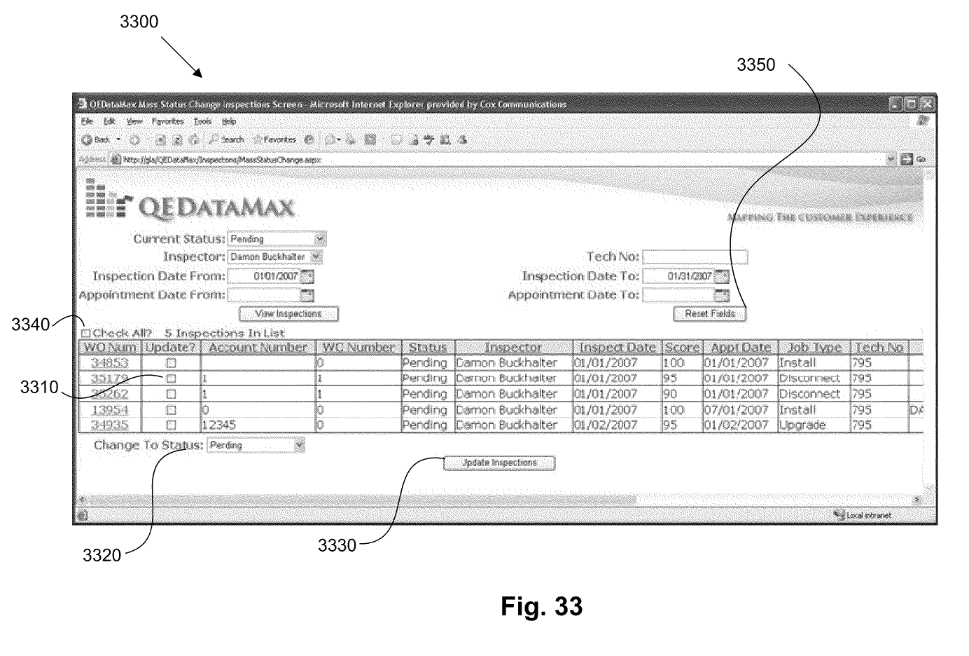

FIG. 32-33 shows the Mass Status Change Inspections screen that allows administrators the ability to change the status of large numbers of inspections at one time. FIG. 32 shows the Mass Status Change Inspections screen 3200 according to one embodiment. The user may enter the appropriate criteria for a search into the display fields 3210, and then select the View Inspection button 3220.

FIG. 33 shows the Mass Status Change Inspections screen 3300 according to one embodiment refreshed with a grid of five inspections based on the criteria provided in FIG. 32. The user may change inspection statuses by checking the box in the Update? column 3310 of the inspections to be updated. The user will also need to select the Change To Status field 3320 from the drop-down menu, and then select the Update Inspections button 3330 to change the status of the chosen inspections. To automatically check all boxes in the Update? Column 3310, select the Check All? checkbox 3340. In order to start a new search, select the Reset Fields button 3350.

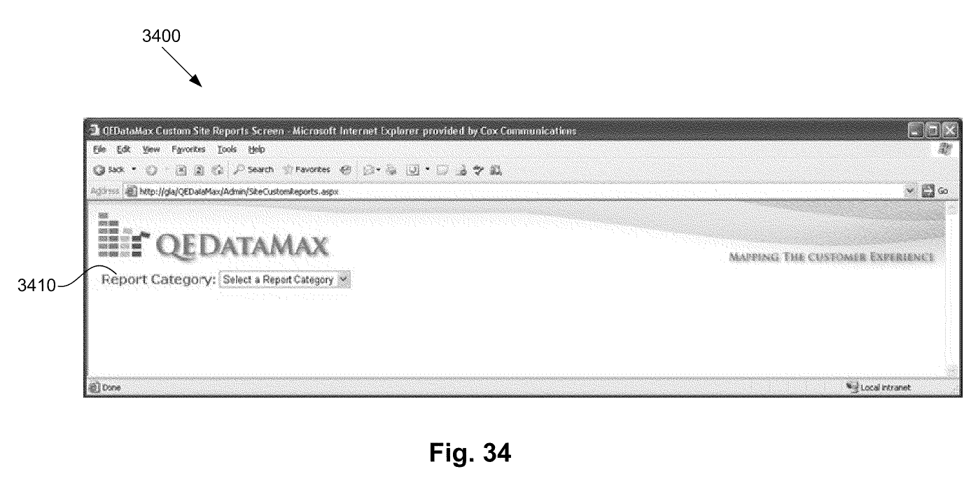

FIG. 34 shows the Custom Site Reports screen 3400 according to one embodiment. This allows sites to have custom reports to assist in sites users needs. The user will select a Report Category 3410 in order to display a list of links the user may select from to access the website, spreadsheet, or report in question.

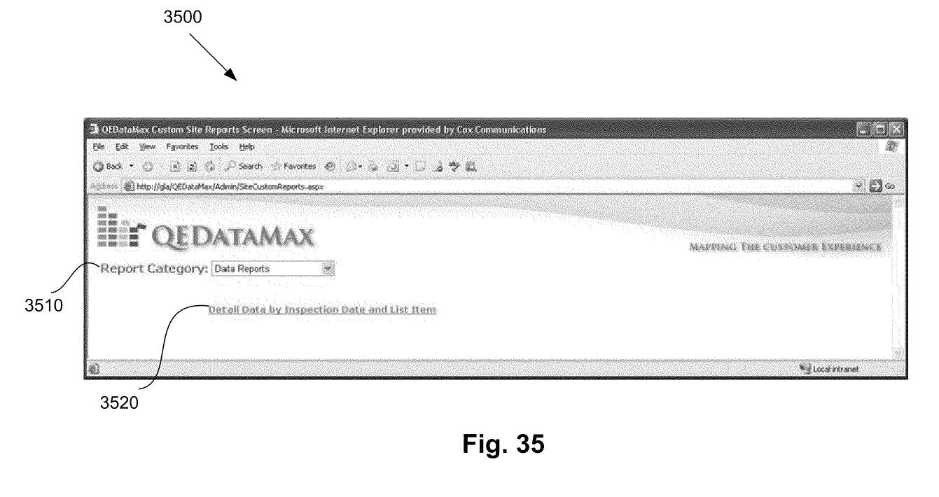

FIG. 35 shows the Custom Site Reports screen 3500 according to one embodiment in which Data Reports has been selected for the Report Category 3510. A description of the category 3520 is displayed on the screen.

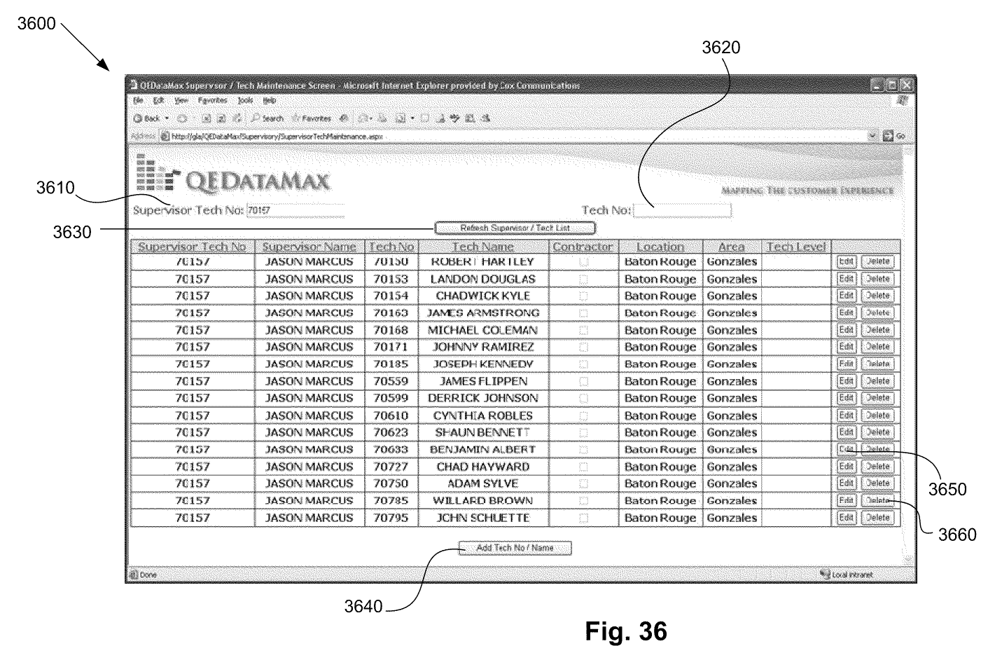

FIG. 36-39 shows the Supervisor/Tech Maintenance screen in which the user can add, edit, or delete techs for an inspection. FIG. 36 shows a list of techs for the Supervisor Tech ‘70157’ 3600 according to one embodiment. The Supervisor Tech No 3610 is automatically inserted when the specific Supervisor Tech accesses the screen. If the user needs to see another supervisor's team or tech, the user may enter a different Supervisor Tech No 3610 or Tech No 3620, and then select the Refresh Supervisor/Tech List button 3630. The user may add new techs by selecting the Add Tech No/Name button 3640, edit a tech by selecting the Edit button 3650, or delete a tech from the list by selecting the Delete button 3660.

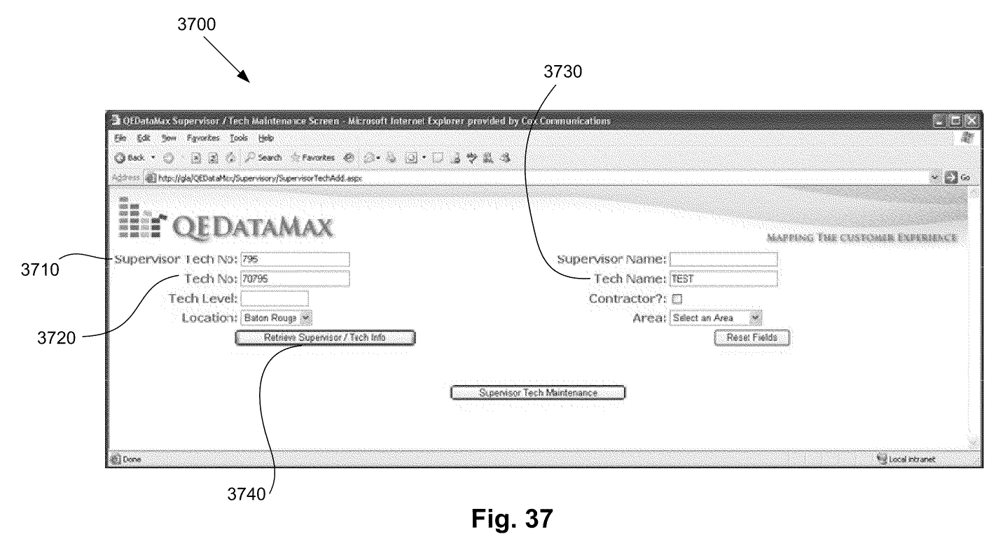

FIG. 37 shows the screen to add a tech to a supervisor list 3700 according to one embodiment. The user will enter a Supervisor Tech No 3710, a Tech No 3720, and a Tech Name 3730, and then select the Retrieve Supervisor/Tech Info button 3750.

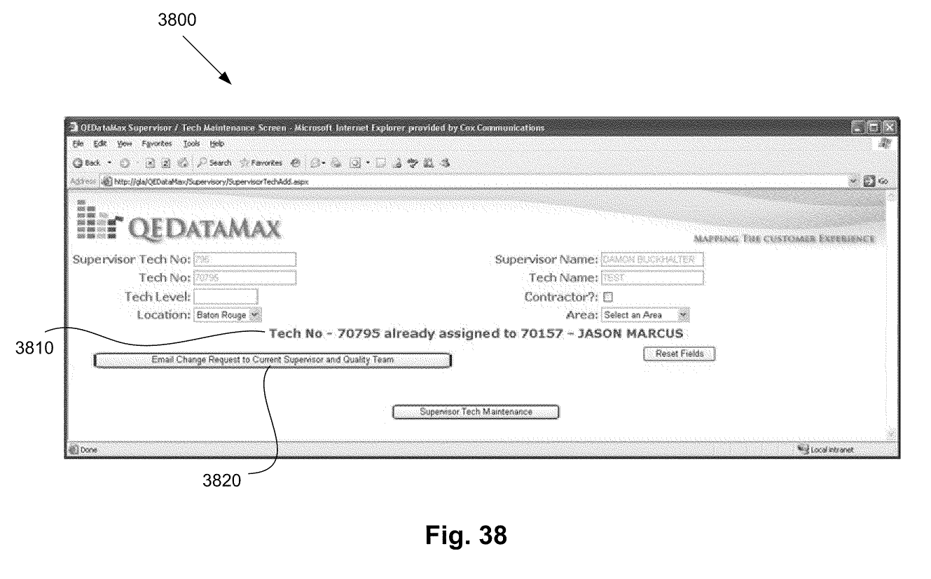

FIG. 38 shows the Supervisor/Tech Maintenance screen 3800 according to one embodiment where the tech already exists on another supervisors list when the user tried to add the tech (see FIG. 37). The screen will display the management hierarchy for the tech 3810. The user may select the Email Change Request to Current Supervisor and Quality Team button 3820 to notify the supervisor and the Quality department currently owning the tech no.

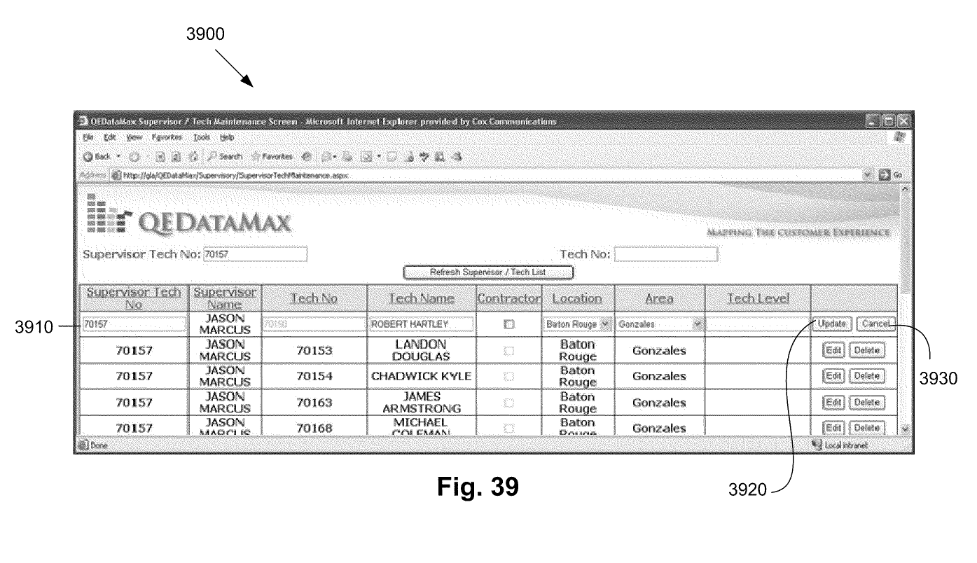

FIG. 39 shows the Supervisor/Tech Maintenance screen 3900 according to one embodiment in which a tech has been selected to be edited (see FIG. 36). The user may edit the appropriate fields 3610, and then select the Update button 3920. The user may choose to select the Cancel button 3930 to go back to the original information.

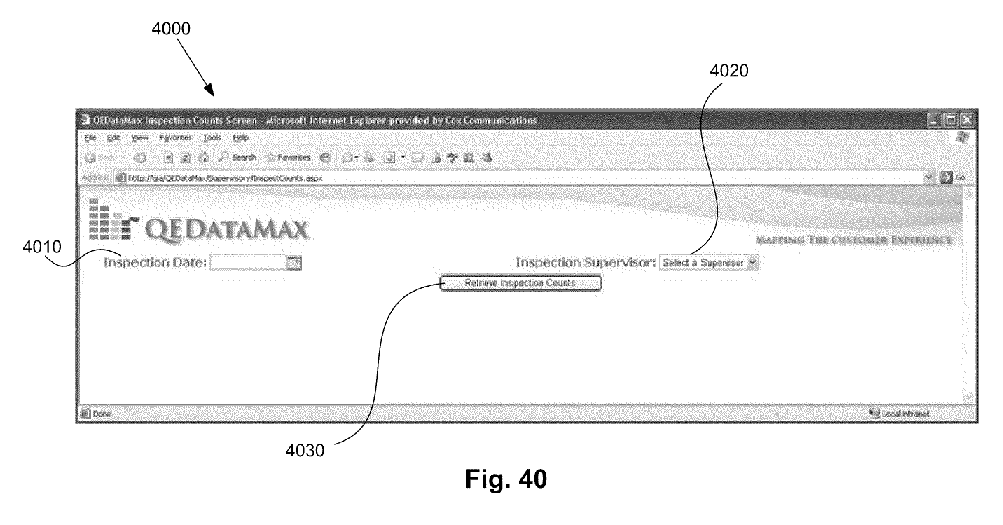

FIG. 40 shows the Inspection Counts screen 4000 according to one embodiment which is used to calculate inspector counts for a specific day. The inspection counts are compiled for reporting to show quantity of inspector work. The user will enter an Inspection Date 4010, select an Inspection Supervisor 4020, and then select the Retrieve Inspection Counts button 4030.

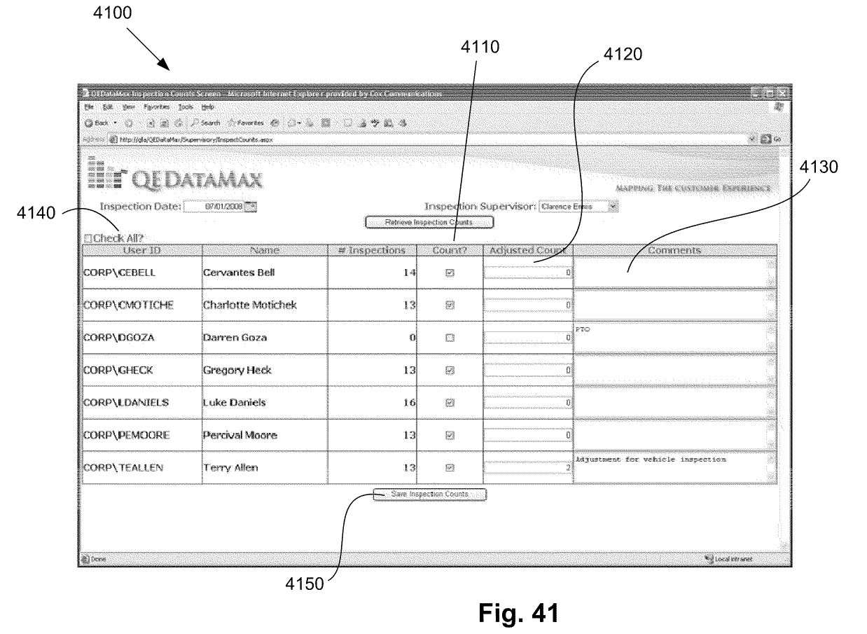

FIG. 41 shows the updated Inspection Counts screen 4100 according to one embodiment with the grid of the inspection counts retrieved (see FIG. 40). The user may select the checkbox in the Count? column 4110 to check off the inspectors whose counts should be added to the total counts for the month. The user may select the Check All? box 4140 to check off all of the Count? column 4110. An Adjusted Count 4120 can be updated to give credit for meetings, office work, etc . . . Administrators may also enter comments 4130 to the inspectors for the specific day selected. To save the entries, the user may select the Save Inspection Counts button 4150.

Table 6 shows the administration sections and their function in real-time quality data system.

TABLE 6

| Administration | |
|---|---|
| Section | Function |
| Flash | Flashes are informational entries that everyone can see from the main |
| | screen. |
| Users | Users in the system must be added through this section. Administrators can |
| | only add user types for the Inspection Type the Administrator is logged |
| | into. To grant access to another Inspection Type, the Administrator must be |
| | an Administrator in that Inspection Type. |
| Job Types | Job types are the different types of inspections that can be accomplished in |
| | an Inspection Type. |
| List Item | List Items are the items in the list for specific job types. |
| Truck Roll Costs | The month cost of a truck roll to calculate costs accrued through inspecting |
| | and fixing issues. |
| Custom Site | Custom reports created for an Inspection Type. |
| Reports | |
| Inspection Type | The different Inspection Types available in real-time quality data system. |
| | ONLY the site administrators can add/edit Inspection types. This is a flag |
| | that is set by your Information Technology Department on the back end. It |
| | is not an available setting in the application. |
| Site | The various site settings global to real-time quality data system regardless |
| | of Inspection Type. ONLY the site administrators can edit Site Settings. |
| | This is a flag that is set by your Information Technology Department on the |
| | back end. It is not an available setting in the application. |

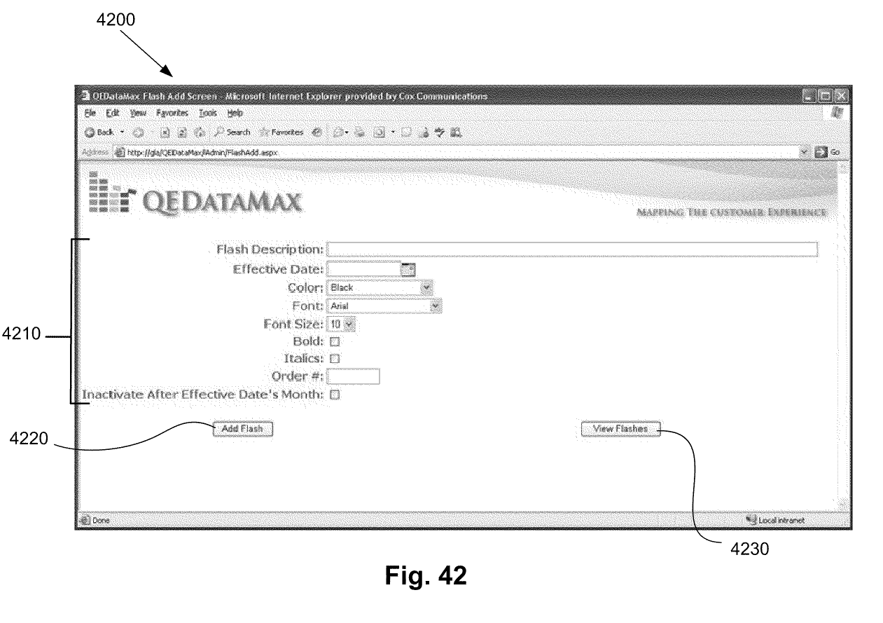

FIG. 42 shows the Flash Add screen 4200 according to one embodiment which allows the user to add flashes to the main menu screens (see FIG. 2) to inform users of a particular inspection type. The user should enter the appropriate data 4210, and then select the Add Flash button 4220. The user may then select the View Flashes button 4230 in order to view all the flashes.

Table 7 shows the fields the user must enter on the flash add screen.

TABLE 7

| Field | Description |
|---|---|
| Description | The flash that will be displayed on the screen. |
| | Maximum 1000 characters |
| Effective Date | The date the flash information takes effect. |
| | Displays before the flash |
| Color | The flash font color |
| Font | The flash font type |
| Font Size | The flash font size. Sizes are between 8 and 17 |
| Bold | Whether the flash is bold or not |
| Italics | Whether the flash is italics or not |
| Order # | The numerical order the flash falls in on the |
| | screen |
| Inactivate After Effective | Whether the flash will inactivate itself at the |
| Date's Month | end of the Effective Date's month |

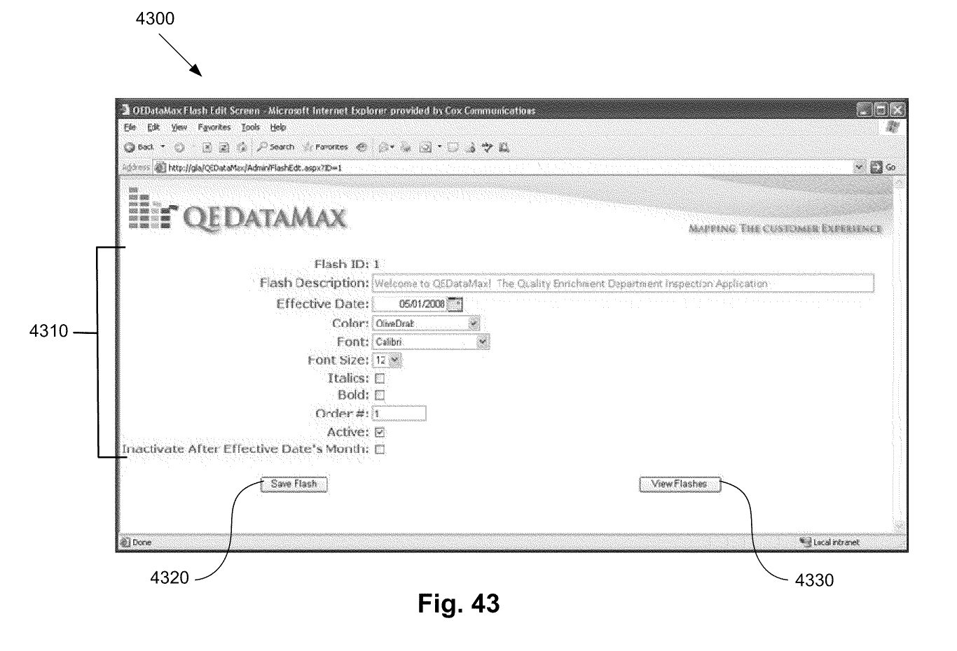

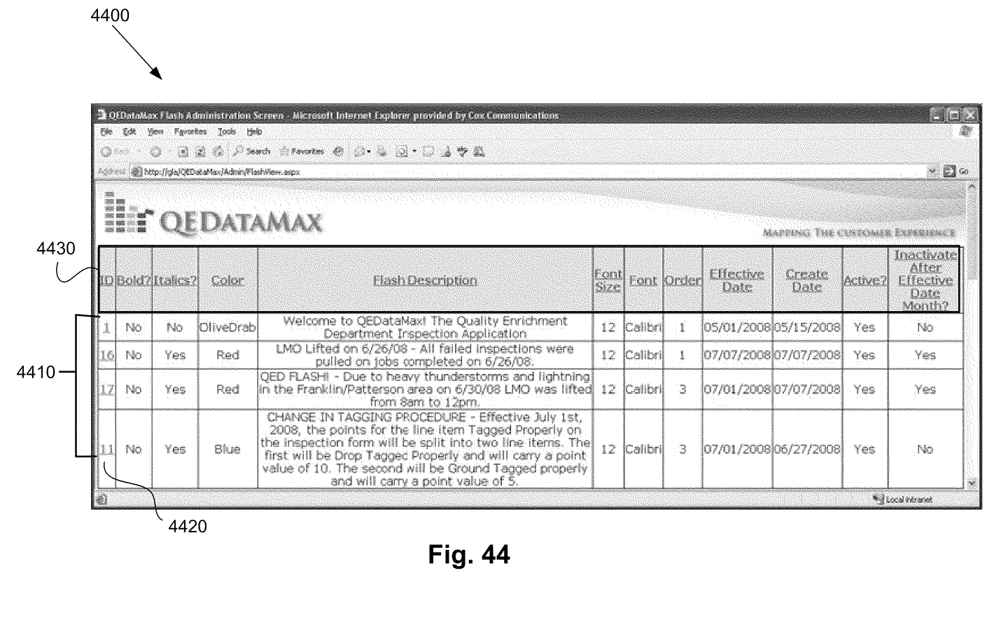

FIG. 43 shows the Flash Edit screen 4300 according to one embodiment in which the user can edit a particular flash ID from the list displayed on the Flash Administration screen (See FIG. 44). The user should enter the appropriate data 4310, and then select the Save Flash button 4320. In order to return to the Flash Administration screen to view the list of all the flashes, the user may select the View Flashes button 4230.

Table 8 show a description of the various fields the user must enter on the flash add screen.

TABLE 8

| Field | Description |
|---|---|
| ID | The flash ID |
| Description | The flash that will be displayed on the screen. |
| | Maximum 1000 characters |
| Effective Date | The date the flash information takes effect. |
| | Displays before the flash |
| Color | The flash font color |
| Font | The flash font type |
| Font Size | The flash font size. Sizes are between 8 and 17 |
| Bold | Whether the flash is bold or not |
| Italics | Whether the flash is italics or not |
| Order # | The numerical order the flash falls in on the |
| | screen |
| Active | Whether the flash is active or not. Inactive |
| | flashes DO NOT display |
| Inactivate After Effective | Whether the flash will inactivate itself at the |
| Date's Month | end of the Effective Date's month |

FIG. 44 shows the Flash Administration screen 4400 according to one embodiment accessed from the real-time quality data system main screen under the Administration menu option (see FIG. 2). A list of all flashes 4410 are displayed for the inspection type the user is logged in as. All columns may be sorted by selecting the column header links 4430. To edit a flash, select the Flash ID 4420.

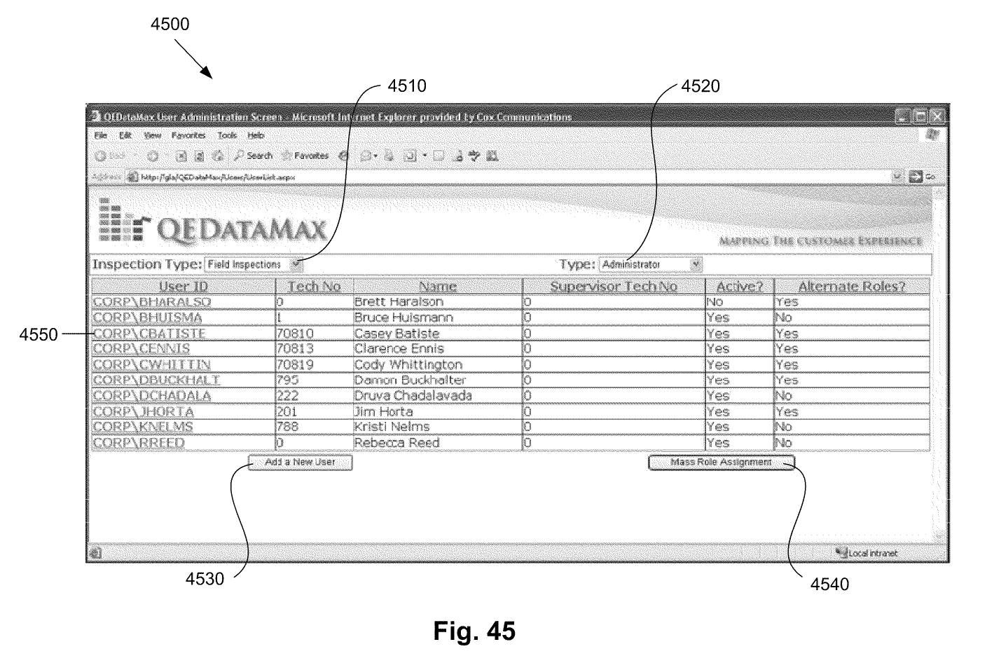

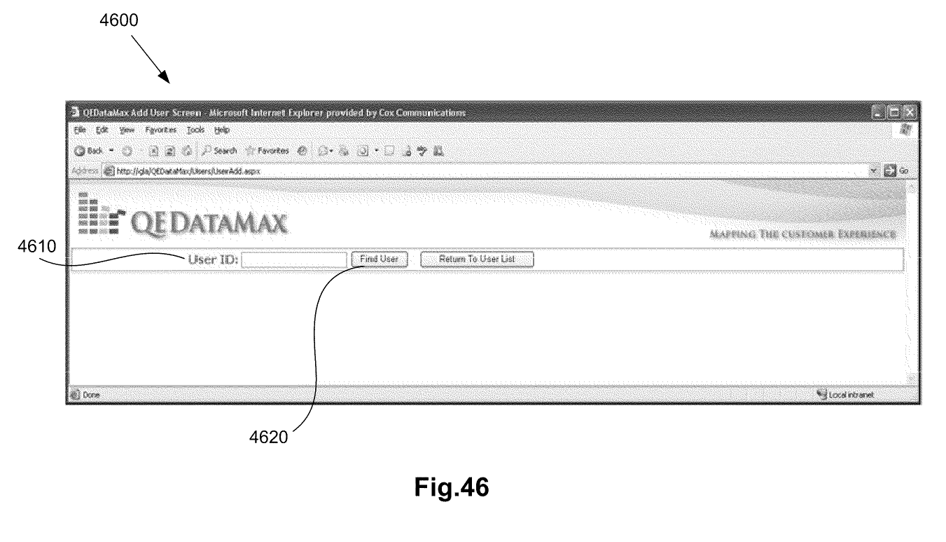

FIG. 45 shows the User Administration screen 4500 according to one embodiment that displays a list of the users who have access to the particular inspection type 4510 and user type 4520 selected. The user may select the Add a New User button 4530 to add a user to the list. To assign a group of user roles for an inspection type at one time, select the Mass Role Assignment button 4540. The administrator may also edit a user by selecting a specific User ID 4550.

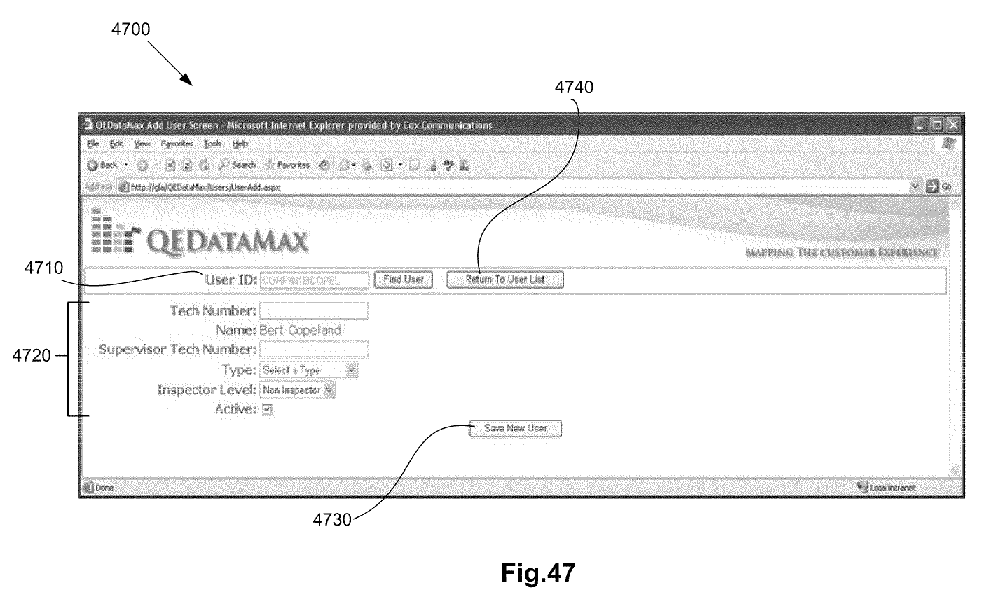

FIGS. 46-47 show the User Add screen in which administrators can set up users to access multiple inspection types and roles. FIG. 46 shows the add screen 4600 according to one embodiment in which the user will enter the network User ID 4610 of the person to be added. After entering the User ID 4610, the user will select the Find User button 4620.

FIG. 47 shows the refreshed add screen 4700 according to one embodiment that has the CORP\ domain added to the front of the now disabled User ID field 4710. The user will enter the appropriate data into the display fields 4720, and then select the Save New User button 4730. To return to the User Administration screen (see FIG. 45) without saving the information select the Return to User List button 4740.

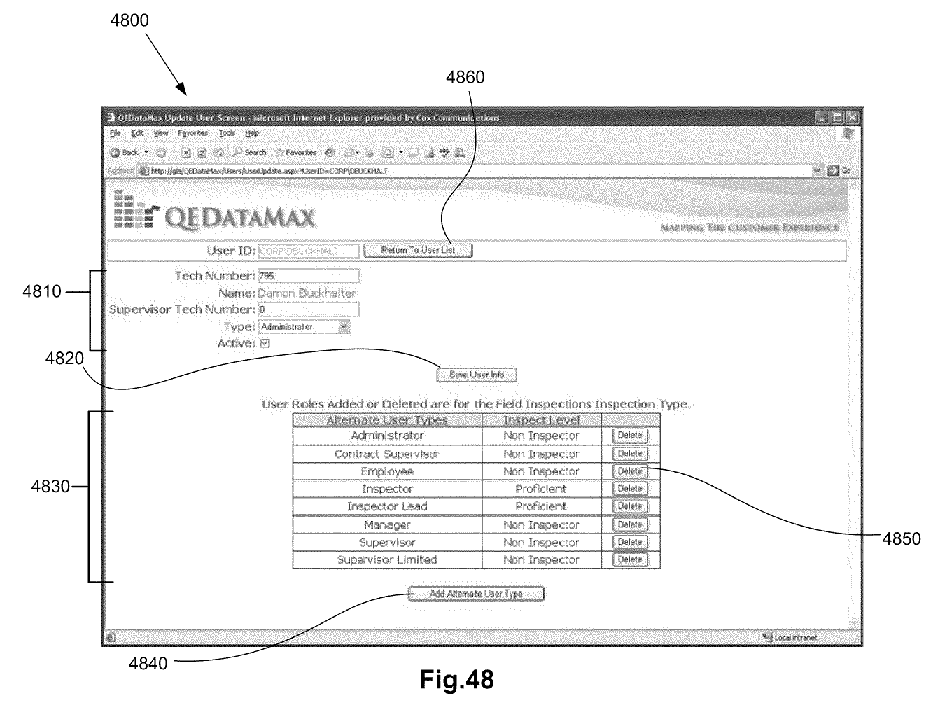

FIG. 48 shows the Update User screen 4800 according to one embodiment. Administrators can edit the Tech Number, the Supervisor Tech Number, the Type the user will be logged in as, and whether the user is Active in the appropriate display fields 4810. The user may select the Add Alternate User Type button 4820 to grant access to an additional role. In order to delete an Alternate User Type, select the Delete button 4830 for the specific type. To save the updated changes, the user must select the Save User Info button 4840. The Return To User List button 4850 will return to the User Administration screen (See FIG. 45).

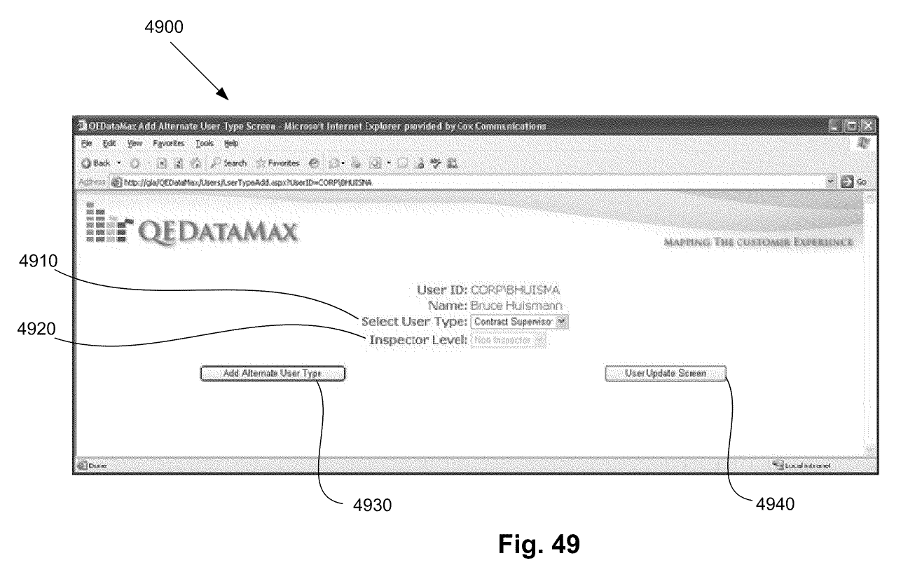

FIG. 49 shows the Add Alternate User Type screen 4900 according to one embodiment in which users can add new user roles to grant access for the role. Select the appropriate User Type 4910 and Inspector Level 4920, and then select the Add Alternate User Type button 4930. The Inspector Level 4920 is only enabled for selection for the Inspector and Inspector Lead user types. To return to the user edit screen (see FIG. 48) without saving, select the User Update Screen button 4940.

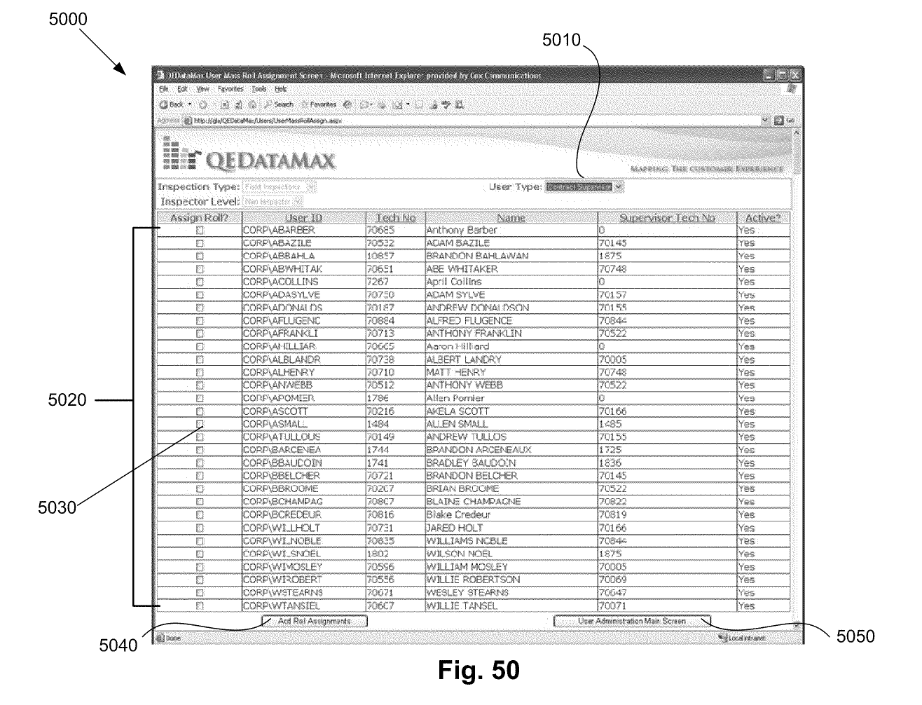

FIG. 50 shows the User Mass Roll Assignment screen 5000 according to one embodiment used to grant role access to a large group of users that are already in the system. This function is mainly used to grant access when a new inspection type has been created. The user will select a User Type 5010 to display a list of users 5020 who are not currently set up for the Inspection Type and User Type. The user will select the checkboxes under the Assign Roll? column 5030 for the persons needing the access level, and then select the Add Roll Assignments button 5040. To return to the user view screen (see FIG. 45) without saving, select the User Administration Main Screen button 5050.

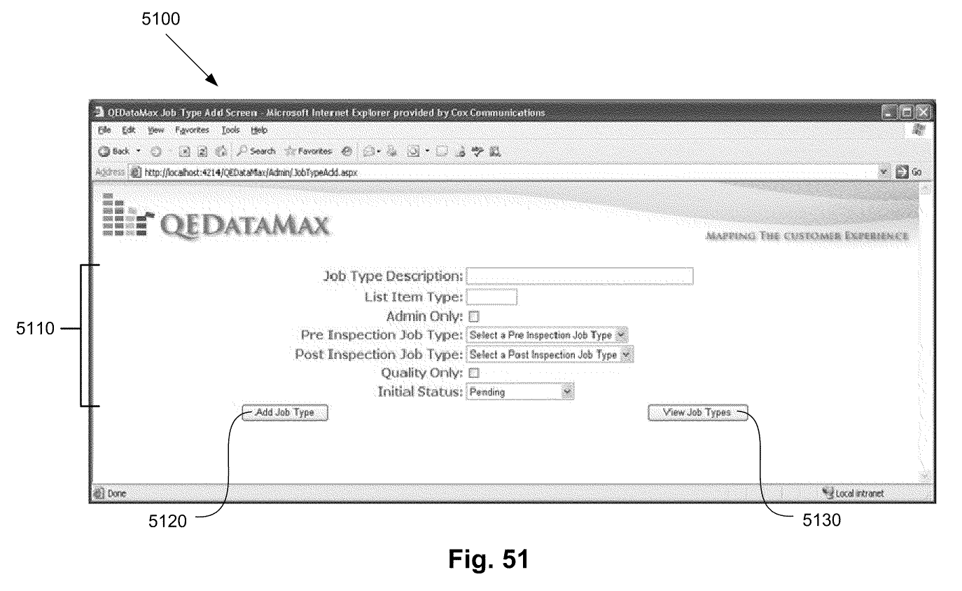

FIGS. 51-53 show the job type administration screens used by real-time quality data system to allow administrators to manage their own job types. Job Types are the different type of inspections that can be performed. These screens are accessed from the main screen menu (See FIG. 2) under the Administration option.

Table 9 shows the job type fields along with a description each job type.

TABLE 9

| Field | Description |
|---|---|
| ID | The job type id |
| Job Type | The job type description |
| List Item # | The job type list item #. List items are linked |
| | through this field. This allows users to create |
| | one set of list items that can link to multiple job |
| | types. |
| Admin Only | The job type is only accessible to administrators |
| Pre Inspection Job | The job type's pre inspection job type. |
| Type | |
| Post Inspection Job | The job type's post inspection job type. |
| Type | |
| Quality Only | The job type is only accessible to the Quality |
| | users. (Administrator, Inspector, Inspector Lead) |
| Active | Whether the job type is an active type for |
| | inspection or not |

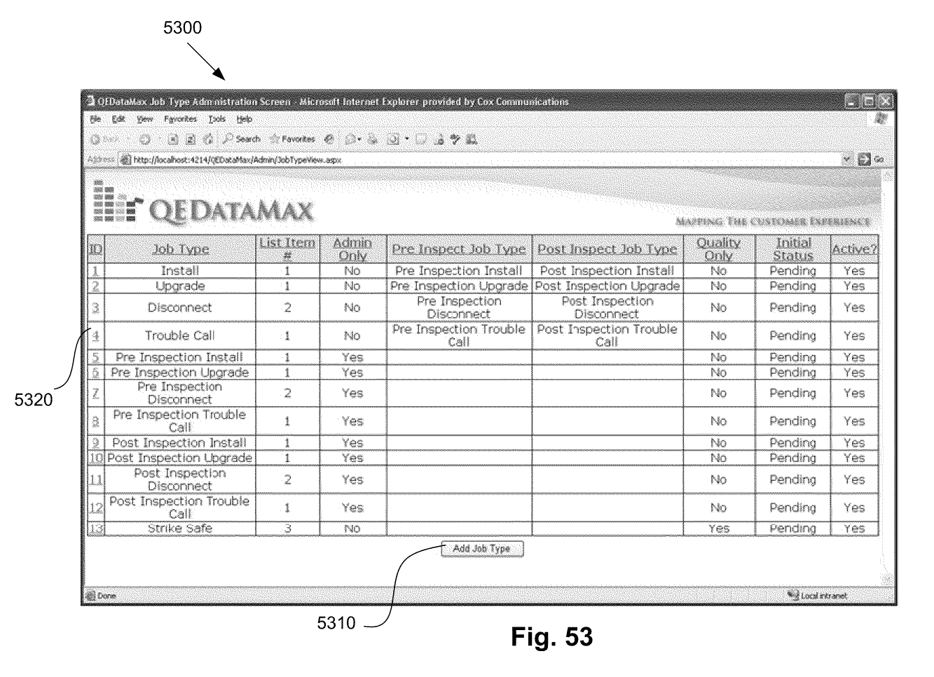

FIG. 51 shows the Job Type Add screen 5100 according to one embodiment. The user will enter the appropriate data 5110, and then select the Add Job Type button 5120. To return to the job type view screen (see FIG. 53) without saving the data, select the View Job Types button 5130.

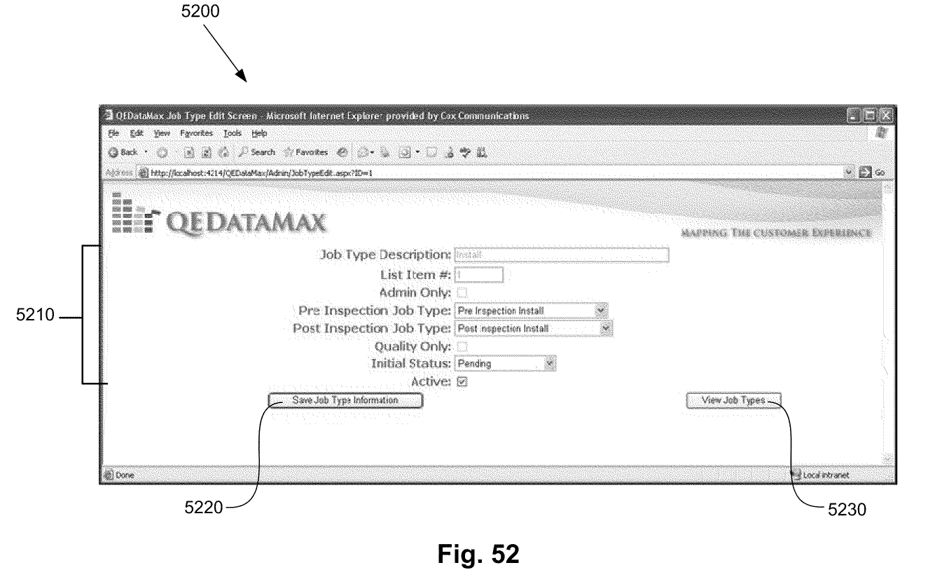

FIG. 52 shows the Job Type Edit screen 5200 according to one embodiment. The user will enter the appropriate data 5210, and then select the Save Job Type Information button 5220. If the job type has been used in an inspection, the Job Type Description, List Item #, Admin Only, and Quality Only fields 5210 are disabled. To return to the job type view screen without saving the data, select the View Job Types button 5230.

FIG. 53 shows the Job Type Administration screen 5300 according to one embodiment. The user may either select the Add Job Type button 5310 to add a job type, or select an ID number under the ID column 5320 to edit the job type.

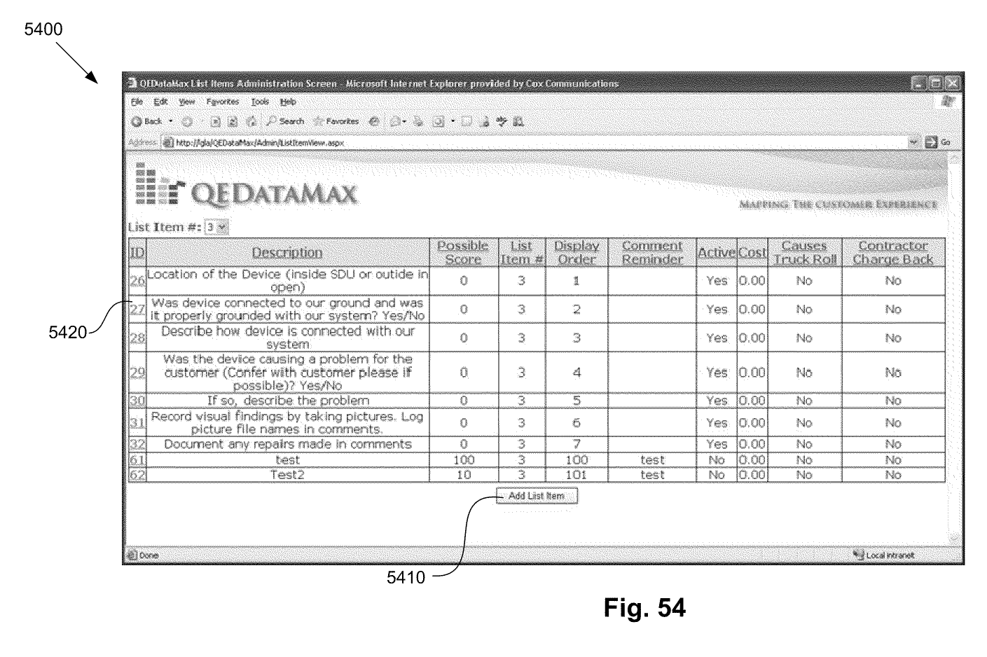

FIGS. 54-60 show the various list item administration screens used by real-time quality data system to allow administrators to manage their own list items. List Items are the different items that appear in a job type list. List items also have reasons that provide specific pass/fail reason reporting for a list item. These screens are accessed from the main screen menu (see FIG. 2) under the Administration option.

FIG. 54 shows the List Item Administration screen 5400 according to one embodiment. The user may either select the Add List Item button 5410 to add a list item, or select an ID number under the ID column 5420 to edit the list item.

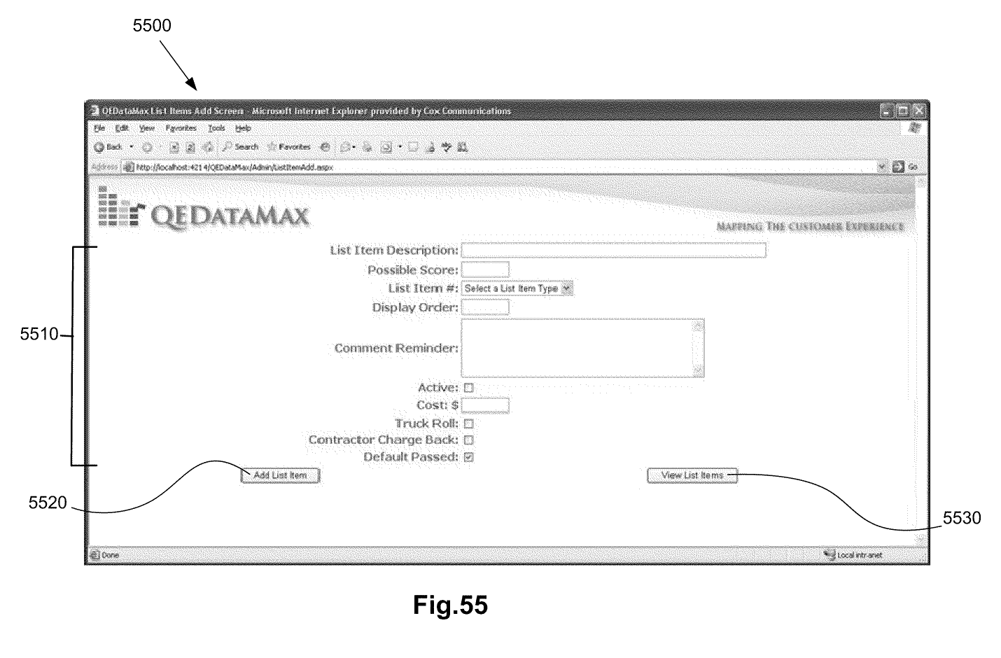

FIG. 55 shows the List Items Add screen 5500 according to one embodiment. The user will enter the appropriate data 5510, and then select the Add List Item button 5520. To return to the list item view screen (See FIG. 54) without saving the data, select the View List Items button 5530.

Table 10 shows the list item fields along with a description of each that must be entered when adding a list item.

TABLE 10

| Field | Description |
|---|---|
| ID | The list item id |
| List Item Description | The list item description viewed by the user |
| Possible Score | The score possible for passing the list item |
| List Item # | The job type list item #. List items are linked through this field. This |
| | allows users to create one set of list items that can link to multiple job |
| | types. |
| Display Order | The order the list item shows up in the list on the screen |
| Comment Reminder | The reminder that displays in the comments for that list item |
| Active | Whether the list item is active or not |
| Cost | The cost of the list item. Used in calculating savings and costs |
| Truck Roll | Whether the list item would does or would have caused a truck roll |
| Contractor Charge | Whether a contractor will be charged back for the list item. |
| Back | |
| Default Passed | Whether the list item defaults to passed on the add screen or not |

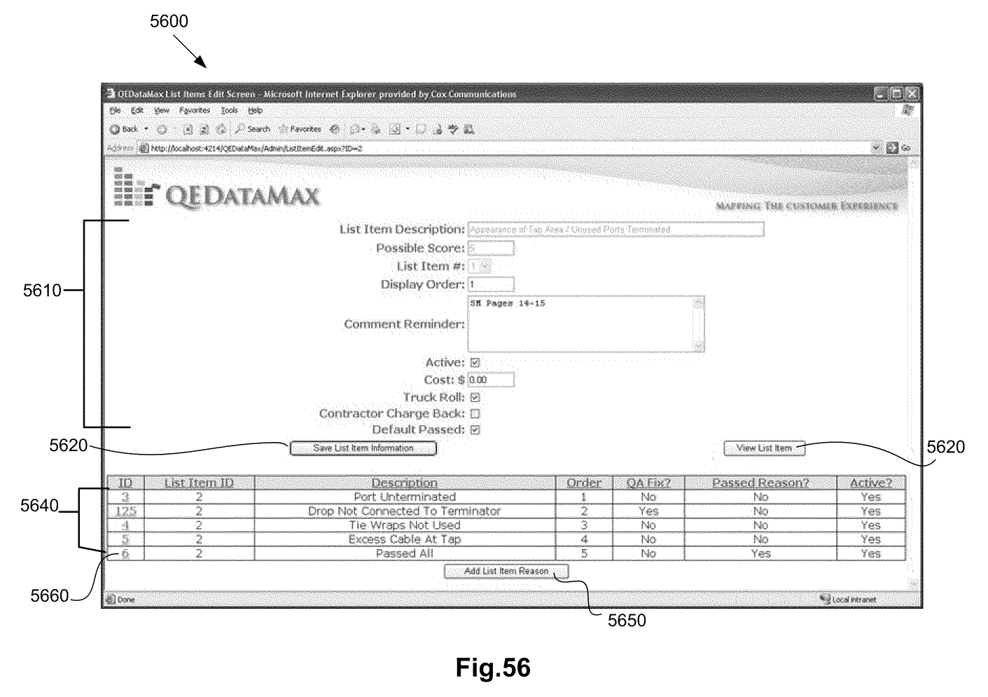

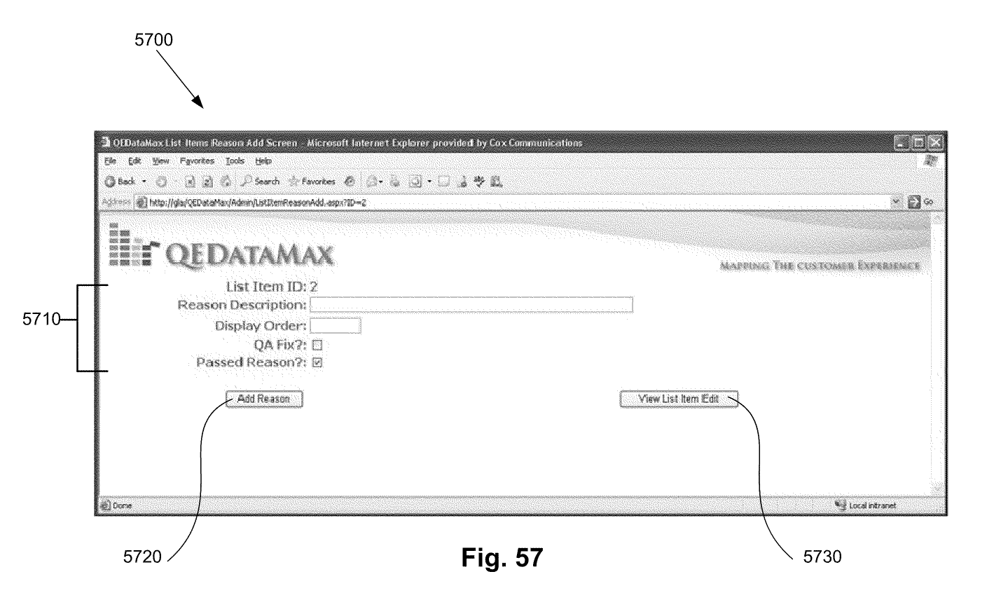

FIG. 56 shows the List Item Edit screen 5600 according to one embodiment which allows the user to edit a particular list item from the list displayed on the List Item Administration screen (see FIG. 54). The user should enter the appropriate data 5610, and then select the Save List Item Information button 5620. The user may then select the View List Item button 5630 in order to return to the list item view screen without saving the data. In order to add a list item reason to the displayed list 5540, the user may select the Add List Item Reason button 5650. To edit a list item reason displayed on the screen 5540, select the ID 5660 of a specific list item reason to be edited under the ID column.

FIG. 57 shows the List Item Reason Add screen 5700 according to one embodiment. The user will enter the appropriate data 5710, the select the Add Reason button 5720. The user may select the View List Item Edit button 5730 in order to return to the list item without saving the data.

Table 11 shows a description of the fields the user must enter when adding a list item reason.

TABLE 11

| Field | Description |
|---|---|
| ID | The list item reason id |
| List Item ID | The list item id |
| Reason Description | The reason description visible to the user |
| Display Order | The order the list item reason shows up in the drop |
| | down list. All passed reasons display first then non |
| | passing reasons |
| QA Fix | Whether QA department would fix this issue or not. |
| Passed Reason | Whether the reason is a passing reason or not |

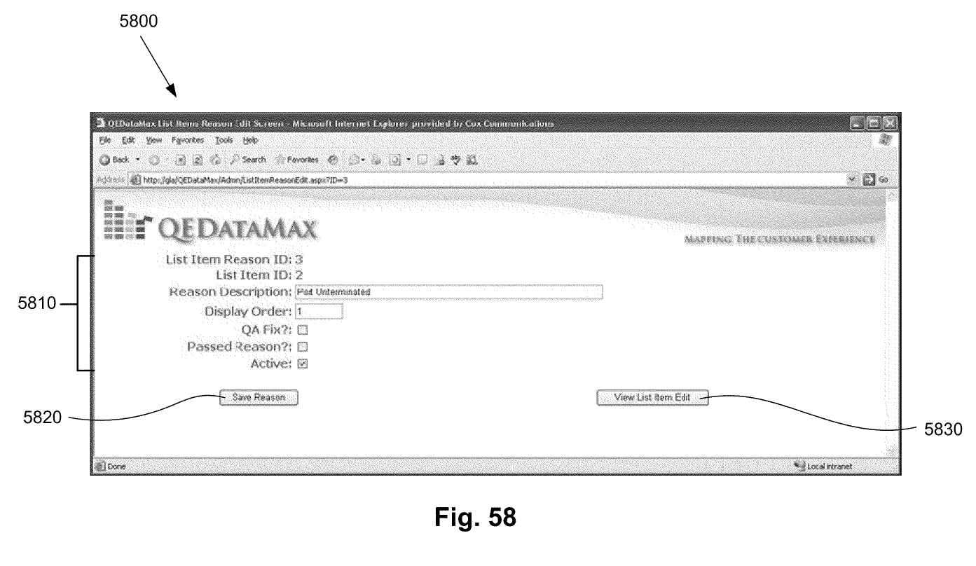

FIG. 58 shows the List Item Reason Edit screen 5800 according to one embodiment. The user will enter the appropriate data 5810, and then select the Save Reason button 5820. The user may select the View List Item Edit button 5830 in order to return to the list item without saving the data.

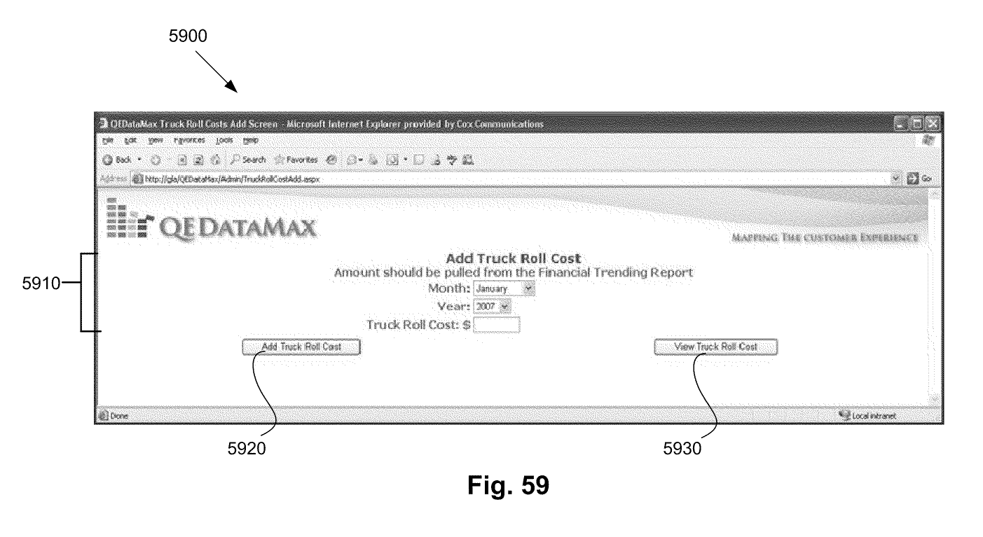

FIGS. 59-61 show the truck roll cost administration screens used by real-time quality data system to allow administrators to determine how much money is spent or saved. These screens are accessed from the main screen menu (see FIG. 2) under the Administration option.

Table 12 shows the fields along with a description needed when adding a truck roll cost.

TABLE 12

| Field | Description |
|---|---|
| Month-Year | The month and year of the truck roll cost |
| Truck Roll | The actual truck roll cost. The amount should be |
| Cost | pulled from the Financial Trending Report. |
| | Consult your local Finance department for this information. |
| Last Updated | The last person to update the truck roll cost. |
| By | |

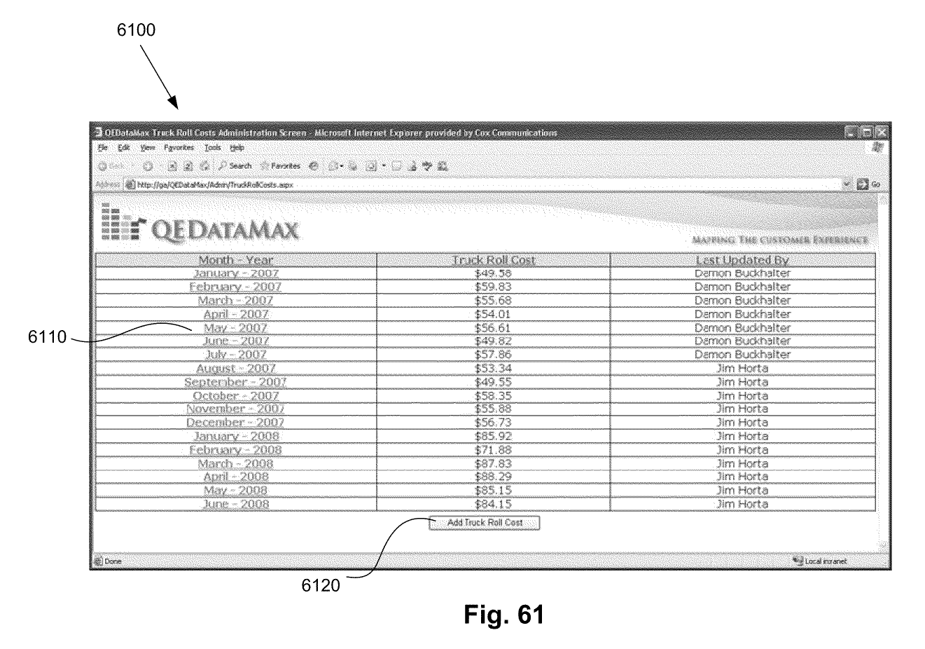

FIG. 59 shows the Truck Roll Costs Add screen 5900 according to one embodiment. The user will enter the appropriate data 5910, and then select the Add Truck Roll Cost button 5920. To return to the truck roll view screen (See FIG. 61) without saving the data, select the View Truck Roll Cost button 5930.

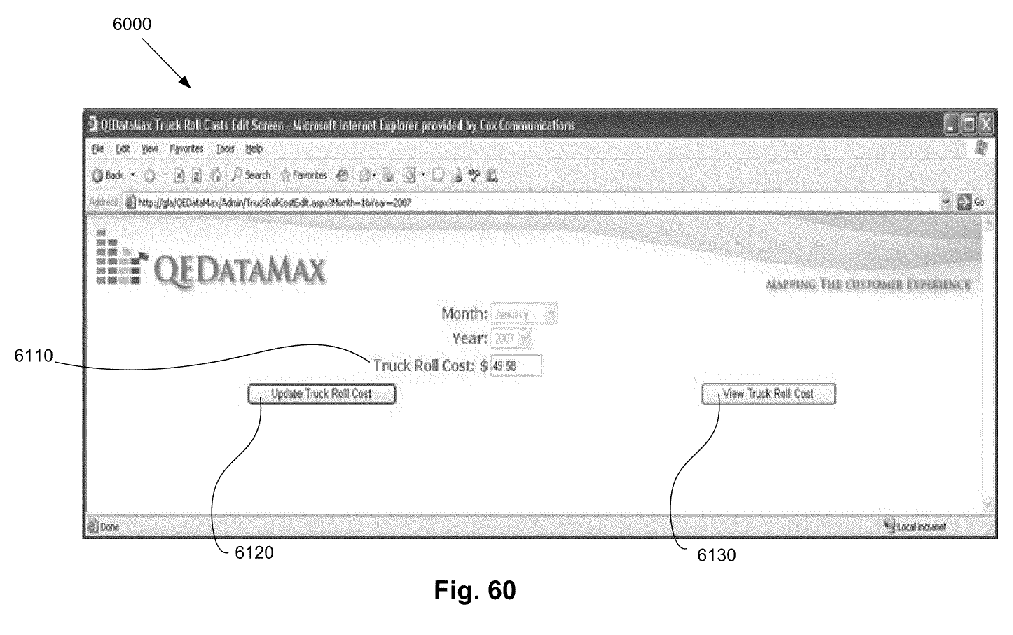

FIG. 60 shows the Truck Roll Cost Edit screen 6000 according to one embodiment. The user will enter an updated Truck Roll Cost 6010, and then select the Save Truck Roll Cost button 6020. To return to the truck roll view screen (See FIG. 61) without saving the data, select the View Truck Roll Cost button 6030.

FIG. 61 shows the Truck Roll Cost Administration screen 6100 according to one embodiment. The user may either select the Add Truck Roll Cost button 6110 to add a new truck roll cost, or select a specific Month-Year 6120 to edit the truck roll cost.

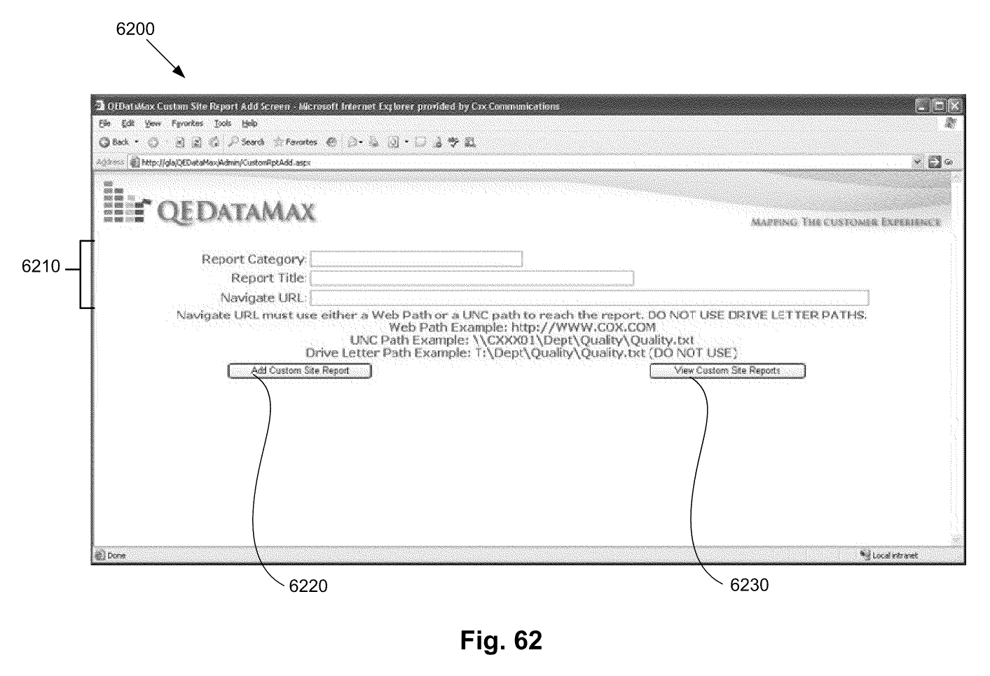

FIGS. 62-65 shows the various screens Administrators use to post custom reports created at the local sites. The report can be a spreadsheet, reporting services report link, web site, etc. These screens are accessed from the real-time quality data system main screen menu under the Administration option (see FIG. 2).

Table 13 shows the fields along with a description of Custom Site reports.

TABLE 13

| Field | Description |
|---|---|
| ID | The Custom Site Report ID |
| Category | The category the report will be listed under |
| Name | |
| Report Title | The title of the report that will be displayed on the screen |
| Navigate | The path to the report. This can be a website path |
| URL | (HTTP://www.company.com) |
| | or UNC path (\\CXXX01\Dept\Quality.txt) |
| | NOT A DRIVE LETTER PATH |
| | T:\Quality.txt |
| Active | Whether the report is active or not |

FIG. 62 shows the Custom Site Report Add screen 6200 according to one embodiment. The user will enter the appropriate data 6210, and then select the Add Custom Site Report button 6220. To return to the Custom Site Reports view screen without saving the data, select the View Custom Site Reports button 6230.

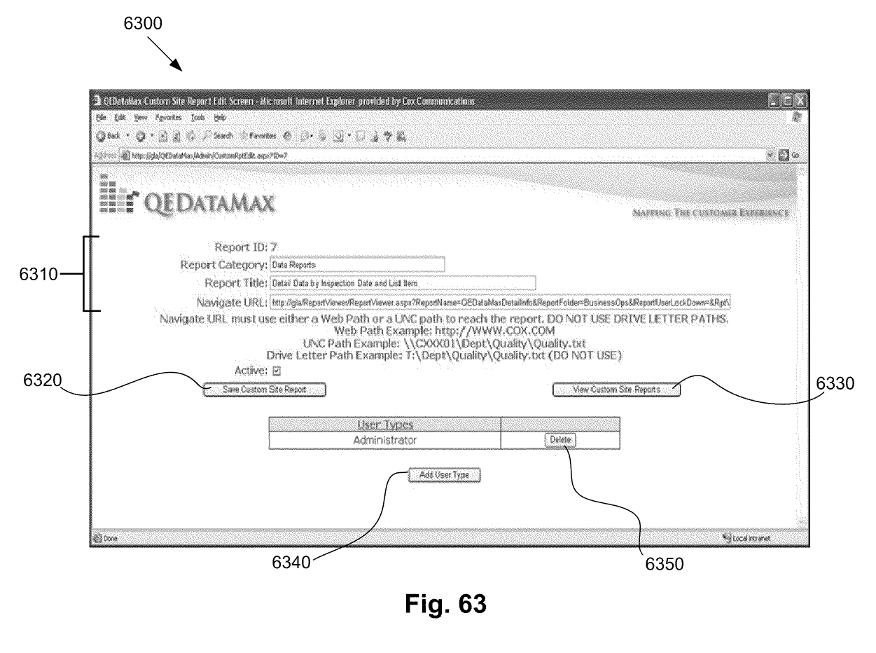

FIG. 63 shows the Custom Site Report Edit screen 6300 according to one embodiment. The user will enter the appropriate data 6310, and then select the Save Custom Site Report button 6320. To return to the Custom Site Reports view screen without saving the data, select the View Custom Site Reports button 6330. The user may need to grant various User Types accessibility to the report by selecting the Add User Type button 6340. In order to remove a User Type, select the Delete button 6350 of the specific user type to be removed.

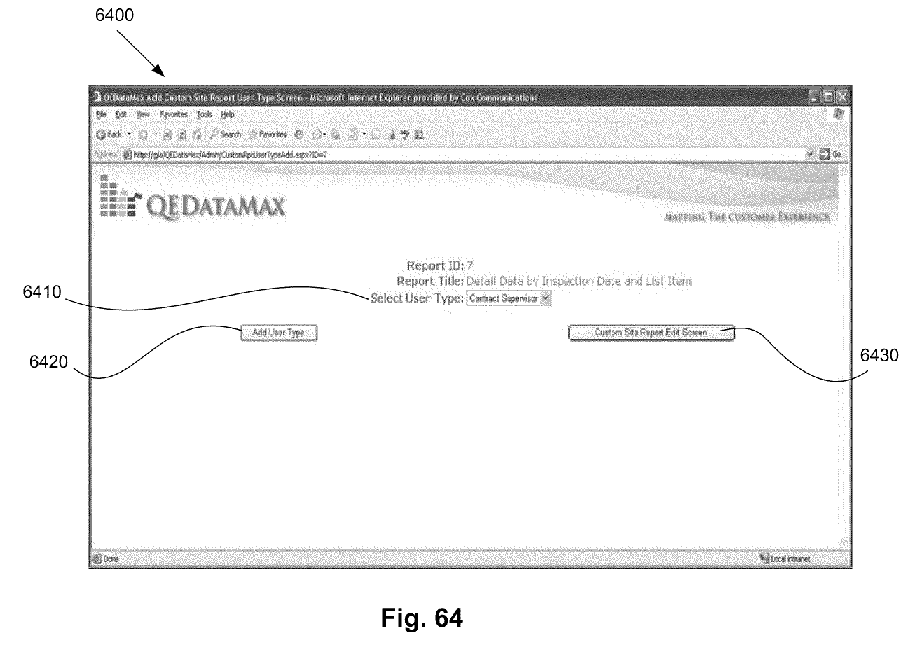

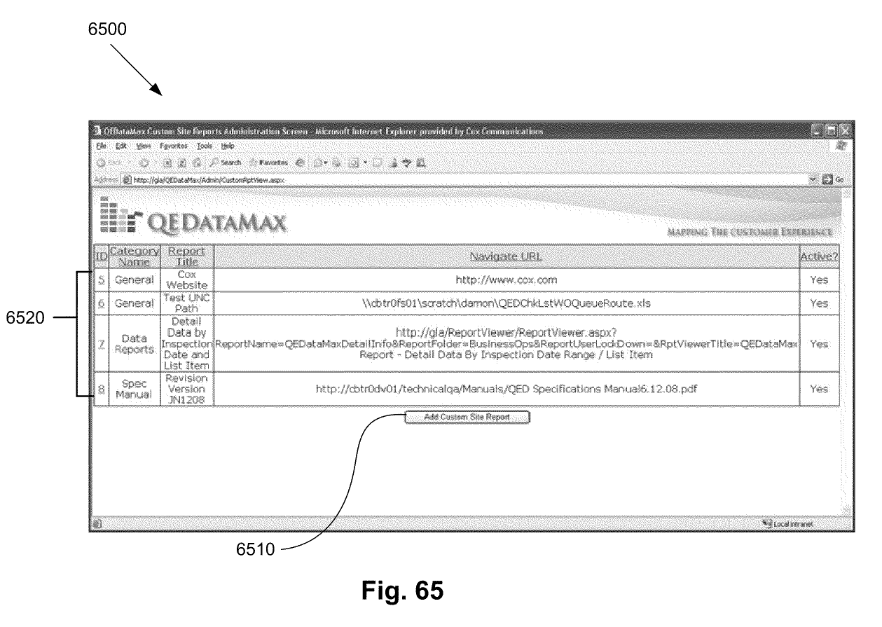

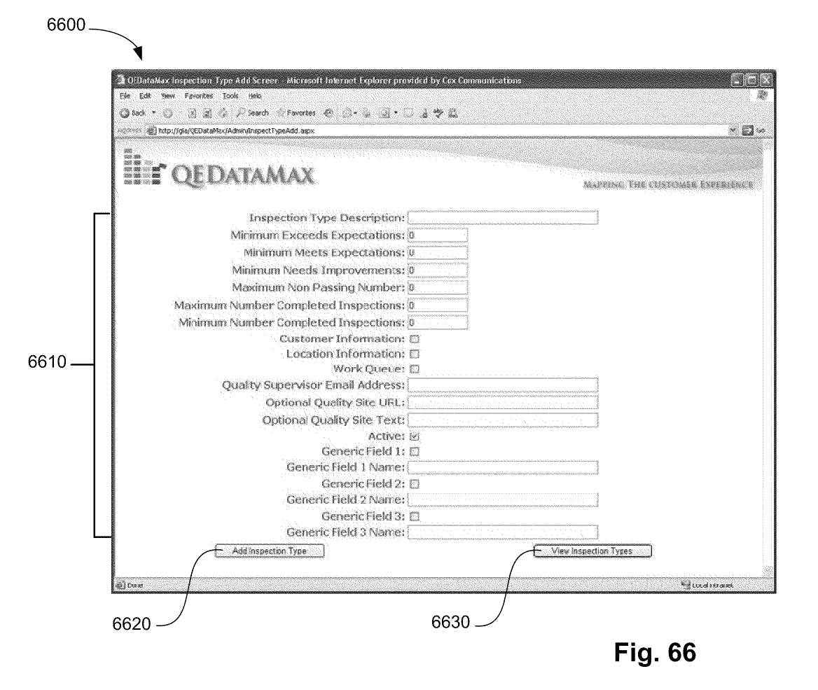

FIG. 64 shows the Add Custom Site Report User Type screen according to one embodiment which grants various User Types accessibility to the report. The user will select a User Type 6410, and then select the Add User Type button 6420. To return to the Custom Site Reports Edit screen without saving, select the Custom Site Reports Edit Screen button 6430.

FIG. 65 shows the Custom Site Reports Administration screen 6500 according to one embodiment. The user may either select the Add Custom Site Report button 6510 to add a job type, or select an ID number under the ID column 6520 to edit the report.

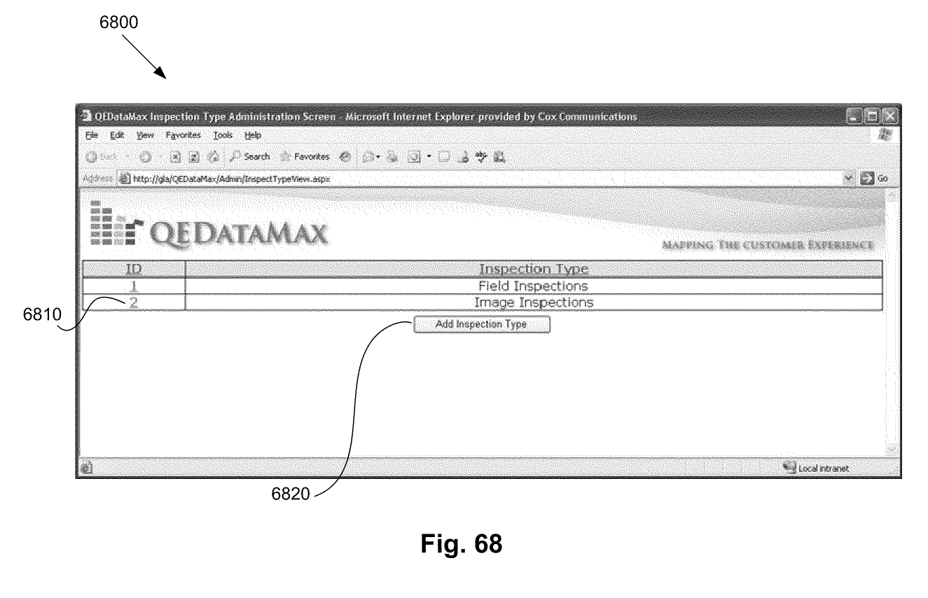

FIG. 66 shows the Inspection Type Add screen 6600 according to one embodiment. Real-time quality data system allows the creation of other Inspection Types as needed that only a Site Administrator can add. The user will enter the appropriate data 6610, and then select the Add Inspection Type button 6620. To return to the inspection type view screen (see FIG. 68) without saving the data, select the View Inspection Types button 6630.

Table 14 shows the various fields along with its description in the Inspection Type that are specific to that inspection type.

TABLE 14

| Field | Description |
|---|---|
| ID | The Inspection Type ID |
| Description | The Inspection Type Description viewed on the screen |
| Minimum Exceeds Expectations | The minimum number necessary to qualify as Exceed |
| | Expectations |
| Minimum Meets Expectations | The minimum number necessary to qualify as Meet |
| | Expectations |
| Minimum Needs Improvements | The minimum number necessary to qualify as Need |
| | Improvements |
| Maximum Non Passing Number | The maximum non passing score on an inspection |
| Maximum Number of | The maximum number of completed inspections allowed per |
| Completed Inspections | month. Once reached inspections automatically go to Filed |
| | Inspection status. This field is used in the Work Queue section. |
| Minimum Number of | The minimum number of completed inspections needed per |
| Completed Inspections | month. This field is used in the Work Queue section. |
| Customer Information | Whether or not the customer information will appear on the |
| | inspection. |
| Location Information | Whether or not the location information will appear on the |
| | inspection. |
| Work Queue | Whether or not the work queue is accessible and usable. |
| Quality Supervisor Email | The email address of the quality supervisor. Disputes and |
| Address | rejections are automatically sent to this address when |
| | submitted. |
| Optional Quality Site URL | The URL to another website that will be displayed on the main |
| | page next to the real-time quality data system Flashes logo. |
| Optional Quality Site Text | The text displayed for the optional website. |
| Active | Whether the Inspection Type is active or not |
| Generic Field 1 | Whether Generic Field 1 is used. This field appears on the |
| | inspection form before the list items. |
| Generic Field 1 Name | The text that displays describing Generic Field 1 |
| Generic Field 2 | Whether Generic Field 2 is used. This field appears on the |
| | inspection form before the list items. |
| Generic Field 2 Name | The text that displays describing Generic Field 2 |
| Generic Field 3 | Whether Generic Field 2 is used. This field appears on the |
| | inspection form before the list items. |
| Generic Field 3 Name | The text that displays describing Generic Field 3 |

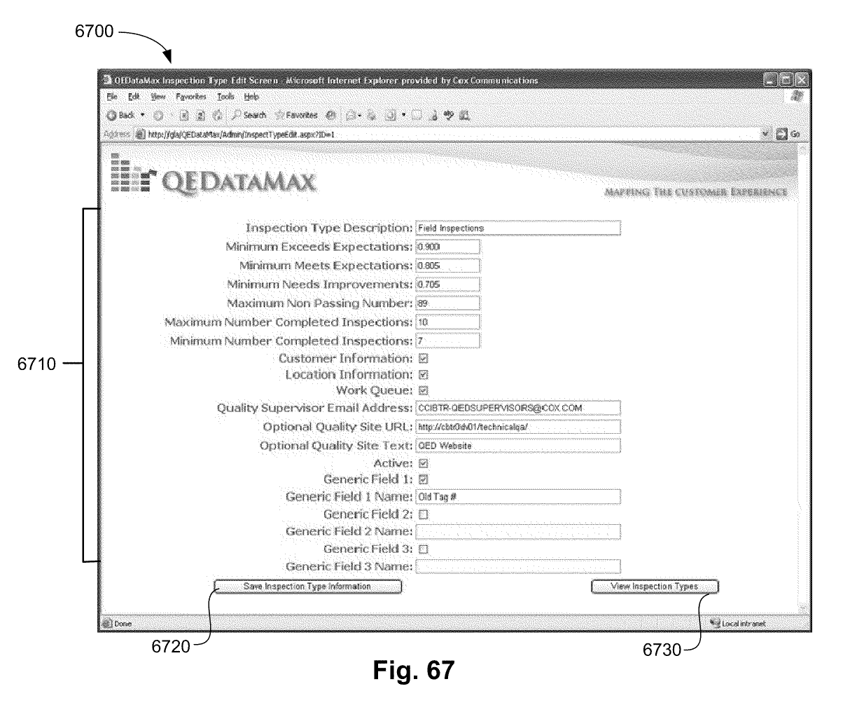

FIG. 67 shows the Inspection Type Edit screen 6700 according to one embodiment. The user will enter the appropriate data 6710, and then select the Save Inspection Type Information button 6720. To return to the inspection type view screen (see FIG. 68) without saving the data, select the View Job Types button 6720.

FIG. 68 shows the Inspection Type Administration screen 6800 according to one embodiment. The user may either select the Add Inspection Type button 6810 to add an inspection type, or select an ID number under the ID column 6820 to edit the inspection type.

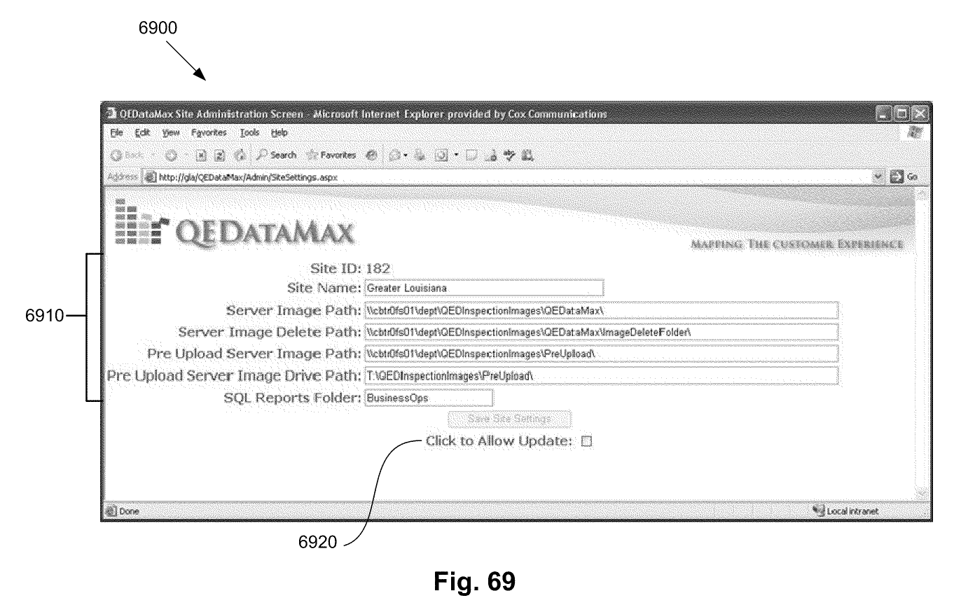

FIG. 69 shows the site administration screen 6900 according to one embodiment that is only accessible by the Site Administration. This screen holds information global to all inspection types. The initial site number 6910 must be entered by an Information Technology person with access to the database. Users must check the Click to Allow Update box 6920 before the data fields 6910 can be saved.

Table 15 shows the site administration fields along with a description of each.

TABLE 15

| Field | Description |
|---|---|
| Site ID | The ICOMS Site ID |
| Site Name | The Site Name |
| Server Image Path | The path real-time quality data system images are stored. Give everyone |
| | Read & Execute permissions on the folder. Give the impersonate user id in |
| | the web.config file Modify access to this folder. |
| Server Image Delete | When deleting, images are moved to this folder before deleting. Give full |
| Path | access to all users to this folder to ensure the app can delete the image. |
| Pre Upload Server | User must move images to the folder with their login id under this folder |
| Image Path | so real-time quality data system will see what images are available to be |
| | attached to an inspection. Users who need access to this folder should be |
| | given Modify access to the top pre upload server image path. |
| Pre Upload Server | This path displays on the screen so users can more easily find the folder to |
| Image Drive Path | move images to so real-time quality data system can load them in the drop |
| | down for adding. |
| SQL Reports Folder | The SQL Reports folder the reports for real-time quality data system are |
| | stored. |

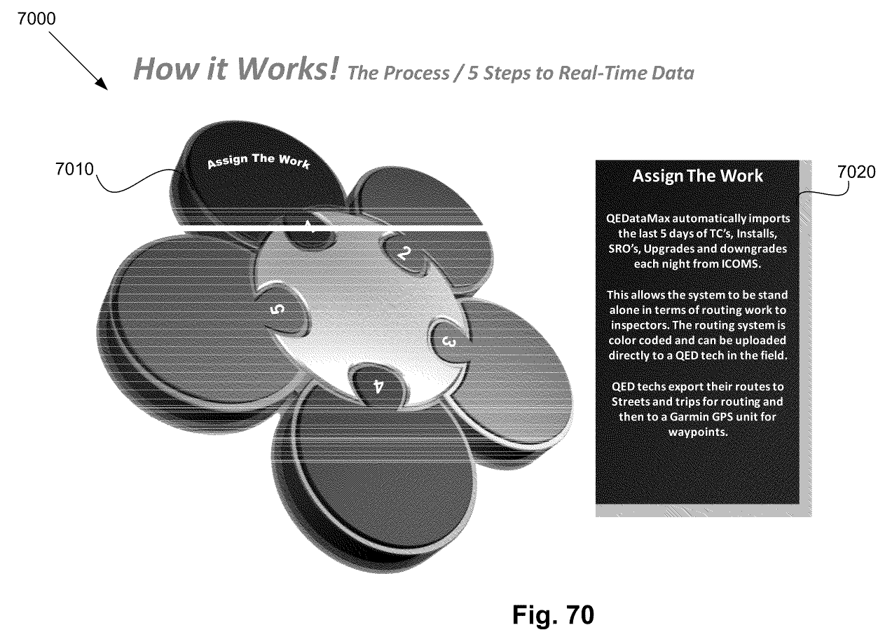

FIGS. 70-74 show how real-time quality data system works by outlining the five step process to real-time data. FIG. 70 shows the first step is to Assign the Work 7000 according to one embodiment along with a description.

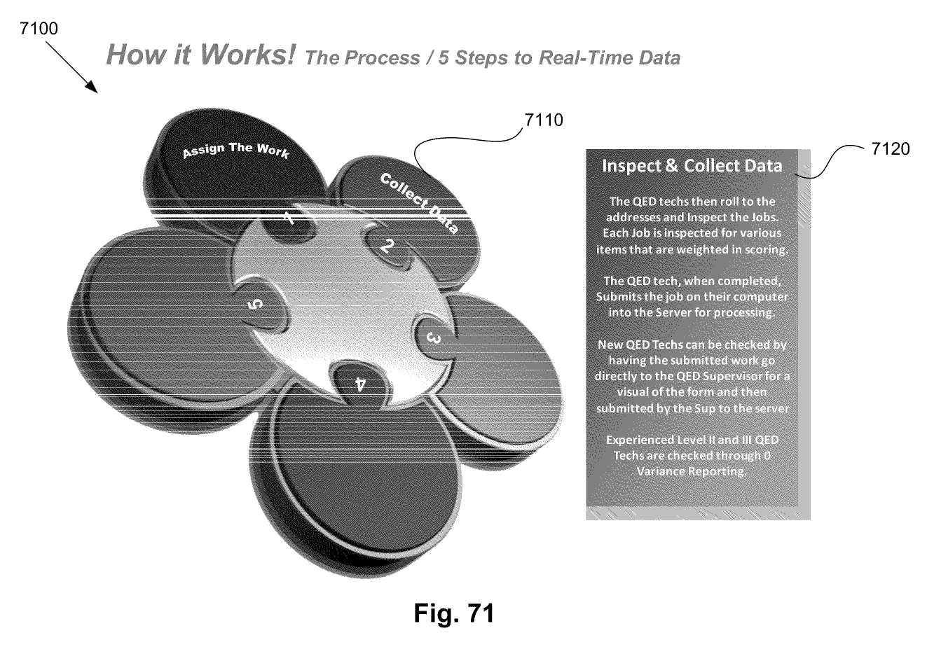

FIG. 71 shows the second step of real-time quality data system is to Inspect & Collect Data 7100 according to one embodiment. A description box 7110 of this step outlines the facts.

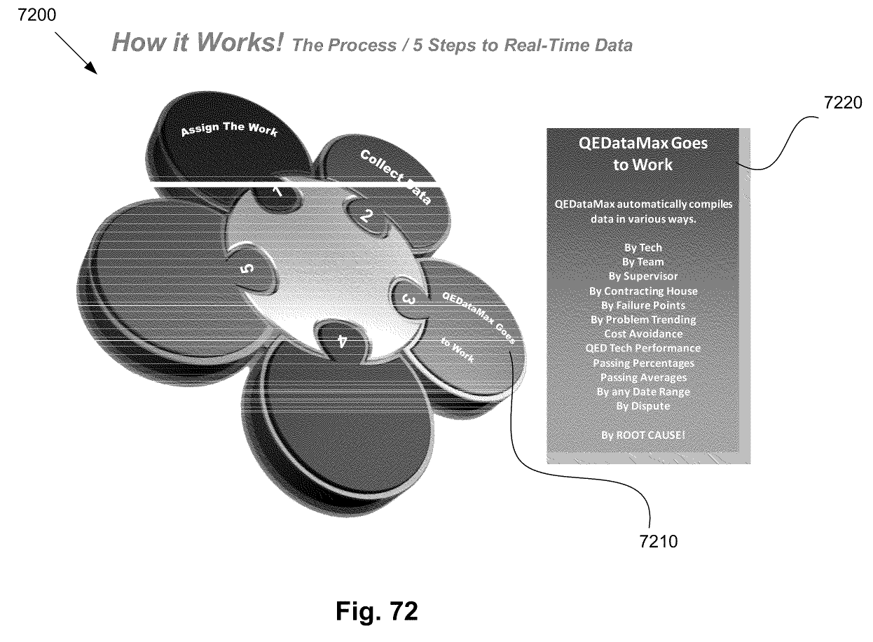

FIG. 72 shows the third step is real-time quality data system Goes to Work 7200 according to one embodiment. A description box 7210 of this step outlines the facts.

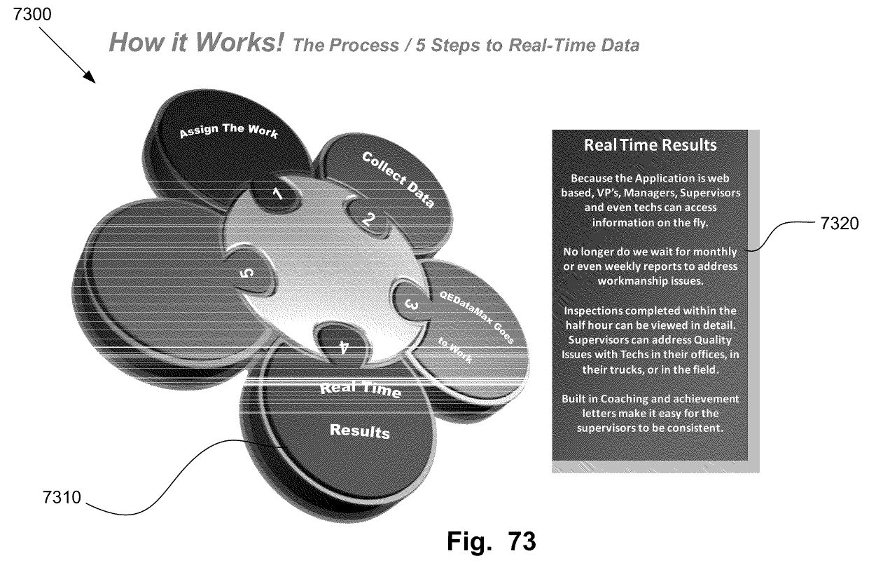

FIG. 73 shows the forth step of real-time quality data system is Real-time Results 7300 according to one embodiment. A description box 7310 of this step outlines the facts.

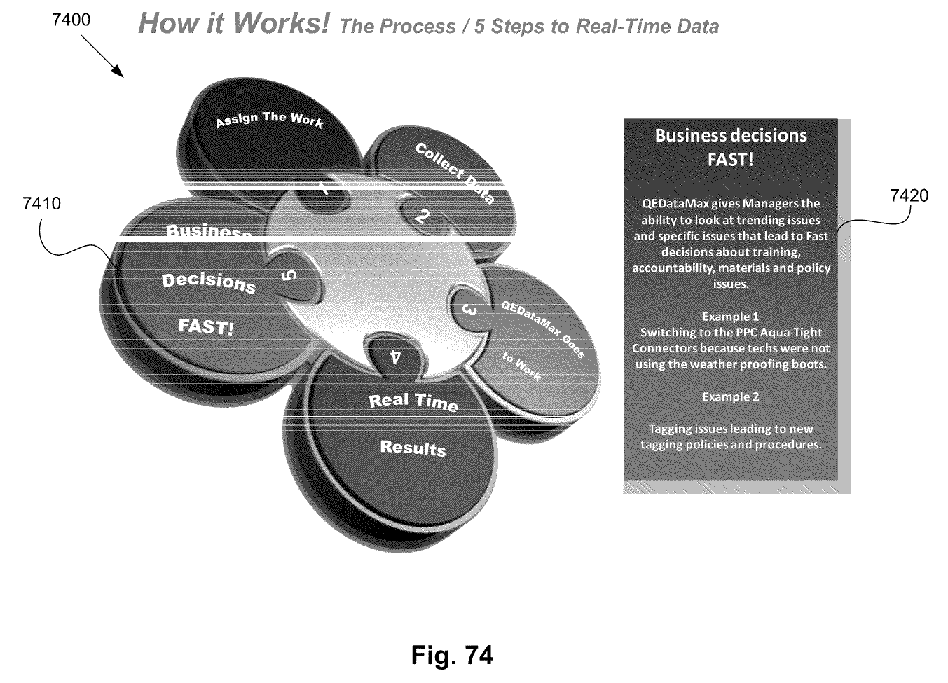

FIG. 74 shows the fifth step of real-time quality data system is being able to make Business Decisions Fast 7400 according to one embodiment. A description box 7410 of this step outlines the facts and gives examples.

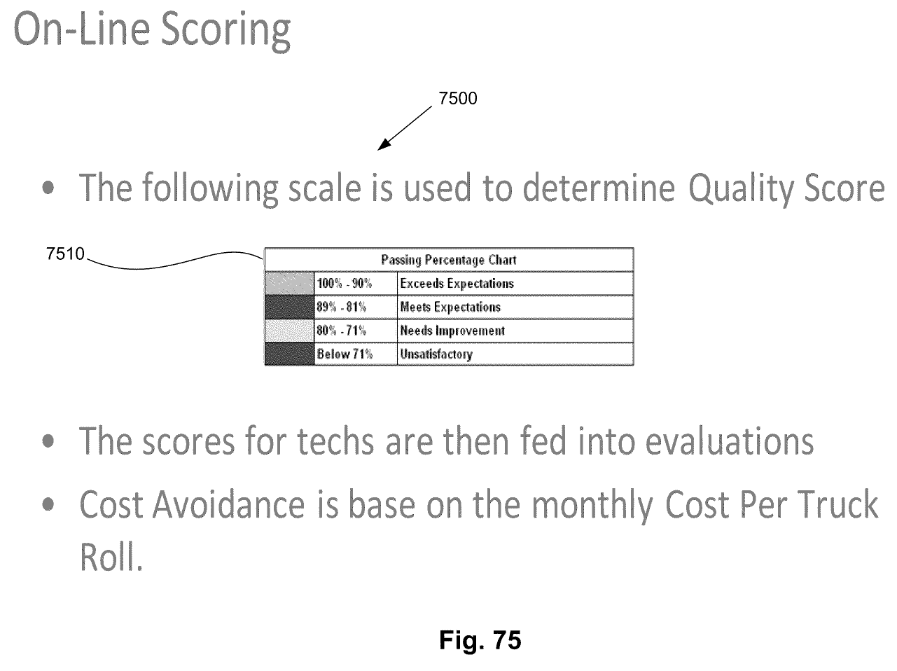

FIG. 75 shows the on-line scoring 7500 according to one embodiment and information about how scores are used. The grid 7510 shows the actual scale used to determine Quality score.

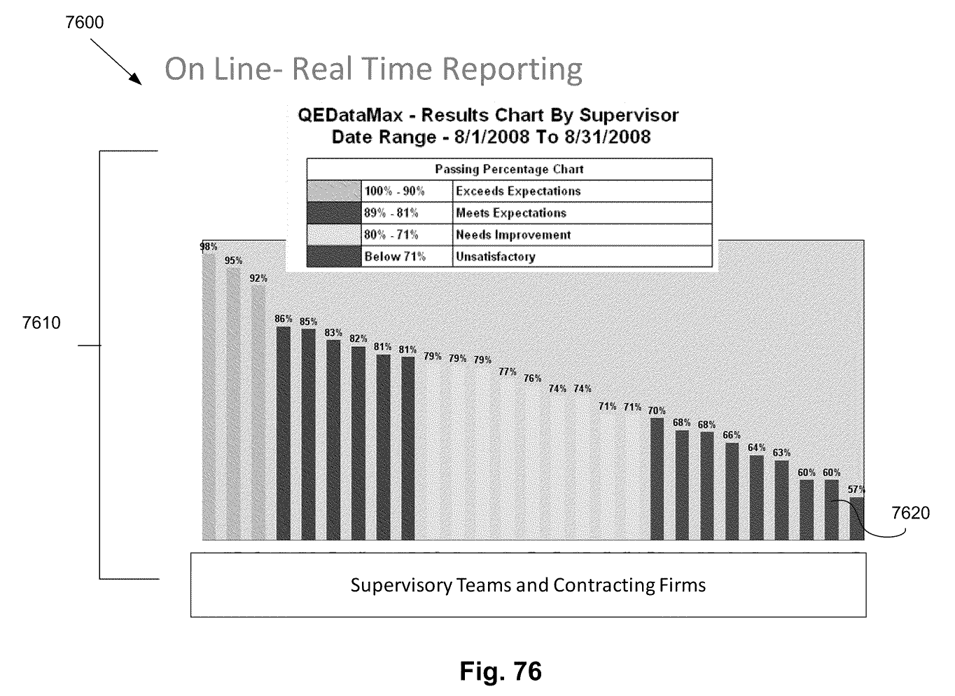

FIG. 76 shows an example of On Line-Real-time Reporting 7600 according to one embodiment by displaying a Results Chart By Supervisor/Date Range report 7610. The Results Chart By Supervisor/Date Range report 7610 displays a chart of passing percentages and a chart of average scores descending from left to right for the month of August. This gives a visual of where supervisors and contract companies stand against each other. By selecting a particular bar 7620, the user will be able to view the Results By Supervisor/Tech/Date Range report.

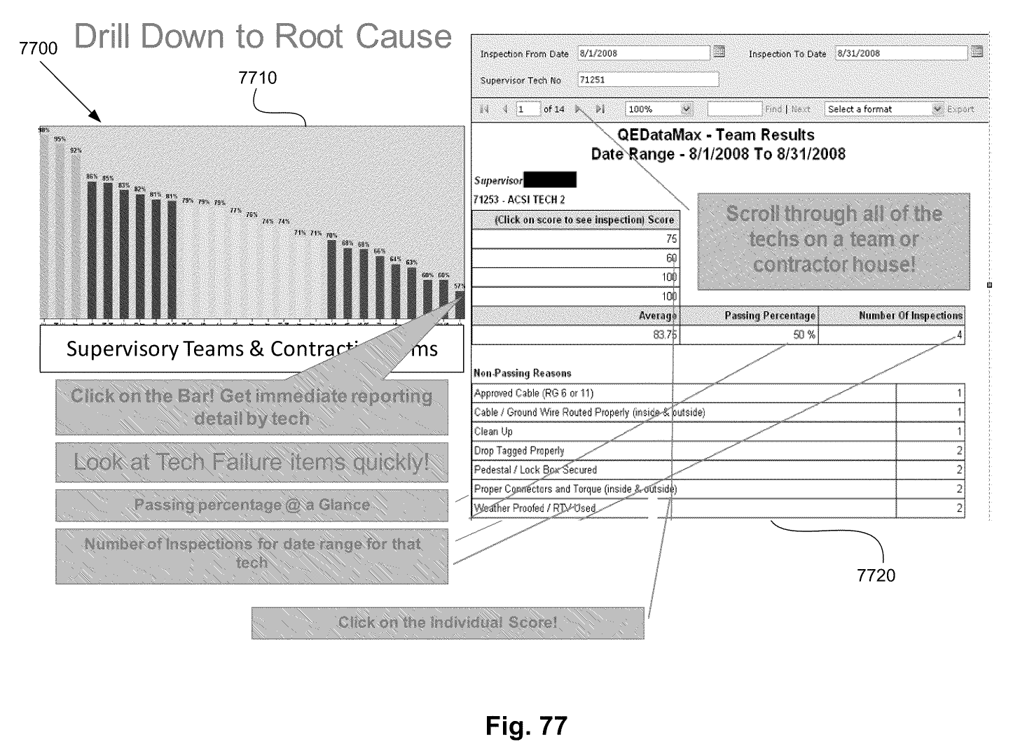

FIG. 77 shows an example of how to Drill Down to Root Cause 7700 according to one embodiment. The user selected a bar from the Results Chart By Supervisor/Date Report 7710 to view specific details by tech 7720.

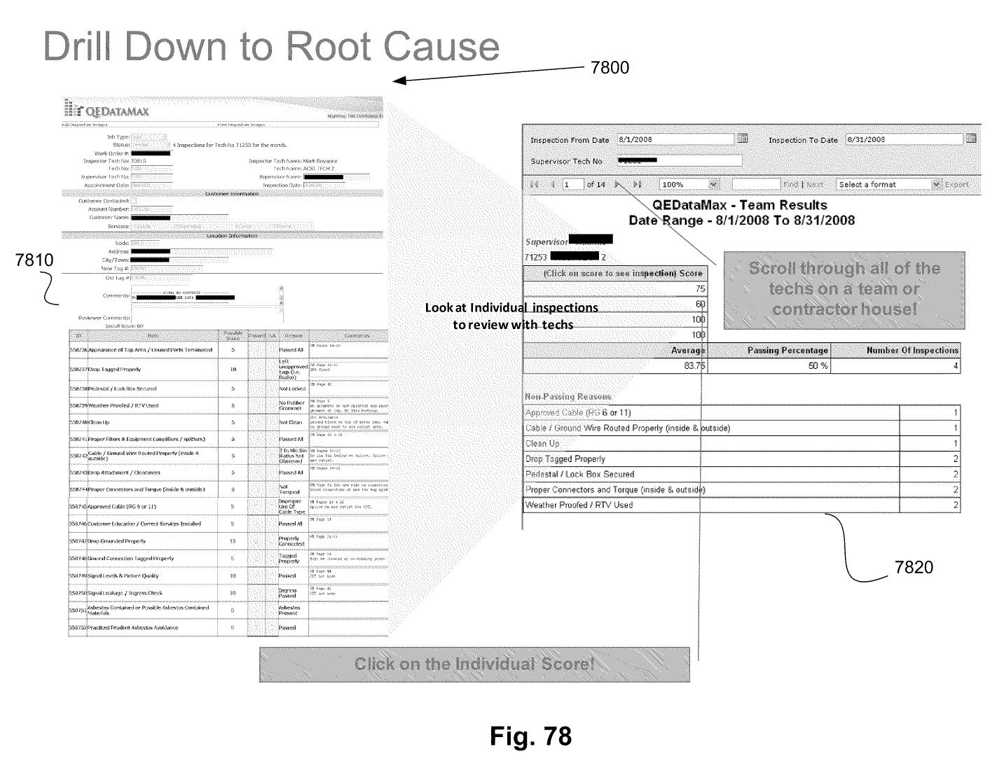

FIG. 78 shows another example of how to Drill Down to Root Cause 7800 according to one embodiment. Individual inspections 7810 that can be reviewed with techs can be displayed by selecting an individual score on the Non Passing Reasons report 7820.

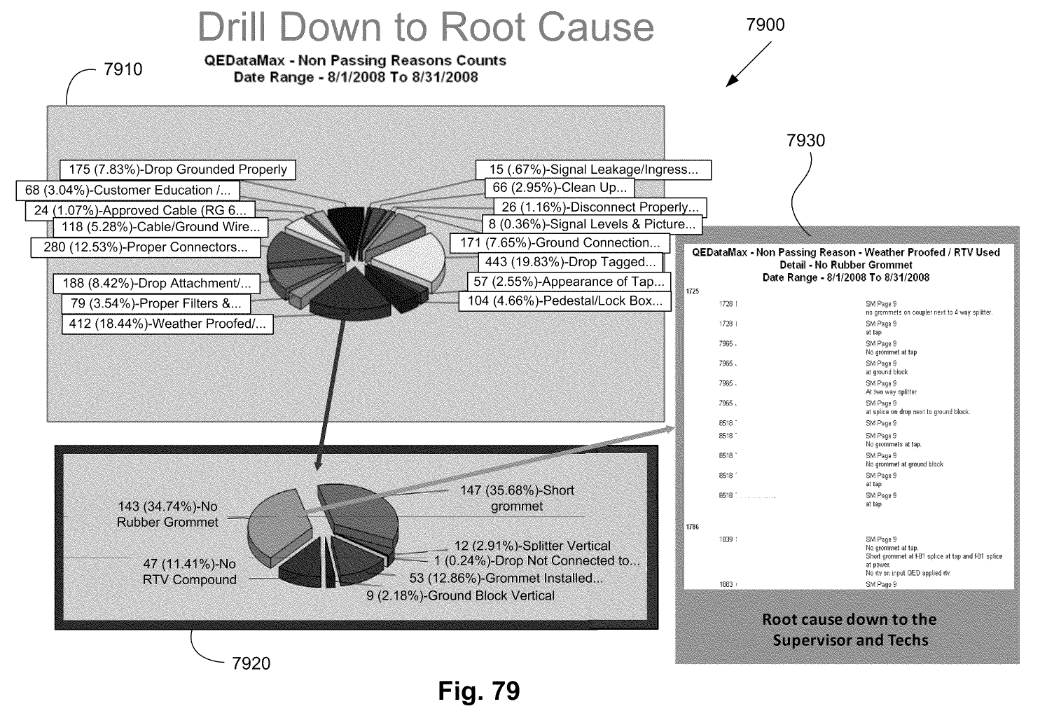

FIG. 79 shows an example of a Non Passing Reasons Chart by Date Range report 7900 according to one embodiment. This report displays a pie chart of items 7910 that were failed by all the team. Selecting a particular piece of the pie will take the user to the Non Passing Reasons Detail for that particular item which shows a pie chart of the reasons selected for that line item 7920. Selecting a particular piece of the pie for the Non Passing Reasons Detail will take the user to the actual line item detail report 7930.

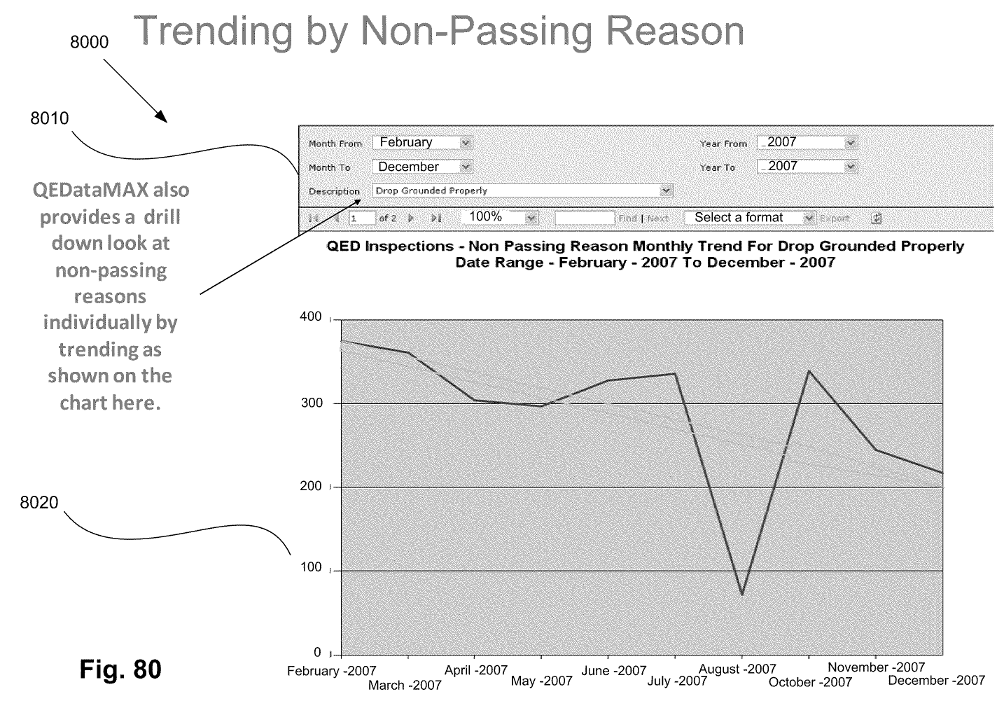

FIG. 80 shows a Non Passing Reasons Monthly Trending Chart By Date Range report 8000 according to one embodiment for the particular list item Drop Grounded Properly. The user selected February and December for the Month From and Month To, 2007 for the Year From and Year To, and Drop Grounded Properly for the List Item Description 8010. The resulting graph report 8020 shows whether the particular item selected is doing better or worse over the course of time.

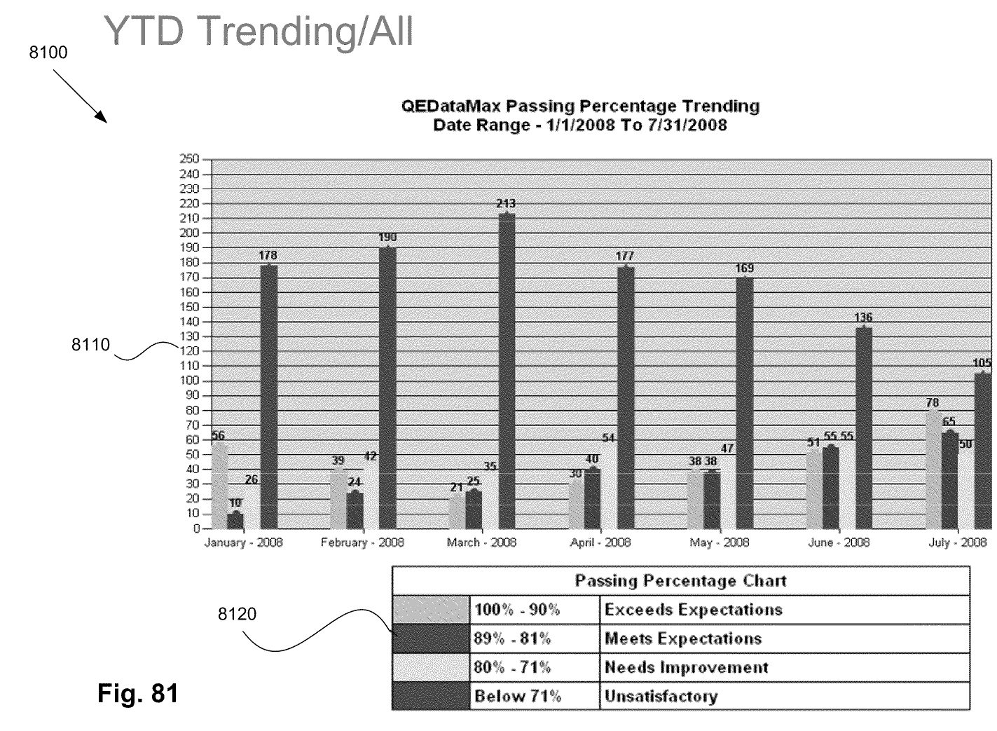

FIG. 81 shows YTD Trending with a Passing Percentage Trending graph 8100 according to one embodiment for the months January through July. This report displays a graph 8110 of how the techs scored monthly within given categories. The Passing Percentage Chart is displayed under the graph 8120.

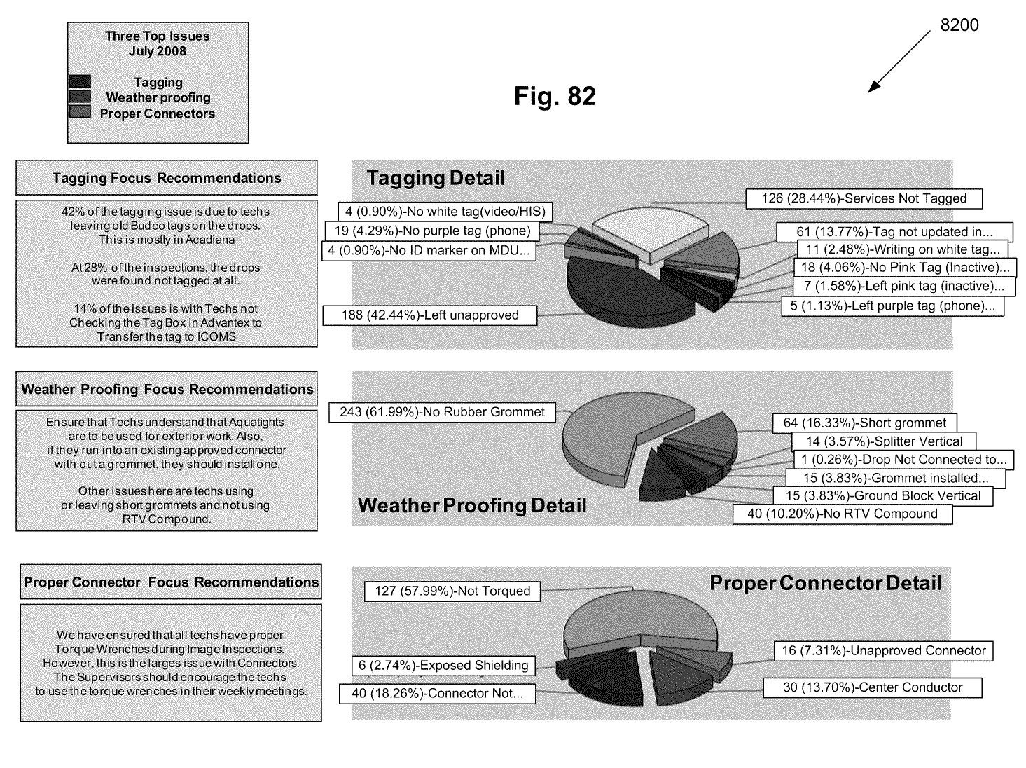

FIG. 82 shows Non Passing Reasons Detail 8200 for the three top issues in July 2008 according to one embodiment. Each report is a pie chart of the reasons selected for that line item.

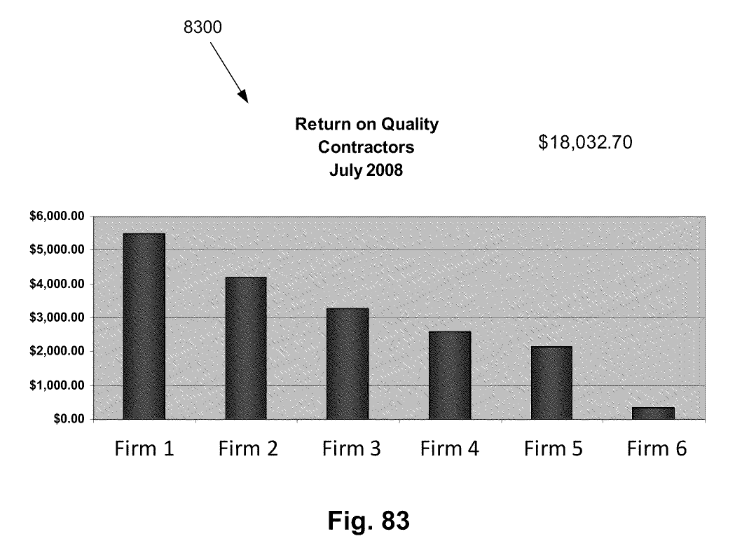

FIG. 83 shows a Return on Quality report 8300 according to one embodiment for the month of July 2008. This report displays truck roll cost generated by contractor's techs in a graph format.

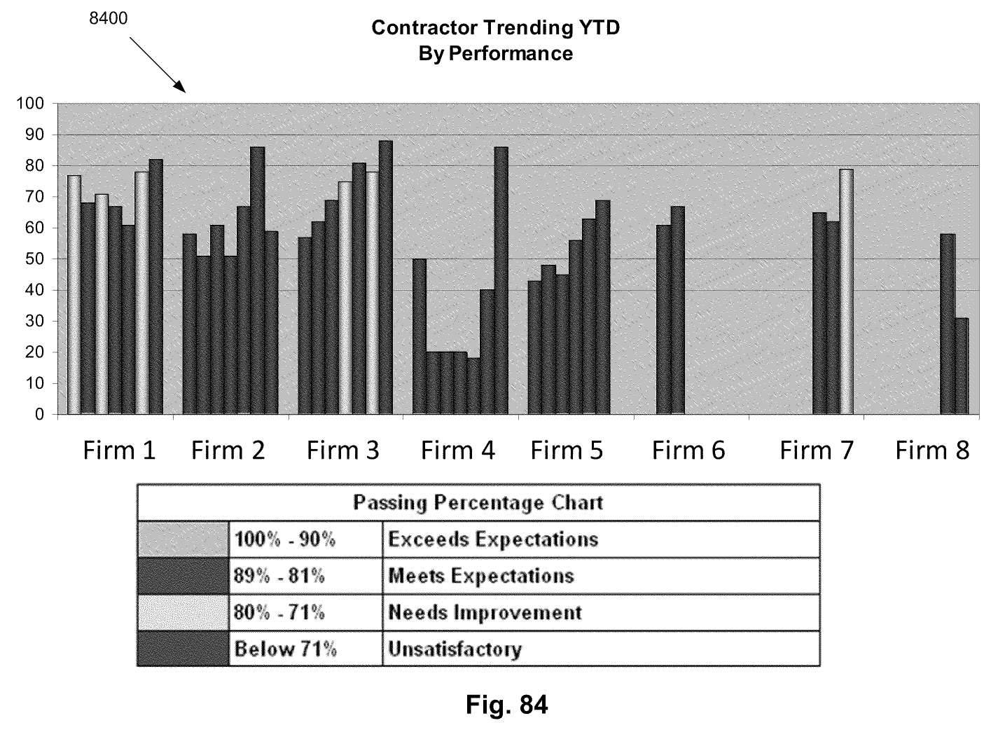

FIG. 84 shows a Contractor Trending YTD by Performance report 8400 according to one embodiment. The graph reflects the trends for eight particular firms.

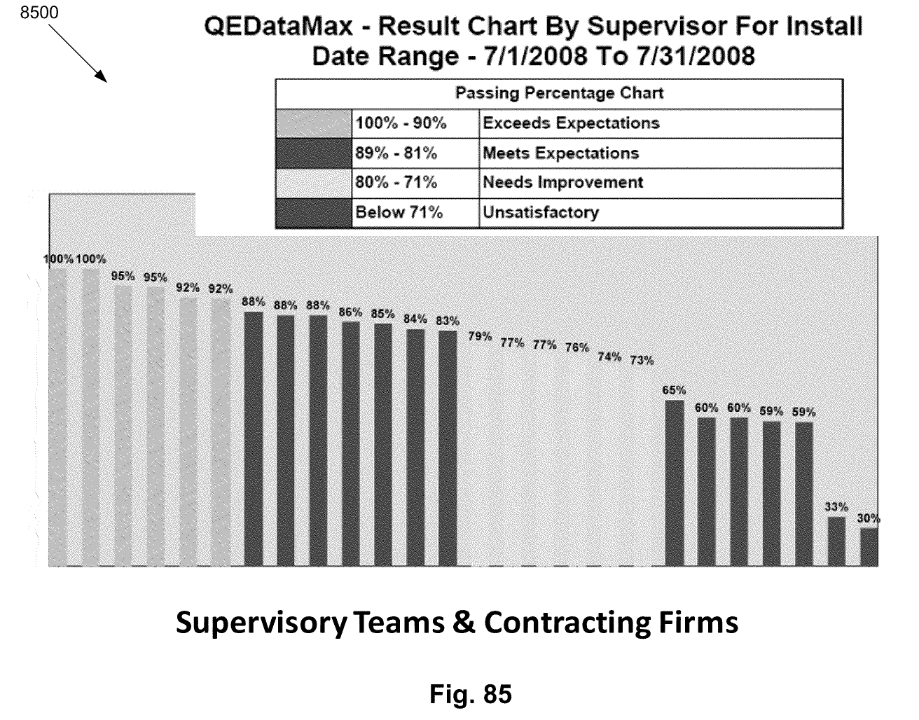

FIGS. 85-87 show Result Chart By Supervisor reports for three different job types. This gives a visual of where supervisors and contract companies stand against each other for a particular job type. FIG. 85 shows a Result Chart By Supervisor For Install report 8500 according to one embodiment for the month of July 2008. Results for the install job type are displayed to evaluate performance.

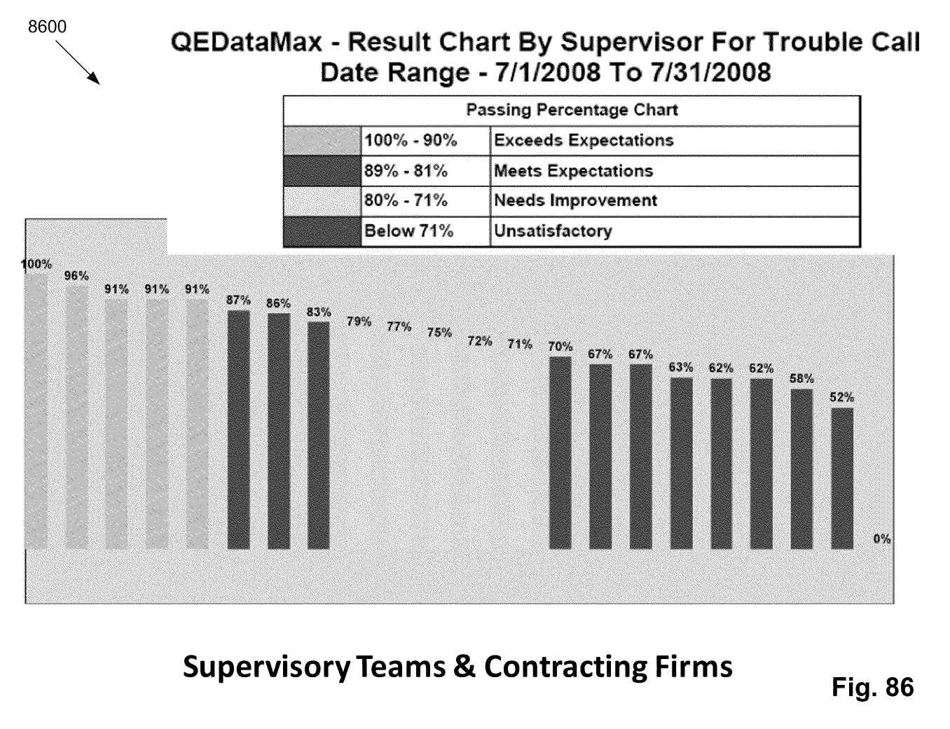

FIG. 86 shows a Result Chart By Supervisor For Trouble Call report 8600 according to one embodiment for the month of July 2008. Results for the trouble call job type are displayed to evaluate performance.

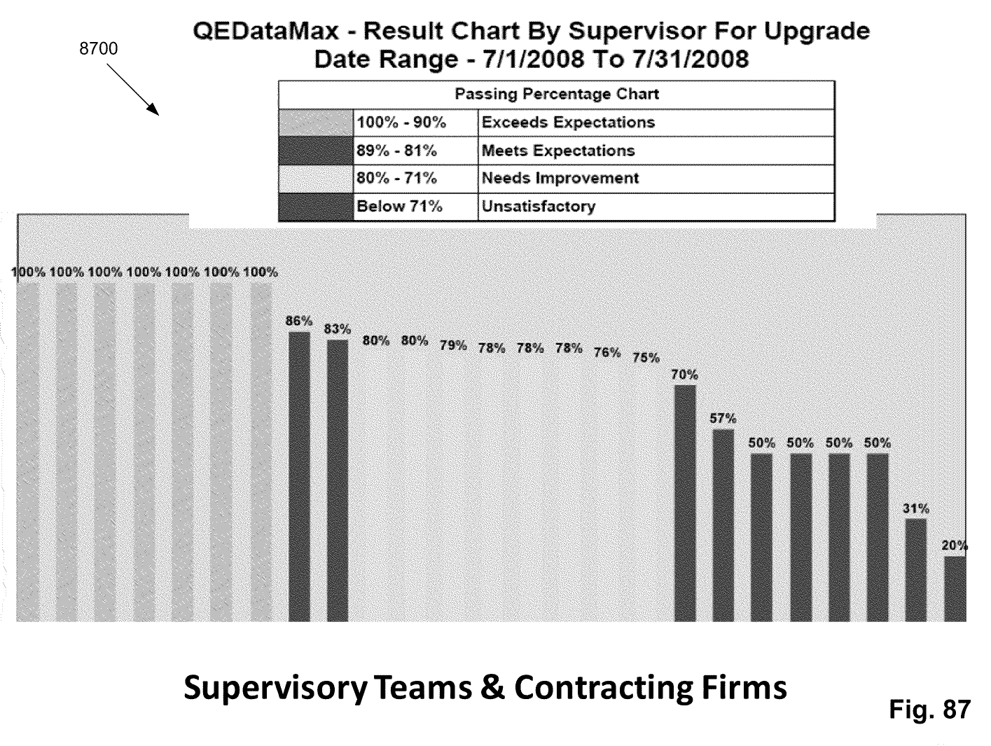

FIG. 87 shows a Result Chart By Supervisor For Update report 8700 according to one embodiment for the month of July 2008. Results for the update job type are displayed to evaluate performance.

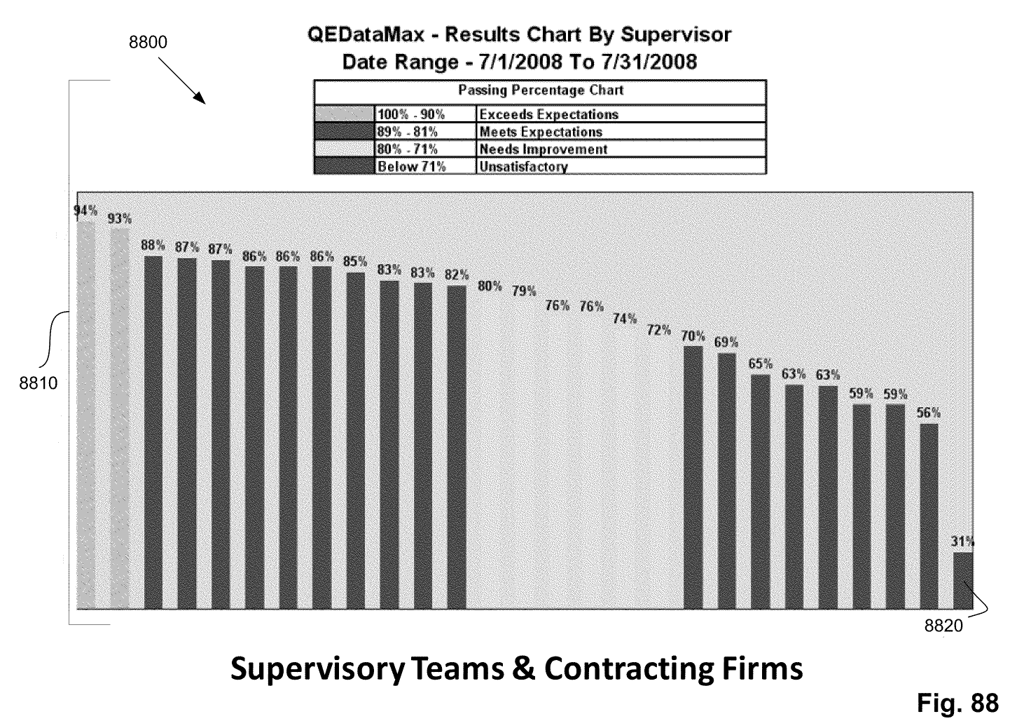

FIG. 88 shows an example of a Results Chart By Supervisor/Date Range report 8800 according to one embodiment. The Results Chart By Supervisor/Date Range report 8810 displays a chart of passing percentages and a chart of average scores descending from left to right for the month of July. This gives a visual of where supervisors and contract companies stand against each other. By selecting a particular bar 8820, the user will be able to view the Results By Supervisor/Tech/Date Range report.

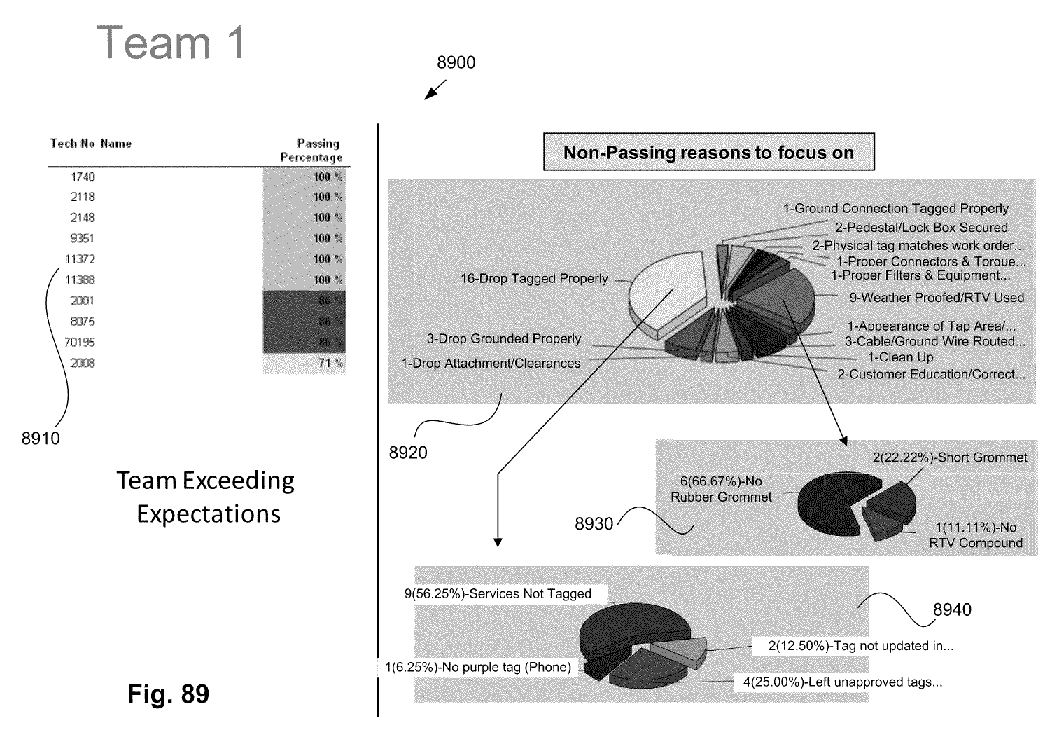

FIG. 89 shows a performance evaluation 8900 for Team 1 according to one embodiment. Team 1 exceeds expectations as shown by the passing percentages of the techs 8910. A Non Passing Reasons Chart By Supervisor 8920 displays a pie chart of items that were failed by the team. By selecting specific pieces of the pie, detail for that line item is displayed in pie charts 8930 and 8940.

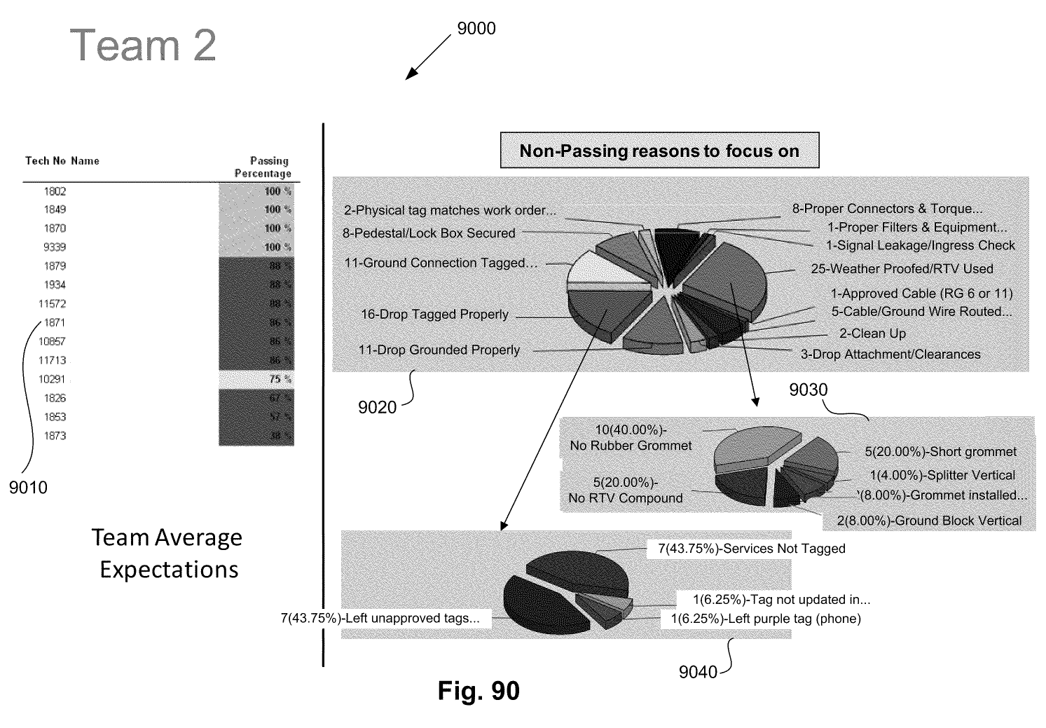

FIG. 90 shows a performance evaluation 9000 for Team 2 according to one embodiment. Team 2 meets average expectations as shown by the passing percentages of the techs 9010. A Non Passing Reasons Chart By Supervisor 9020 displays a pie chart of items that were failed by the team. By selecting specific pieces of the pie, detail for that line item is displayed in pie charts 9030 and 9040.

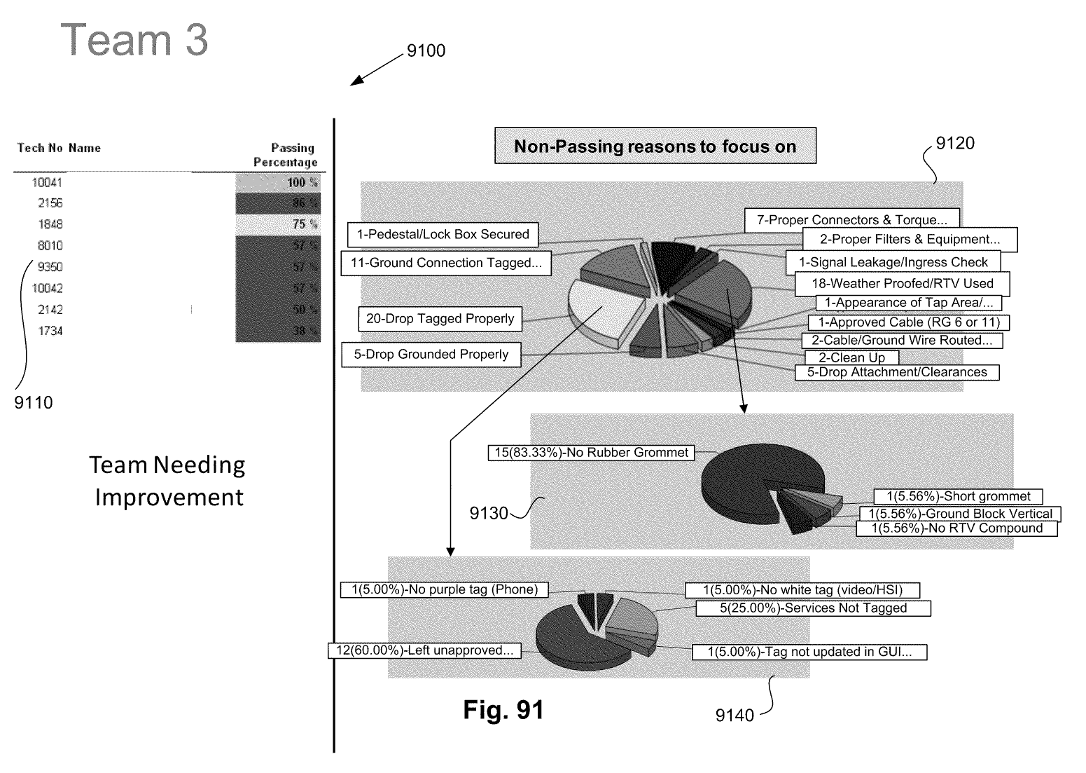

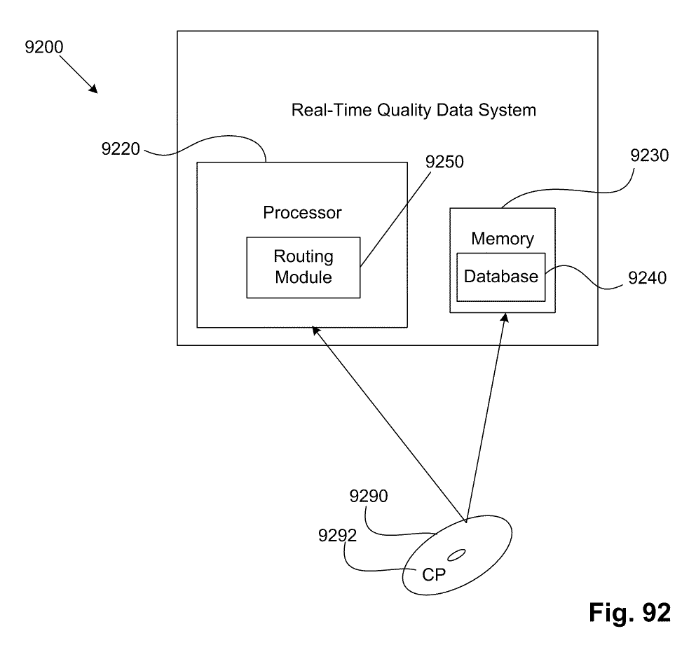

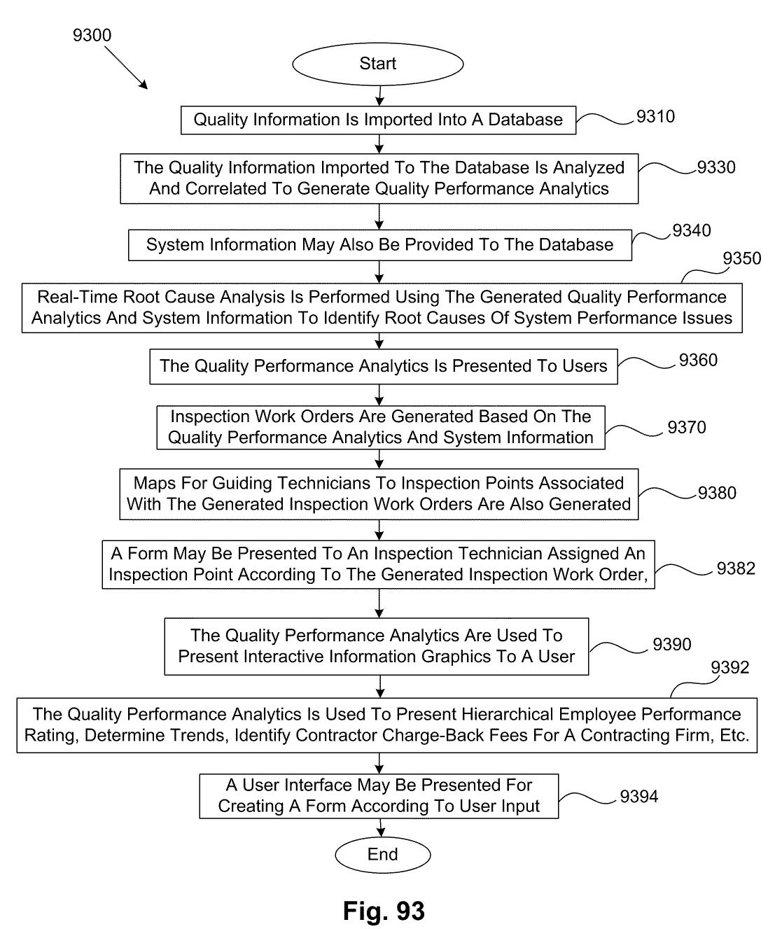

FIG. 91 shows a performance evaluation 9100 for Team 3 according to one embodiment. Team 3 needs improvement as shown by the passing percentages of the techs 8810. A Non Passing Reasons Chart By Supervisor 9120 displays a pie chart of items that were failed by the team. By selecting specific pieces of the pie, detail for that line item is displayed in pie charts 9130 and 9140.

FIG. 92 illustrates a suitable computing environment 9200 for implementing a system for providing real-time quality data to a system that may be continuously updated and reviewed to maintain and control quality performance of the business according to an embodiment. In FIG. 92, a real-time quality data system 9200 includes a processor 9220 and memory 9230. Embodiments may also be implemented in combination with other types of computer systems and program modules. Generally, program modules include routines, programs, components, data structures, and other types of structures that perform particular tasks or implement particular abstract data types. By way of example, computer readable media 9290 can include computer storage media and communication media. Computer storage media 9290 includes volatile and nonvolatile, removable and non-removable media implemented in any method or technology for storage of information 9292, such as computer readable instructions, data structures, program modules or other data. Computer storage media 9290 typically embodies computer readable instructions, data structures, and program modules. Moreover, those skilled in the art will appreciate that the invention may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network.

Embodiments implemented on computer-readable media 9290 may refer to a mass storage device, such as a hard disk or CD-ROM drive. However, it should be appreciated by those skilled in the art that computer-readable media can be any available media that can be accessed or utilized by a processing device, e.g., server or communications network provider infrastructure.

By way of example, and not limitation, computer-readable media 9290 may include, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by a processing device.

As mentioned briefly above, a number of program modules and data files may be stored and arranged for controlling the operation of processing devices. Thus, one or more processing devices 9220 may be configured to execute instructions that perform the operations of embodiments of the present invention.

It should also be appreciated that various embodiments of the present invention can be implemented (1) as a sequence of computer implemented acts or program modules running on a processing device and/or (2) as interconnected machine logic circuits or circuit modules within the processing devices. The implementation is a matter of choice dependent on the performance requirements. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Memory 9230 thus may store the computer-executable instructions that, when executed by processor 9220, cause the processor 9220 to implement a system for providing real-time quality data to a system that may be continuously updated and reviewed to maintain and control quality performance of the business. However, memory 9230 may also be configured to provide the database 9240 for storing the quality information provided by users of the system and other system information, which is processed by processor 9229.

Accordingly, the real-time quality data system 9200 allows users to identify root cause issues by clicking charts, graphs, and other information graphics. The system 9200 is scalable so that the system is appropriate for uses with one technician or a thousand technicians. Moreover, the system 9200 may be accessed by contracting firms or in-house employees. The data may be compartmentalized according to well-known security processes. The system 9200 implements a routing module 9250 for generating inspection work orders.

Jobs may be color coded to reflect the aging of each of the inspection jobs. The inspectors go to the inspection points associated with the work order for their inspection job to inspect and collect data. There may be different types of inspections, such as an install inspection, trouble call inspection, disconnect inspection, etc. The system 9200 pulls up the appropriate form based on the type of inspection job. The system 9200 uploads all of the customer information from the billing system, which may be implemented by the processor 9220 using data in memory 9230. Once the inspection is complete, the inspection data is imported to the memory 9230, where the data is automatically compiled in various ways. The system 9200 may generate reports by technician, by team, by supervisor, by contracting house, by failure point, by problem trending, cost avoidance or any other selectable parameter. The system 9200 also provides online performance scoring to compare teams, supervisors, etc.

The system 9200 presents data to a user in an information graphics that may be drilled down to identify root causes of problems. For example, if a supervisor is looking at an information graphic showing a 52% passing percentage, the supervisor may select the object to immediately retrieve reporting details by technician. The supervisor may look at the technician's failure items, the passing percentage, number of inspections per data range for that technician, etc. The supervisory may also pull up the actual inspection to read the notes that the inspector gathered in the field and entered on a form at the inspection point. The system 9200 also provides trending report to identify issues for a predetermined period. By looking at the root cause of failure, a supervisor may identify charges that need to be charged back to a contracting firm. The data may also be sued to score employees.

The system 9200 also allows a technician to write a report that can be imported into streets and trips when the technician is routing through the application. The technician may then use streets and trips to set their route for the day. A second report may be exported into GPS units which will allow technicians to take and use those as points and exits to get directions so between streets and trips on their route for the day.

The database 9240 may also be sued to store and track disputes. The system 9200 may then compile the disputes to identify resolutions for the disputes. Additional modules may be implemented, such as providing a progressive disciplinary action program, a user interface for creating custom inspection sheets. Further, the processor 9220 may implement different analytical programs, e.g., a statistical program, so that different parameters may be sued within the system 9200. For example, a statistical program may process the data to provide a probability rate for elements within a network.

FIG. 93 is a flowchart 9300 of a method for implementing a system for providing real-time quality data to a system that may be continuously updated and reviewed to maintain and control quality performance of the business according to an embodiment. In FIG. 93, the flowchart 9300 shows that quality information is imported into a database 9310. The quality information imported to the database is analyzed and correlated to generate quality performance analytics 9330. The importing of quality information includes uploading data from field inspections. System information may also be provided to the database 9340. Real-time root cause analysis is performed using the generated quality performance analytics and system information to identify root causes of system performance issues 9350. The quality performance analytics is presented to users 9360. Inspection work orders are generated based on the quality performance analytics and system information 9370. The generation of inspection work orders based on the quality performance analytics and system information may include processing customer input, such as customer complaints, and analyzing billing information associated with the customer.

Maps for guiding technicians to inspection points associated with the generated inspection work orders are also generated 9380. A form may be presented to an inspection technician assigned an inspection point according to the generated inspection work order, wherein the form is selected based on a type of inspection associated with an inspection point provided by the generated inspection work order 9382. The quality performance analytics are used to present interactive information graphics to a user 9390. The interactive information graphics may be color-coded interactive information graphics. The quality performance analytics may further be used to present hierarchical employee performance rating, to determine trends, to identify contractor charge-back fees for a contracting firm, etc. 9392. A user interface may be presented for creating a form according to user input 9394.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for using real-time quality data to maintain and control quality performance of the business, comprising:
importing quality information into a database;
analyzing and correlating the quality information imported to the database to generate quality performance analytics;
provide system information to the database;
perform real-time root cause analysis using the generated quality performance analytics and system information to identify root causes of system performance issues; and
presenting the quality performance analytics to users.

2. The method of claim 1, wherein the importing quality information includes uploading data from field inspections.

3. The method of claim 1 further comprises generating inspection work orders based on the quality performance analytics and system information.

4. The method of claim 3, wherein the generating inspection work orders based on the quality performance analytics and system information further comprises analyzing billing information associated with the customer.

5. The method of claim 3 further comprises generating maps for guiding technicians to inspection points associated with the generated inspection work orders.

6. The method of claim 5, further comprising presenting a form to an inspection technician assigned an inspection point according to the generated inspection work order, the form being selected based on a type of inspection associated with an inspection point provided by the generated inspection work order.

7. The method of claim 3, wherein the generating inspection work orders based on the quality performance analytics and system information further comprises processing customer input.

8. The method of claim 7, wherein the processing customer input further comprises customer complaints.

9. The method of claim 1, further comprises using the quality performance analytics to present interactive information graphics to a user.

10. The method of claim 9, wherein the presenting interactive information graphics to a user comprises presenting color-coded interactive information graphics

11. The method of claim 1, further comprising using the quality performance analytics to present hierarchical employee performance rating.

12. The method of claim 1, further comprising using the quality performance analytics to determine trends.

13. The method of claim 1, further comprising using the quality performance analytics to identify contractor charge-back fees for a contracting firm.

14. The method of claim 1 further comprises presenting a user interface for creating a form according to user input.

15. A computer-readable medium having stored thereon computer-executable instructions for implementing a system for providing real-time quality data to a system that may be continuously updated and reviewed to maintain and control quality performance of the business, the computer-executable instructions, when executed by a computer, cause the computer to:
importing quality information into a database;
analyzing and correlating the quality information imported to the database to generate quality performance analytics;
provide system information to the database;
perform real-time root cause analysis using the generated quality performance analytics and system information to identify root causes of system performance issues; and
presenting the quality performance analytics to users.

16. The method of claim 15, wherein the importing quality information includes uploading data from field inspections.

17. The method of claim 15 further comprises generating inspection work orders based on the quality performance analytics and system information.

18. The method of claim 17, wherein the generating inspection work orders based on the quality performance analytics and system information further comprises analyzing billing information associated with the customer.

19. The method of claim 17 further comprises generating maps for guiding technicians to inspection points associated with the generated inspection work orders.

20. The method of claim 19, further comprising presenting a form to an inspection technician assigned an inspection point according to the generated inspection work order, the form being selected based on a type of inspection associated with an inspection point provided by the generated inspection work order.

21. The method of claim 17, wherein the generating inspection work orders based on the quality performance analytics and system information further comprises processing customer input.

22. The method of claim 21, wherein the processing customer input further comprises customer complaints.

23. The method of claim 15, further comprises using the quality performance analytics to present interactive information graphics to a user.

24. The method of claim 23, wherein the presenting interactive information graphics to a user comprises presenting color-coded interactive information graphics

25. The method of claim 15, further comprising using the quality performance analytics to present hierarchical employee performance rating.

26. The method of claim 15, further comprising using the quality performance analytics to determine trends.

27. The method of claim 15, further comprising using the quality performance analytics to identify contractor charge-back fees for a contracting firm.

28. The method of claim 15 further comprises presenting a user interface for creating a form according to user input.

29. A system for providing real-time quality data to a system that may be continuously updated and reviewed to maintain and control quality performance of the business, comprising:
a memory configured to provide a database for storing information; and
a processor, coupled to the memory, the processor imports quality information into the database, analyzes and correlates the quality information imported to the database to generate quality performance analytics, provides system information to the database, performs real-time root cause analysis using the generated quality performance analytics and system information to identify root causes of system performance issues and presents the quality performance analytics to users.

30. The system of claim 29, wherein the quality information includes data uploaded from field inspections.

31. The system of claim 29, wherein the processor generates inspection work orders based on the quality performance analytics and system information.

32. The system of claim 29, wherein the processor uses the quality performance analytics to present interactive information graphics to a user.

33. The system of claim 29, wherein the processor uses the quality performance analytics to determine trends.
